(19) United States
(12) Patent Application Publication
(10) Pub. No.: US 2023/0096468 A1
(43) Pub. Date: Mar. 30, 2023

(54) IN-TRANSIT PACKET DETECTION TO REDUCE REAL-TIME RECEIVER PACKET JITTER

(71) Applicant: Intel Corporation, Santa Clara, CA (US)

(72) Inventors: Boon Leong ONG, Penang (MY); Kishore KASICHAINULA, Phoenix, AZ (US)

(21) Appl. No.: 18/073,221

(22) Filed: Dec. 1, 2022

(51) Int. Cl. H04L 47/283; H04L 47/2441; H04L 49/00

(52) U.S. Cl. CPC H04L 47/283; H04L 47/2441; H04L 49/3018

(57) ABSTRACT

The present disclosure is generally related to network topologies and engineering, time-aware networks, time-sensitive applications, edge computing frameworks, data processing, network communication, and communication system implementations, and in particular, to techniques for providing in-transit packet detection to reduce real-time packet jitter. The present disclosure includes in-transit packet detectors inside a Medium Access Control (MAC) entity that observes received frames stored in a buffer, and provides in-transit received frame flag through a next bit of a descriptor. This provides a hint of received packet batch processing about in-transit receiver frames that should be processed in a current batch cycle.

### TECHNICAL FIELD

The present disclosure is generally related to network topologies and engineering, time-aware networks, time-sensitive applications, edge computing frameworks, data processing, network communication, and communication system implementations, and in particular, to techniques for providing in-transit packet detection to reduce real-time packet jitter.

### BACKGROUND

Time sensitive networking has become increasingly important today in many applications especially in industrial automation and automotive. But many of IEEE TSN standards solely focus on transmitter (Tx) traffic shapers, for example, IEEE Standard for Local and Metropolitan Area Networks—Virtual Bridged Local Area Networks Amendment 12: Forwarding and Queuing Enhancements for Time-Sensitive Streams, IEEE Std 802.1Qav-2009, pp. C1-72 (5 Jan. 2010) (“[IEEE802.1Qav]”); IEEE Standard for Local and metropolitan area networks—Bridges and Bridged Networks—Amendment 25: Enhancements for Scheduled Traffic, IEEE Std 802.1Qbv-2015, pp. 1-57 (18 Mar. 2018) (“[IEEE802.1Qbv]”); and IEEE Standard for Local and metropolitan area networks—Bridges and Bridged Networks—Amendment 26: Frame Preemption, IEEE Std 802.1Qbu-2016, pp. 1-52, (30 Aug. 2016) (“[IEEE802.1Qbu]”), to ensure Tx packets are transmitted in a deterministic manner. Equally important is timely reception of receiver (Rx) packets to ensure end-to-end (e2e) determinism.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 depicts an example network controller and interrupt-driven batch processing flow.

FIG. 2 depicts an example interrupt driven receiver (Rx) batch processing timing diagram.

FIG. 3 depicts an example busy polling Rx batch processing timing diagram.

FIG. 4 depicts an example hardware implementation including in-transit detectors.

FIG. 5 depicts an example timing diagram for back-to-back packets under system bus congestion.

FIG. 6 depicts an example in-transit packet detection and handling in a network controller and network driver for low-latency/jitter Rx packet processing.

FIG. 7 depicts an example timing diagram for a slightly delayed Rx packet is processed in current batch instead of the next cycle.

FIG. 8 depicts an example time-aware network.

FIG. 9 depicts an example PTP instance model.

FIG. 10 illustrates an example edge computing environment.

FIG. 11 illustrates an example software distribution platform.

FIG. 12 depicts example components a compute node.

FIG. 13 depicts an example infrastructure processing unit (IPU).

FIG. 14 depicts an example system capable of rebalancing of security control points.

### DETAILED DESCRIPTION

### 1. In-Transit Packet Detection Aspects

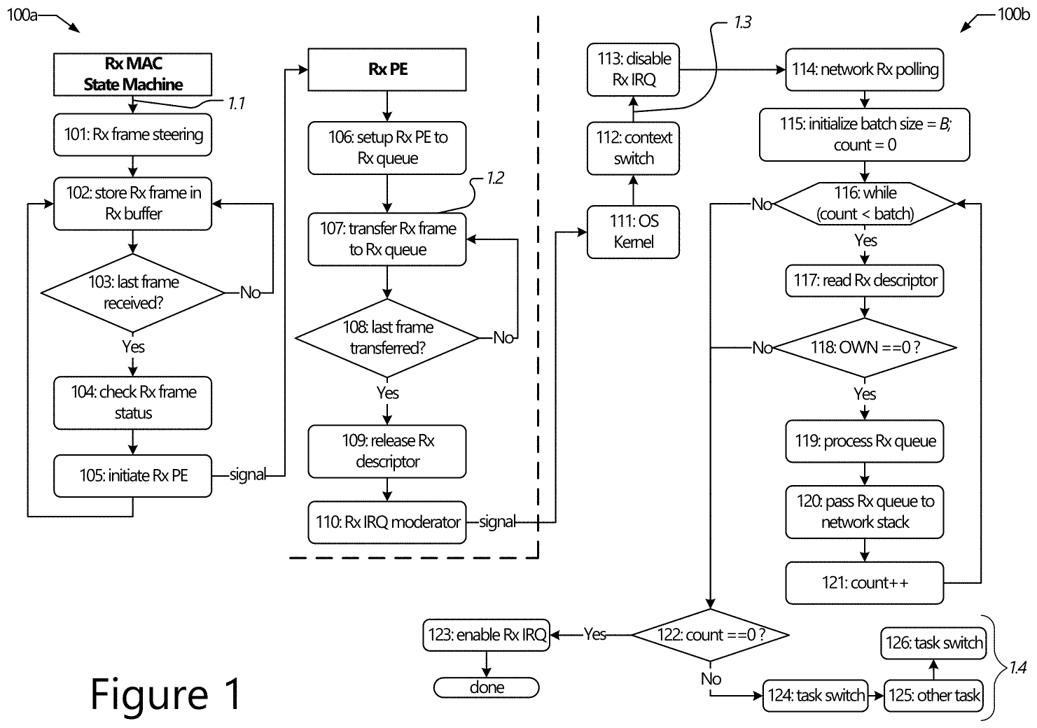

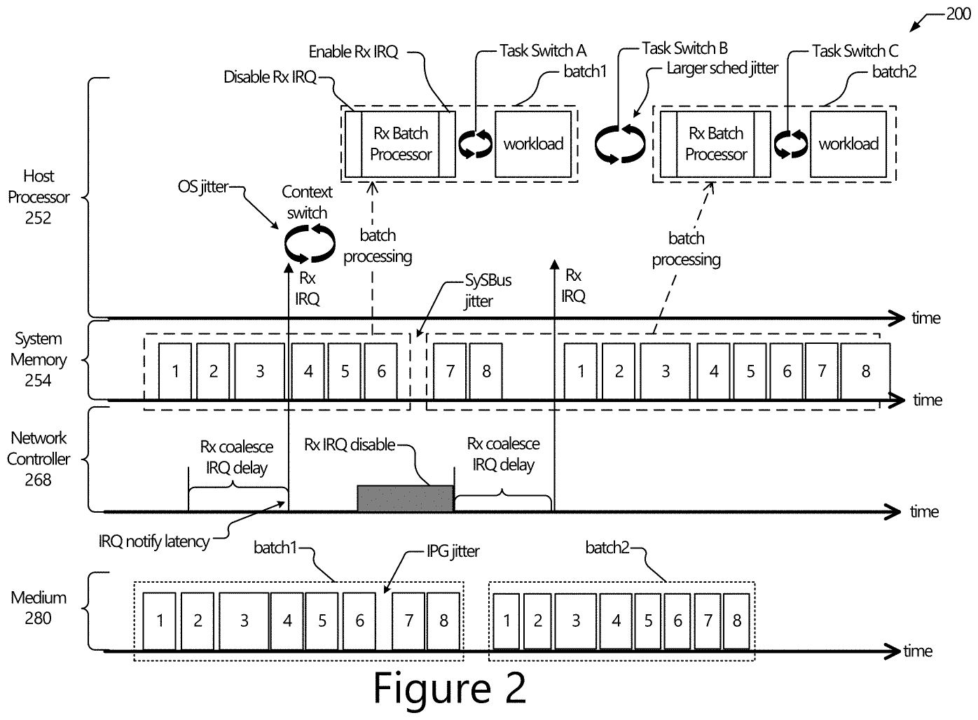

FIG. 1 depicts an example network controller and interrupt-driven batch processing flow, which includes a network controller process 100a that may be performed by network controller circuitry (e.g., network controller 268 of FIG. 2) and a host platform process 100b that may be performed by host processor circuitry (e.g., host processor 252 of FIG. 2) including interactions with host (system) memory (e.g., system memory 254 of FIG. 2). The network controller includes a receiver (Rx) medium access control (MAC) state machine (also referred to as the “MAC”) and an Rx packet engine (PE) (e.g., an Rx direct memory access (DMA) engine, LAN engine, protocol engine, host interface engine/controller, and/or the like), wherein the MAC performs operations 101 to 105 of process 100a and the Rx PE performs operations 106 to 110 of process 100a. Additionally, the host processor circuitry may operate or execute functions of a network driver (or API) to perform operations 111 to 126 of process 100b.

Process 100a starts at the MAC, which performs Rx frame steering (101). Next, an in-coming Rx frame is stored in hardware Rx buffer (102), which may be implemented using on-board memory circuitry of the network controller. As an example, the Rx buffer/queue may be a first in first out (FIFO) buffer and/or a buffer/queue that operates according to some other queue management technique. The MAC determines whether a last data chunk (e.g., PDU, byte, and/or the other data unit) of the Rx frame has been received (103), and if not, the MAC loops back to continue to store in-coming Rx frames (or data chunks of the Rx frame) in the buffer (102). If the last data chunk (e.g., PDU, byte, and/or the other data unit) of the Rx frame has been received and/or stored in the Rx buffer (103), the MAC checks an Rx frame status based on, for example, a frame check sequent (FCS) or some other error-detecting code or checksum (104), signals the Rx PE to initiate or start (105) and loops back to continue storing Rx frames (or data chunks of the Rx frame) in the Rx buffer (102). After initialization, the Rx PE sets up an Rx PE to Rx queue (e.g., a memory location in a system memory of a host platform pointed to by one or more Rx descriptors) (106). Then, the Rx PE transfers the Rx frame to the Rx queue (e.g., by performing one or more DMA operations to transfer the data chunks in the buffer to a system memory of a host platform) (107), which may include some data transfer jitter 1.2 (e.g., (DMA) transfer jitter and/or the like). Next, the Rx PE determines whether the last data chunk (e.g., PDU, byte, and/or the other data unit) of the Rx frame has been transferred from the Rx buffer to the Rx queue (108). If the last data chunk (e.g., PDU, byte, and/or the other data unit) has not been transferred, then the Rx PE loops back to transfer additional data chunk(s) (e.g., PDU(s), byte(s), and/or the other data unit(s)) to the Rx queue in the host memory of the host platform (107). Otherwise, the Rx PE releases a corresponding Rx descriptor (e.g., by updating and/or setting an “OWN” bit to 0 in the Rx descriptor and/or the like) (109), and then signals an interrupt request (IRQ) to the host processor via, for example, a host interface and/or network driver/API (110). This may be done using, for example, adaptive IRQ moderation (also referred to as “adaptive IRQ coalescing” or the like), which involves delaying an interrupt for a a period of time or a number of completions (e.g., packets for networking devices) in order to optimize the effective throughput by mitigating the cost of handling interrupts (110).

The host processor process 100b begins when an operating system (OS) kernel of the host platform receives the Rx IRQ from the Rx PE (110 to 111). The OS kernel triggers a context switch (112), which may include some context switch jitter 1.3. The context switch (112) causes a disable Rx IRQ (113) and network Rx polling (114) to take place. Next, the host processor initializes a batch size by setting a batch size value (e.g., init batch size=B, where B is a number), and setting a count to zero (115). Here, the batch size (B) controls the number of packets to process per batch cycle. In some examples, the initial batch size value (B) is a user/system tunable (or configurable) limit on the number of packets to be processed per batch cycle. While the count is less than the batch size/amount (116), the host processor reads one or more Rx descriptors (117) and then checks if the OWN bit is set to zero (118). If the OWN bit is set to zero (118), the host processor processes the Rx buffer (119), passes the Rx buffer data to a network stack (120), increments the batch count (121), and then proceeds back to determine if the count is still less than zero (116). If the OWN bit is not set to zero (118) or the count is not less than the batch (116), the host processor determines whether the count is set to zero (122). If the count is set to zero (122), then the host processor enables the Rx IRQ (123) and process 100b ends. If the count is not set to zero (122), then the host processor performs one or more task switches (124, 125, 126). Additionally or alternatively, a task switch (e.g., 126) may eventually enter network Rx polling (114) to continue with the Rx frame looping. The tasks/task switches 124, 125, and 126 may include task switch jitter 1.4.

FIG. 1 is a framework of network traffic processing in a network controller and network driver of a host processor wherein incoming Rx frames is/are stored in an Rx buffer (101, 102, 103) before it is DMA transferred to system memory (104, 105, 106, 107, 108, 109). The notification about the arrival of one or more Rx frames is done through an Rx IRQ (110). Upon entering an interrupt service register (ISR), the host platform (network driver) immediately disables the Rx IRQ (113) and all the received packets are processed (114-119) (e.g., passing to network stack for further processing (120) in a batch manner). At the end of the batch processing (116 to 122), just before exiting the ISR, the Rx IRQ is reenabled (123). For wired and/or wireless Time-Sensitive Networking (TSN), cyclic real-time packets are required to be delivered from a sender (e.g., a source or talker) to receiver (e.g., destination or listener) in a bounded and low latency manner in order to ensure real-time computation and response (e.g., for a control loops, time-sensitive applications, cyclic queuing and forwarding (CQF), and/or the like) are meeting its deadline within a specific cycletime (or predefined interval). Hence, Rx frames must be made available to the control loop application to meet the requisite deadline.

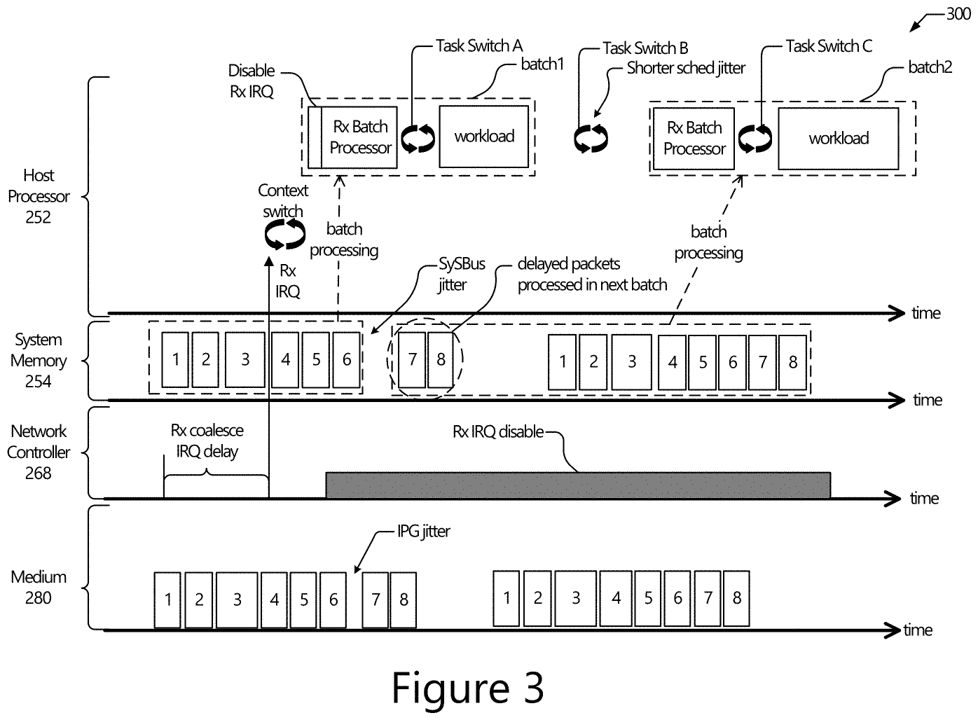

The factors that affect such determinism include various types of jitter, for example, inter-packet jitter 1.1, DMA transfer jitter 1.2, packet process scheduling jitter, and missed cycles. Inter-packet gap (IPG) jitter 1.1 involves Rx packets that arrive on network controller (e.g., stored in Rx FIFO buffer) over the network with different delay from its expected arrival time due to packet transmission jitter at the sender for buffering effect in network switch. DMA transfer jitter 1.2 refers to the time taken to DMA transfer a Rx packet from an Rx buffer to system memory (e.g., frame buffer and/or Rx descriptor update), which may vary due to internal system bus congestion during relatively heavy workloads at the host processor. Packet process scheduling jitter refers to scheduling of Rx packet batch processing loop in the host processor, which is affected mainly by two factors including context switch jitter 1.3 (e.g. jitter based on interrupt context and normal context switches) and task switch jitter 1.4 (e.g., scheduling of concurrent processes in normal context that run on the same CPU/processor). TSN involves cyclic real-time traffic that is/are allocated timeslot(s) for packet delivery, and these packets are best serviced in cyclic batch fashion at the receiver. However, there may be one or more packets that miss the designated Rx packet processing cycle and must wait for the next cycle. Such a miss is undesirable, and due to the inter-packet jitter 1.1 and/or DMA transfer jitter 1.2 discussed earlier (see e.g., discussion of packet 7 in the examples of FIGS. 2 and 3 infra).

The present disclosure provides system capabilities and implementations that overcome the aforementioned types of jitter by providing an in-coming and/or in-transit Rx frame hint (e.g., before its associated Rx descriptor is updated) to Rx packet batch processing (or processing pipeline) to ensure that slightly delayed Rx frames are still processed within the same cycle (or within an intended cycle). Without such capabilities and implementations, such delayed Rx frames are further pushed out to a next batch cycle resulting in increased jitter. The capabilities and implementations discussed herein decrease the amount of jitter resulting from Rx packet/frame processing, which improves the function of the computing device/component itself by improving resource consumption efficiencies of such devices/components.

FIG. 2 illustrates an example timing diagram 200 of an interrupt-driven-then-polling Rx packet batch processing technique and FIG. 3 shows an example timing diagram 300 of an enhanced version of busy-polling Rx packet batch processing technique. Both techniques involve operations/tasks performed by a host processor 252, system memory 254, network controller 268, and a network wire 280. The examples of FIGS. 2 and 3 includes two network packet batches (e.g., batch1 and batch2), each of which includes a set of packets that are labeled 1 through 8 in each batch. In particular, FIGS. 2 and 3 show the back-to-back arrival of 8 packets in batch1 where a gap exists between packets 6 and 7. In other implementations, each batch may include more or fewer packets than shown. For purposes of the present disclosure, each batch represents a logical unit or other collection of packets to be processed during a same batch processing cycle. Additionally, each packet represents a container or other arrangement of data units that is communicated over a network, and which can include a set of protocol data units (PDUs). As examples, each PDU in a packet may represent a header section, data or payload (e.g., a PDU of application, presentation, and/or session layers), a segment (e.g., a transport layer PDU), a network layer PDU (also referred to as a “packet”), frame(s) (e.g., data link layer PDUs), bytes, bits (e.g., physical layer PDUs), and/or any combination thereof. Additionally or alternatively, the numbered blocks in FIGS. 2 and 3 may represent fragments, segments, PDUs, service data units (SDUs), blocks, data chunks, data parts, information elements, data elements, sections, data fields, partitions, frames, subframes, bytes, bits, symbols or other data items/units of one or more data payloads, segments, packets, frames, bytes, symbols, bits, and/or any other data structure or type of data. The following description describes various examples based on Ethernet frames/packets, however, the embodiments discussed herein can be straightforwardly applied to other types of data units of other communication protocols, such as any of those discussed herein. Furthermore, the present disclosure may use the term “packet” interchangeably with the term “PDU” or “frame”, even though these terms may refer to different concepts.

The timing diagram 200 of FIG. 2 corresponds to the network driver/controller process 100a and host platform process 100b in FIG. 1. The technique of timing diagram 200 is useful for avoiding relatively high context switch costs due to a high in-coming packet rate. The timing diagram 300 of FIG. 3 is an enhanced version of busy-polling Rx packet batch processing technique where the Rx IRQ is disabled at the network controller 268 indefinitely after the first notification (e.g., IRQ), and the batch processing repeats itself as scheduled by the OS (e.g., priority-based task switching) without relying on the Rx IRQ. This technique avoids expensive context switching (e.g., in terms of resource overhead and/or jitter/latency), and Rx frames are moved through the host processor 252 in batch-like manner depending on the batch size (e.g., number of packets per batch). The task switching could be implemented in or by a suitable software (SW) interrupt or kernel thread mechanism. One benefit of the enhanced busy-polling Rx packet batch processing technique includes reducing task switch jitter to be smaller than I/O-based context switching related jitter. Another packet processing technique is Time Coordinated Computing (TCC), which focuses on achieving determinism in system fabric transaction and computation. With the right tuning, DMA transfer jitter could be made low and bounded using TCC.

The interrupt-driven-then-polling Rx packet batch processing technique of FIG. 2, the busy-polling Rx packet batch processing technique of FIG. 3, and the TCC technique can prevent context switches caused by Rx IRQs and minimize task switching jitter between two consecutive Rx packet batch processing. However, these techniques are not capable of overcoming missed processing cycle scenarios. This is because Rx packet batch processing operates on individual Rx frames based on updated Rx descriptors (e.g., OWN=0) up to a batch-size limit (see e.g., FIG. 1). For example, in FIGS. 2 and 3, task switch A may occur when the host processor 252 (or the Rx batch processing pipeline/logic) does not get notified that the relevant descriptors are being updated at the end of the Rx batching processing of batch1. This can cause additional jitter and/or delay because this task switch depends on the OS to reschedule itself. When this happens, then some packets (e.g., packets 7 and 8) will miss the current batch processing cycle and have to be processed at a much later time (e.g., in the next batch). This causes additional jitter to be experienced by packets 7 and 8 because those packets were supposed to be processed in the previous batch. Additionally or alternatively, the batch processing can be delayed due to system bus (SySBus) jitter taking place on the internal SySBus connecting the NIC 268, the system memory 254, and the host processor 252. The SysBus jitter/delay depends at least in part on the load of the processing happening within the host processor 252 and/or the amount of traffic being conveyed over the SySBus. If the SySBus jitter is large enough, the batch processing cycle may end before all of the packets in a batch (e.g., packets 7 and 8) can be transferred over the SySBus from the system memory 254 to the Rx batch processor operating on the host processor 252, which will cause the missed packets to be processed as part of the next batch at the next batch cycle.

In other words, any delay in updating the Rx descriptors due to inter-packet (IPG) jitter 1.1 (e.g., the IPG jitter between packets 6 and 7 on the network wire 280 in FIGS. 2-3 and/or the Rx coalesce IRQ delay in FIG. 2) or DMA transfer jitter 1.2 (e.g., the system bus (SysBus) jitter in FIGS. 2-3) outside of the Rx packet batch processing time quantum will result in that Rx frame be processed in the next batch processing cycle (e.g., delayed packets 7 and 8 being processed in a next batch in FIG. 3). In other words, if the cumulative delay (caused by IPG jitter 1.1 and/or DMA/SysBus jitter 1.2) in informing the host processor about the arrival of packets 7 and 8 (e.g., through an Rx descriptor) exceeds the Rx packet batch processing time quantum, will cause undesirable delayed processing of packets 7 and 8 in the next Rx packet batch processing cycle. While batch processing is optimal for pushing higher throughput, it is sub-optimal in ensuring the lowest possible real-time computation of slightly delayed Rx packets (see e.g., packets 7 and 8 in FIGS. 2-3).

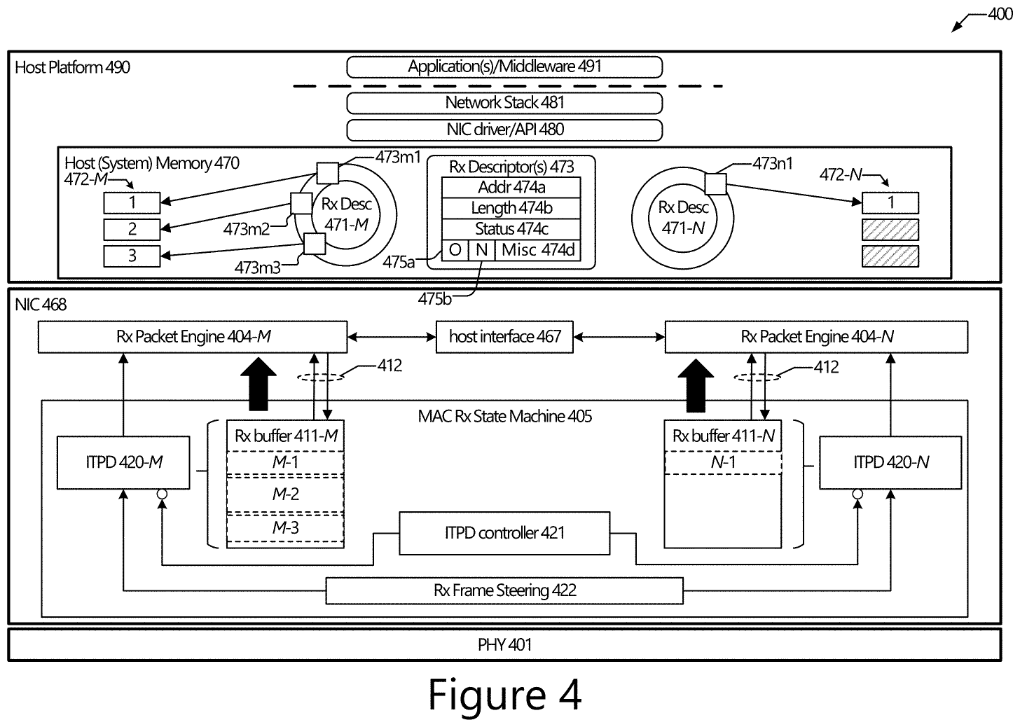

The present disclosure provides an in-transit packet detector inside an Rx MAC state-machine that observes Rx frames stored in a corresponding Rx buffer and provides in-transit Rx frame flag through a NEXT bit of an Rx descriptor (see e.g., FIG. 4) to provide hints or otherwise indicate to Rx packet batch processing pipeline about in-transit Rx frame(s) that should be processed in a current batch cycle. The example implementations discussed herein avoids undesirable “wait till next cycle batch processing” situation and improves overall real-time networking and computation determinism that is critical for real-time and networked applications and/or use cases that require microsecond (μs) and/or sub-μs range determinism, such as, for example, industrial automation and/or industrial IoT, motion control applications (e.g., for autonomous or semi-autonomous driving vehicles, drones, and/or robots), and/or the like.

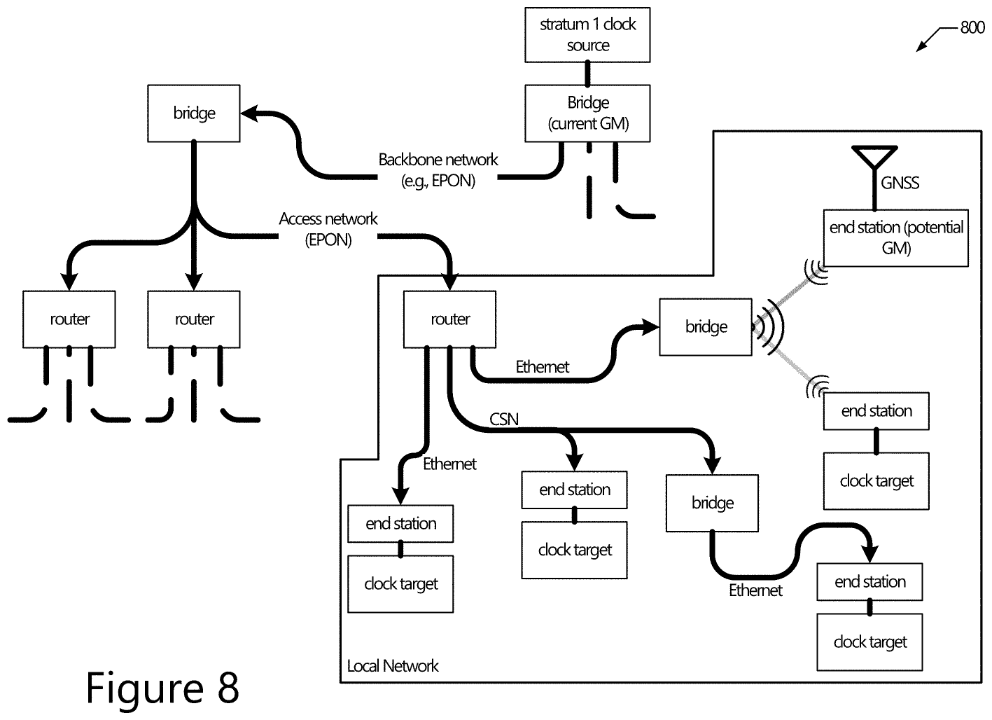

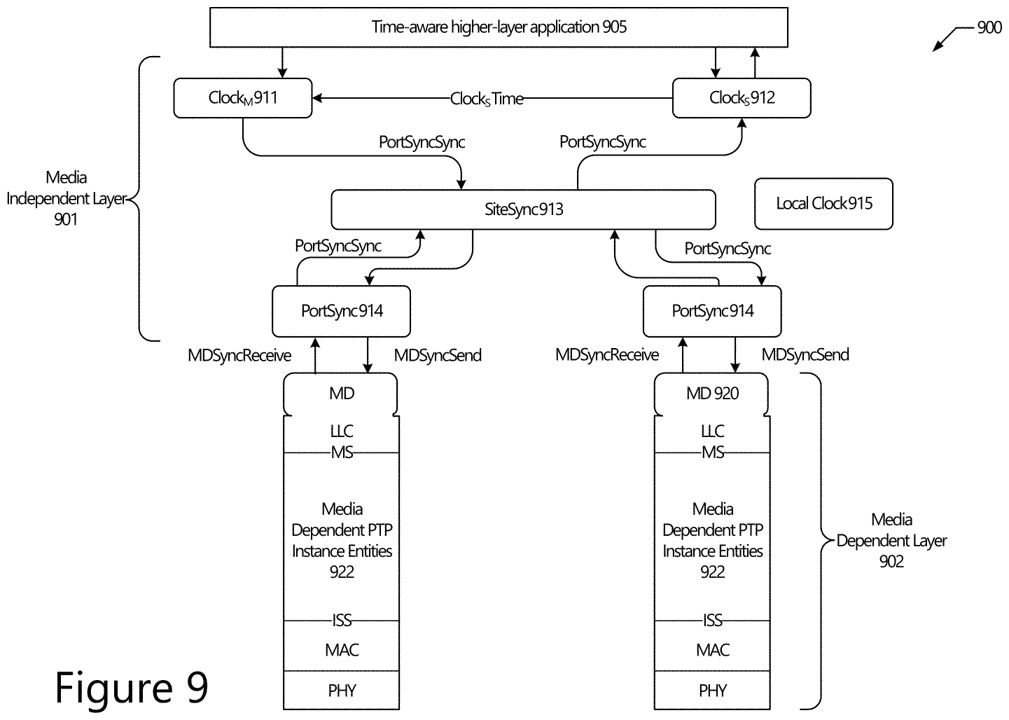

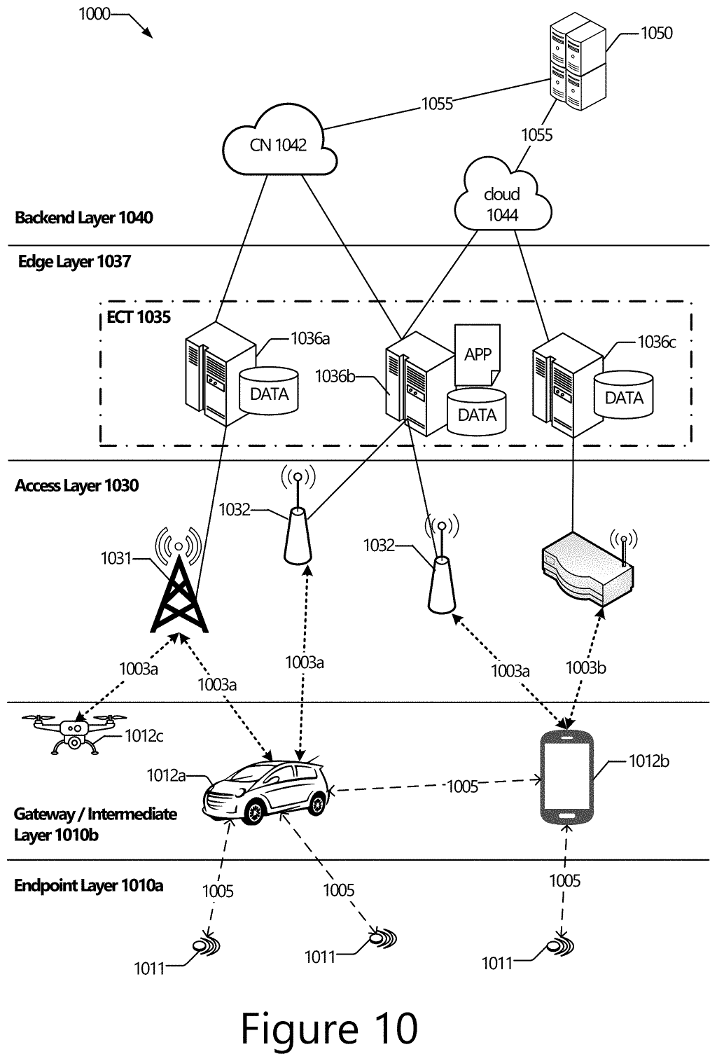

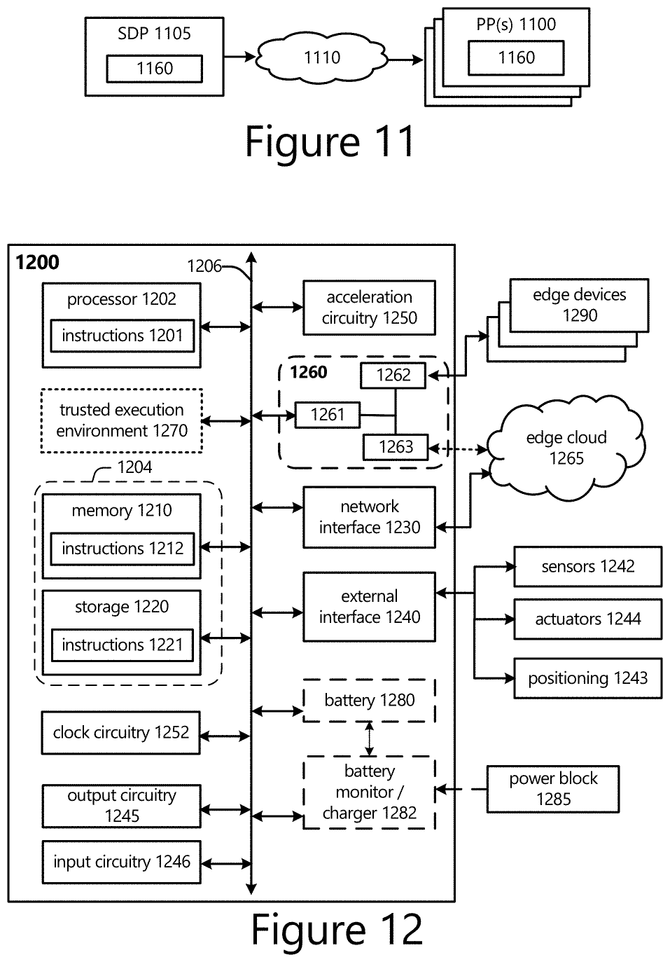

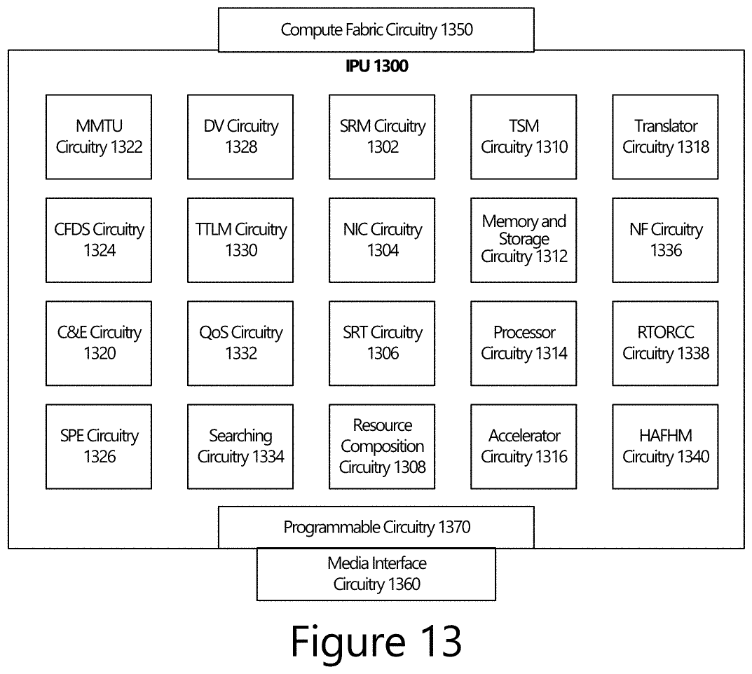

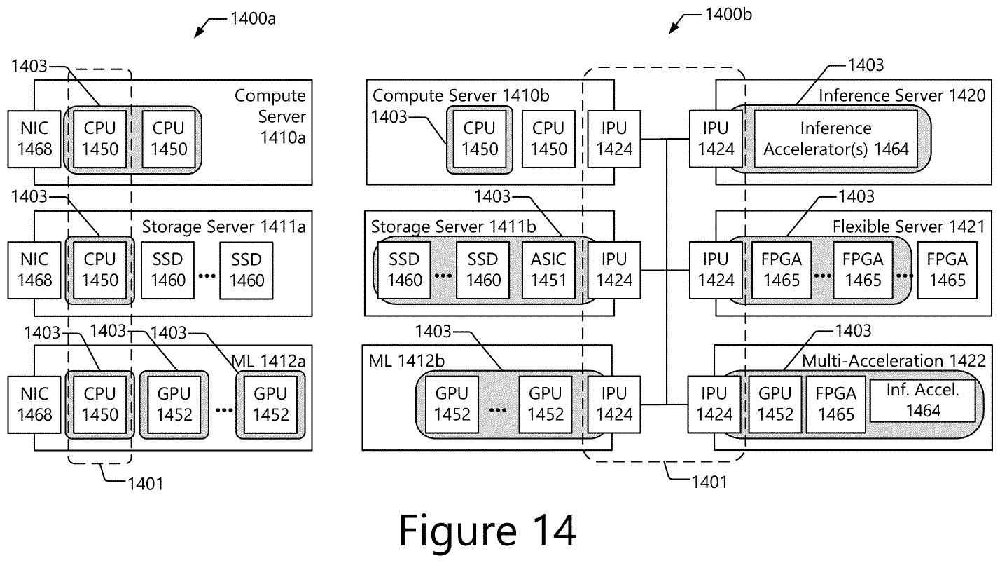

FIG. 4 illustrates an example compute node implementation 400 for an Rx data path. The compute node implementation 400 includes a host platform 490 and a network interface controller (NIC) 468. The host platform 490 includes host (system) memory 470 and a host processor (not shown by FIG. 4). Here, after Rx packets or frames have been received by the NIC 468, the Rx packets are provided to the host platform 490. The NIC 468 interacts with applications (apps) and/or middleware 491 operating in/on the host platform 490 via NIC driver/API 480. The NIC 468 also interacts with memory 470 via a system fabric (SF) (not shown), which may be, for example, a primary system fabric (PSF) and/or any other suitable IX technology (see e.g., IX 1206 of FIG. 12). Although the example of FIG. 4 is based on an Rx path, the concepts discussed herein could also be applied to the Tx path. In various implementations, the compute node implementation 400 may be part of any suitable network node or other computing device, such as, for example, any of the TASs in TAN 800 of FIG. 8; PTP instance 900 in FIG. 9; the UEs 1010, NANs 1030, edge compute node(s) 1036, cloud compute nodes (e.g., in cloud 1044), NF(s) (e.g., in CN 1042), and/or app servers 1050 of FIG. 10; processor platform(s) 1100 and/or SW distribution platform 1105 of FIG. 11; IPU 1300 of FIG. 13; any of the servers 1410a, 1410b, 1411a, 1411b, 1412a, 1412b, 1420, 1421, 1422 of FIG. 14; and/or any other type of computing device such as any of those discussed herein.

In some examples, the NIC 468 is a TSN Ethernet NIC 468, the NIC driver/API 480 is a TSN Ethernet driver/API 480. Additionally or alternatively, the host platform 490 may be a motherboard, a Multi-Chip Package (MCP), a System-on-Chip (SoC), a System-in-Package (SiP), or other like collection of hardware (HW) elements included in a complete computing system such as a server (e.g., blade, rack-mount, and/or the like), edge compute node, workstation, desktop computer, laptop or notebook computer, a network switch, a network access node (e.g., access point, base station, router, modem, bridge, gateway, and/or the like), a smartphone, a wearable device, an IoT device, a smart appliance, and/or the like. The host platform 490 includes a collection of chips/circuitry that includes processor circuitry (e.g., which may be the same or to similar as processor circuitry 1252 of FIG. 12) and host memory circuitry 470 (e.g., which may be the same or similar as system memory 1254 of FIG. 12), which act in concert to execute program code to carry out various tasks, such as executing apps/middleware 491, network protocol/stack 481, NIC driver/API 480, and/or the like. In some examples, the host platform 490 can be a data processing unit (DPU) and/or an infrastructure processing unit (IPU) that handles one or multiple NICs 401. The apps/middleware 491 may include various data buffers that store data to be transmitted via the NIC 468 (e.g., data of a Tx data path), or store received data destined for one or more applications (e.g., data of an Tx data path). The various data buffers correspond to different TCs, where each TC is represented by a different fill-pattern.

The host memory 470 (or system memory 470) may be embodied as any suitable memory device such as random access memory (RAM) including double data rate (DDR) (e.g., DDR1, DDR2, DDR3, DDR4, and future DDR implementations) and/or other RAM devices (e.g., SRAM, DRAM, SDRAM, and the like), cache memory devices, and/or some other suitable memory circuit(s). Although DDR is used as an example for the host memory throughout the present disclosure, the example implementations discussed herein should not be construed as limited to using such technologies and the implementations discussed herein may be applicable to any type or combination of memory technologies. In some implementations, the drivers/APIs 480 and/or network stack 481 can set up a wide variety of host memory objects that can be comprehended, manipulated, or otherwise consumable by the NIC 468, such as for security and reliability purposes.

Examples of such host memory objects include Rx queues 472-M and 472-N (collectively referred to as “Rx queues 472”, “queues 472”, “Rx frame buffers 472”, and/or the like). The queues 472 may be referred to as transmit (Tx) queues 472 when transmitting data over a Tx data path and referred to as Rx queues 472 when receiving data over an Rx data path. In this example, respective Rx descriptor ring buffers (Rx Desc) 471-M and 471-N (collectively referred to as “ring buffers 471”, “descriptor rings 471”, “Rx rings 471”, “Rx Desc 471”, and/or the like) include descriptors 473 that point to respective memory locations (or slots) in the Rx queues 472 for posting packets that arrive from the network (e.g., over the physical layer transceiver circuitry (PHY) 401). In this example, Rx Desc 471-M corresponds to Rx queue 472-M and Rx Desc 471-N corresponds to Rx queue 472-N. The Rx queues 472, 471 are typically mapped into OS or kernel space (or user space for dataplane switch-mode interface (DSI) drivers and/or the like). In a virtualized server, the Rx queues 472 can be assigned either to a VMM or to VMs using SR-IOV. The Rx queues 472 can be assigned to physical functions (PFs) and/or virtual functions (VFs) as needed (which may be represented by the apps/middleware 491 in FIG. 4). The Rx queues 472 assigned to a particular interface function (e.g., PF or VF) can be used for distributing packet processing work to the different processors in a multi-processor system. In some implementations, on the Rx side, packets are classified by the NIC 468 under OS or VMM control into groups of conversations. Each group of conversations is assigned its own Rx queue 472 and Rx processor or processor core according to, for example, hash-based classification (e.g., receive side scaling (RSS) or the like), flow director (FD) filtering (see e.g., Introduction to Intel® Ethernet Flow Director and Memcached Performance, INTEL CORP. White Paper (13 Oct. 2014), Chilikin et al., Intel® Ethernet Controller 700 Series: Hash and Flow Director Filters, INTEL.COM (30 Nov. 2018) (collectively referred to herein as “[FlowDirector]”), the contents of each of which are hereby incorporated by reference in their entireties), quad-hash (QH) classification, and/or another filtering or classification technique such as any of those discussed herein. Additionally or alternatively, individual Rx queues 472 are assigned to respective traffic classes (TCs), and on the Rx side, packets are classified by the NIC 468 into different TCs. Here, Rx queues 472 assigned to different TCs can be serviced at different rates by an Rx scheduler (not shown), a network stack 481, and/or a Quality of Service (QoS)-enabled OS and its SW device drivers/APIs 480.

Other memory objects that can be set up by the drivers/APIs 480 and/or network stack 481 can include other types of queues such as, for example, LAN Auxiliary structures (e.g., Tx completion queues, Tx doorbell (DB) queues, Tx quanta descriptor (QD) queues, and/or the like), LAN queue pairs (LQPs), protocol engine queue pairs (QPs), RDMA queues, control queue (or admin queue (AQ)) pairs, and/or the like (see e.g., Intel® Ethernet Controller X710/XXV710/XL710 Datasheet, INTEL® ETHERNET PRODUCTS GROUP (EPG), Order No.: 332464-026, revision 4.1 (June 2022) (“[X710]”), and Intel® Ethernet Controller E810 Datasheet, INTEL® ETHERNET PRODUCTS GROUP (EPG), document no.: 613875-006, revision 2.4 (March 2022) (“[E810]”), the contents of each of which are hereby incorporated by reference in their entireties).

Each descriptor 473 (including descriptors 473m1, 473m2, 473m3, and 473n1) is a SW construct that describes packets and/or memory locations where packets are stored or should be stored. For example, an address 474a (or memory location 474a) where the packet is stored or should be stored, a length 474b (or size 474b) of the packet or memory location, and/or the like. In various implementations, each descriptor 473 also includes status information 474c related to the packet, miscellaneous information 474d related to the packet, an OWN bit (0) 475a, and a NEXT bit (N) 475b. In some examples, the descriptors 473 are 16 byte data structures, although other size descriptors 473 can be used depending on the implementation of the compute system 400. Examples of the descriptors 473 for both the Tx and Rx data paths can include LAN descriptors, filter program descriptors, Fibre Channel over Ethernet (FCoE) descriptors, and/or other descriptors. In some examples, the descriptors 473 may be one quadword in length (e.g., 64 bits in x86 implementations, 128 bits in ARM implementations, and so forth) or two quadwords in length. In some implementations, the memory 470, or at least a portion of the memory 470 used to store the descriptors 473, can be arranged or implemented as ring or circular buffers (descriptor rings) 471-M, 471-N, such as, for example a LAN Tx/Rx queue (ring) (see e.g., [X710], [E810]).

The NIC 468 includes a host interface 467, packet engines (PEs) 404-M and 404-N (collectively referred to as “packet engines 404”, “PE 404”, and/or the like), and a MAC state machine 405 (also referred to as a “MAC layer 405”, “MAC entity 405”, or simply “MAC 405”). The MAC 405 includes buffers 411-M and 411-N (collectively referred to as “buffers 411”, “buffer 411”, and/or the like), in-transit data unit detectors (ITD) 420-M and 420-N (collectively referred to as “ITDs 420”, “ITD 420”, “in-transit packet detectors 420” or “ITPD 420”, and/or the like), a per-channel ITD controller 421, and a steering function/circuitry 422. For purposes of the present disclosure, when receiving packets over the Rx data path, the PEs 404 may be referred to as Rx PEs 404, the MAC 405 may be referred to as an Rx MAC 405, the buffers 411 may be referred to as Rx buffers 411, and the steering function/circuitry 422 may be referred to as an Rx steering function/circuitry 422. Similarly, when transmitting packets over the Tx data path, the PEs 404 may be referred to as Tx PEs 404, the MAC 405 may be referred to as a Tx MAC 405, the buffers 411 may be referred to as Tx buffers 411, and the steering function/circuitry 422 may be referred to as a Tx steering function/circuitry 422. Although not shown by FIG. 4, in some implementations the NIC 468 may also include a descriptor cache (not shown by FIG. 4) to store fetched descriptors 473 for later use, an Rx scheduler, PTP logic to measure the latency between a primary clock and an end-point clock and/or to inform the scheduler about TSN/TSA application data in one or more queues that buffer TSN/TSA application data or corresponding TCs, and/or other MAC and/or NIC elements/functions.

The host interface 467 is an interface between the host platform 490 and the NIC 468, which is used to convey data between the host platform 490 (e.g., memory 470) and the NIC 468. In some implementations, the host interface 467 implements a set of physical functions (PFs) and a set of virtual functions (VFs). As examples, the host interface 467 can be an integrated on-chip system fabric (IOSF) interface, an IX interface (e.g., PCIe interface), (R)DMA channels and/or (R)DMA programming interface, and/or the like.

The PEs 404 is/are a HW components that offload protocol processing from the host platform 490, places received data payloads directly into queues 472 with little or no host processor involvement, and eliminates user-kernel context switching when performing I/O by mapping the programming interface (e.g., (R)DMA programming interface) directly into application address space. Additionally or alternatively, the PE 404 can directly access the host memory 470 via the host interface 467 and/or via a direct channel (e.g., (R)DMA channel(s) or the like) in order to read or write data independently of and/or in parallel with host platform execution. The PE 404 can fetch descriptors 473 and store the descriptors 473 in a descriptor cache for later use. Multiple descriptors 473 can be fetched at a time to minimize interface 467 and memory 470 bandwidth overhead. For the Rx data path, Rx descriptors 473 are fetched to the descriptor cache when there are fewer descriptors 473 than incoming packets require and/or when the last free Rx descriptor 473 is used for an Rx packet. In some examples, the PE 404 can include multiple channels to access data stored in the queues 472. In one example, the PE 404 has one channel for each queue 472 and/or one channel per TC. As examples, the PE 404 may implement a direct memory access (DMA) based protocol such as ISA, PCI (or variants thereof), advanced microcontroller bus architecture high-performance bus (AHB), multichannel DMA (MCDMA) (e.g., AXI MCDMA, PCIe MCDMA, and/or the like), and/or the like; a remote DMA (RDMA) protocol such as iSCSI Extensions for RDMA (iSER) protocol, RDMA over Converged Ethernet (RoCE), RoCEv2 (or variants thereof), InfiniBand™ over Ethernet (IBoE), Internet Protocol over InfiniBand™ (IPoIB), internet wide area RDMA protocol (iWARP), and/or the like (for purposes of the present disclosure, the term “(R)DMA” may refer to DMA, RDMA, or both protocols); Intel® Omni-Path Architecture; Open Fabric Interface (OFI); Portals 4.0 Network Programming Interface; a message passing protocol such as Message Passing Interface (MPI), Intel® Performance Scaled Messaging (PSM), and/or the like. In some examples, the PE 404 may be, or include, an (R)DMA engine for processing (R)DMA packets; the PE 404 may be, or include, a LAN engine for processing LAN packets; the PE 404 may be, or include, an FCoE engine for processing FCoE packets; and/or the like.

As mentioned previously, the descriptors 473 include pointer 474a and length 474b pairs that point to locations in the data queues 472, and also include various control fields for data processing. The pointer 474a may also be referred to as an address 474a (or “addr 474a”). The address (addr) field 474a in an Rx descriptor 473 points to locations where data from received packets is/are to be stored or posted. The NIC 468 (or the MAC 405 or the PE 404) will fetch the descriptors 473 from the memory 470 based on a detected change to a tail pointer, parse the descriptors 473 to obtain the pointers 474a to where the data of Rx packets should be stored, and stores those pointers (or the descriptors 473 themselves) in corresponding slots in a descriptor cache in the NIC 468. After Rx descriptor 473 is prefetched, the address is known to the PE 404 for the transfer (e.g., DMA) operation of a received frame/packet from its corresponding Rx buffer 411. Each slot (also referred to as “descriptor queues”) may belong to a specific TC and a specific Rx Desc 471. Based on the pointers 474a in the descriptor cache, the PE 404 will store that data in a corresponding queue 472.

In some cases, additional control parameters that cannot fit within the data descriptors 473 are needed to process the packet(s). In these cases, additional context descriptors are used in front of the data descriptors 473. Examples of such context descriptors include transmit segmentation (TSO), FD filter programming (see e.g., [FlowDirector]), and FCoE context programming. Additionally or alternatively, the additional control parameters can be indicated using additional fields within individual descriptors 473. Examples of such fields/parameters include a status information field 474c, a misc field 474d, an OWN bit (O) 475a, and a NEXT bit (N) 475b.

The MAC 405 is a data link sublayer that is responsible for transferring data to and from the PHY 401. The PHY 401 contains various functions that transmit, receive, and manage encoded signals that are impressed on and recovered from the physical medium (see e.g., [IEEE802.3], clauses 23 to 26, 32, 36, 40, 48-54, 58-63, 65-66, 82-89, and 96). Examples of the PHY 401 functions include the physical coding sublayer (PCS), the physical medium attachment (PMA), and in some cases, a WAN interface Sublayer (WIS) and a physical medium dependent (PMD) sublayer.

The buffers 411 store data obtained from received packets, which is/are then forwarded to, or otherwise stored in, a corresponding queues 472. The buffers 411 may be implemented using in-package memory circuitry (also referred to as “on-chip memory circuitry”, “on-die memory circuitry”, or the like) and/or cache device/circuitry. The in-package memory circuitry may include the same or similar memory devices discussed herein such as, for example, a DDR SRAM circuit. Although DDR is used as an example for the in-package memory circuitry throughout the present disclosure, the example implementations discussed herein should not be construed as limited to using such technologies and the implementations discussed herein may be applicable to any type or combination of memory technologies. In the example of FIG. 4, the buffers 411 may implement a FIFO queue management technique, however, any suitable queue management technique, AQM technique, and/or cache replacement technique (e.g., such as any of those discussed herein), or any combination thereof, can be used in other implementations. Additionally, each buffer 411 is connected to its corresponding PE 404 via a data path 412, which is used for signaling or otherwise indicating when an Rx frame is ready and/or when packet transfer (e.g., (R)DMA transfer) is done.

In addition to the aforementioned elements, the NIC 468 includes a set of ITPDs 420 and an ITPD controller 421. Each ITPD 420 may be embodied as one or more circuits or other HW elements on or in the NIC 468 (or inside the MAC 405), and the ITPD controller 421 may also be embodied as one or more circuits or other HW elements on or in the NIC 468 (or inside the MAC 405). In alternative implementations, ITPD 420 may be embodied as one or more circuits or other HW elements on or in the PHY 401 (e.g., RAT circuitry) since some PHY 401 implementations perform some packet filtering earlier in the Rx data path. In various implementations, each ITPD 420 corresponds to a buffer 411. For example, in FIG. 4, ITPD 420-M corresponds to the buffer 411-M and the ITPD 420-N corresponds to the buffer 411-N. Although FIG. 4 only shows two ITPDs 420 and two buffers 411, there may be many more ITPDs 420 and buffers 411 than shown by FIG. 4. In some implementations, there may be multiple buffers 411 that correspond to an individual ITPD 420, or vice versa. In some implementations, individual ITPDs 420 are defined for, or otherwise correspond to, respective hardware queue 411 based on an assigned TC. In these implementations, there may be a one-to-one correspondence of ITPDs 420 to buffers 411, and each buffer 411 and/or ITPD 420 corresponds to a particular TC.

Additionally or alternatively, the number and types of TCs may be defined by relevant communication standards and/or communication protocols (e.g., [IEEE802.3], [IEEE1588], [IEEE802.1AS], and/or the like). For example, TSN-based NICs 468 have eight HW queues 411, each belonging to a particular traffic class (e.g., TC7 to TC0), where traffic class 7 (TC7) to traffic class 5 (TC5) are assigned to queues 411 for handling higher priority data streams (e.g., cyclic data streams) and TC0 to TC4 are assigned to lower priority data streams (e.g., non-cyclic (or acyclic) data streams). In these implementations, there can be three ITD circuits 420 belonging to TC7 to TC5 Rx queues 411, respectively, and queues 411 assigned to TC0 to TC4 may or may not have corresponding ITD circuits 420. Additionally or alternatively, the ITD controller 421 may designate or otherwise assign individual ITD circuits 420 to respective Rx queues 411. In some implementations, the ITD controller 421 can be a switch (or include switch logic) that turns on or off specific ITD circuits 420. For example, the ITD controller 421 may determine that buffer 411-M is assigned to handle TC7 streams and that buffer 411-N is assigned to handle TC0 streams, and as such, may turn on or activate ITD 420-M and turn off or deactivate ITD 420-N.

As an example, in TSN/TSA implementations, queues 411 assigned to TC7, TC6, and TC5 may be used for cyclic queuing and forwarding (CQF), which is a traffic shaping technique for handling deterministic and/or time-sensitive traffic streams. CQF involves stream traffic being transmitted and queued for transmission along a network path in a cyclic manner. Here, time is divided into numbered time intervals (or cycles) i, i+1, i+2, . . . i+N, each of duration d. Frames transmitted by a first node during interval/cycle i are received by a second (downstream) node during time interval/cycle i and are transmitted onwards by the second node towards a third node during time interval i+1, and so on. In some examples, each interval/cycle i may include the batch processing cycles discussed herein. A starting assumption is that, for a given TC, all nodes/stations in the network (or network path) have a common understanding of the start time of cycle i and the cycle duration d (to a known accuracy and/or within a standard deviation). The latency introduced as a frame transits the network is completely described by the cycle time and the number of hops, and is unaffected by any other topology considerations, including interference from other non-time-sensitive traffic. However, this only holds if frames are kept to their allotted cycles. For example, if a frame that is expected to be received within a specific cycle does not appear until the next cycle, such as described previously with respect to (w.r.t) FIGS. 1-3, then the assumptions about maximum latency expectations no longer hold. Most previous solutions focus on the choice of cycle times, alignment of cycle times among the network nodes, and the timing of transmissions within a cycle are required in order to ensure that the desired latency bounds are achieved. The example implementations discussed herein improve the timing and/or cycles of data transfers between the NIC 468 and host platform 490 and/or improve the batch processing cycle alignment to ensure that the desired latency bounds are achieved.

The ITDs 420 are responsible for detecting or otherwise identifying individual Rx packets in their corresponding buffers 411 that belong to the same Rx frame. In various implementations, each ITD 420 tags a current Rx packet/frame with a “next bit” flag (e.g., also referred to as a “next bit tag” or the like) when all the Rx data belonging to that frame is read out of its corresponding buffer 411 and/or when the corresponding buffer 411 is not empty. The next bit flag indicates that there is additional packet(s) in transit that are already in the Rx buffer 411. As examples, for tagging the Rx packets, the ITD 420 can insert the next bit flag/tag into an end-of-packet (EOP) field, an EOP delimiter (EPD), end-of-stream delimiter (ESD), and/or other like field of the Rx frame/packet. These additional packets can be partial packets, complete packets, and/or any combination thereof. Additionally or alternatively, the additional packets belong to the same TC, but have not yet been transferred over to the host (system) memory 470. In some implementations, the next bit tag in the Rx packets/frames may be extracted by the PE 404 as they are read out of the buffer 411, and the extracted next bit tag may be inserted into the corresponding Rx descriptor 473. Additionally or alternatively, before the Rx packet/frame is stored in the host memory 470, a VLAN tag in the Rx packet/frame can be stripped and optionally stored in the corresponding Rx descriptor 473. In some cases, the networking protocol may not always guarantee that the next frame is back-to-back, and in such cases, the next bit/flag may cause undesirable waiting effects (e.g., delay, latency, jitter, and the like). To counter these undesirable effects, the Rx PE 404 may be configured to only set the next bit/flag if it is already aware that the actual next packet/frame is inside the Rx buffer 411. Additionally or alternatively, for NIC 468 implementations that use metadata fields at the head of Rx queue 472 to store information about the current frame/packet, the next bit information can be stored in these metadata fields in addition to current in Rx descriptor 473.

Packet/frame reception involves the PHY 401 obtaining a packet or frame over a communication medium (e.g., wired or wireless medium), filtering, queue assignment, storing the packet in an Rx buffer 411, transferring the data to assigned Rx queues 472 in host memory 470, and updating the state of an Rx descriptor 473 corresponding to the packet. During operation for packet reception (Rx data path), the PHY 401 passes a received packet/frame to the MAC 405. The MAC 405 performs initial processing on the Rx frame/packet including, for example, checksum verifications and/or the like. The Rx packet/frame (or the packet header) then goes through a packet processing pipeline where parsing, switching, ACL, and classification/filtering takes place. For the filtering, the MAC 405 forwards the packet to one or more Rx filters, and if the packet matches (pre-programmed or configured) criteria of the Rx filter(s), the packet is forwarded to the Rx buffer 411. As examples, the Rx filters can include Ethertype and/or L2 filters (e.g., Ethernet MAC Address, unicast, multicast, or broadcast), FCoE context filters (e.g., FCoE redirection tables), L3/L4 5-tuple filters, MAC and/or virtual LAN (VLAN) filters, manageability filters (e.g., port, IP, flex, and/or the like), switch filters, access control list (ACL) filters, FD filters (e.g., Q steering), hash filters (e.g., RSS and/or the like), (R)DMA/QH filters, TCP SYN filters, CQF per-stream filtering and policing (see e.g., [IEEE802.1Q], Annex T), custom/programmable filters and/or ACLs, and/or the like (see e.g., [E810], [X710]). The Rx packet processing pipeline can also involve updating various statistics counters and/or stripping out various data (e.g., cyclic redundancy check (CRC) bits, Rx padding bytes, preamble, start of frame delimiter (SFD), VLAN tags, and/or the like). In some implementations, the MAC 405 can be configured to strip or otherwise remove different fields or data elements from received packets/frames, or provide the full Rx frame/packet without stripping out or removing any information from the frame. After packet processing, the MAC 405 passes the processed packet/frame to the host platform 490 via the host interface 467.

Before being passed to the host platform 490, the packets/frames are stored in an appropriate buffer 411. In various implementations, the Rx frame steering function 422 detects the incoming Rx frames and steers the Rx frames to the appropriate queue 411. The Rx frame steering function 422 uses various matching criteria of any of the aforementioned filtering mechanisms (or combinations thereof), packet inspection/snooping techniques, and/or some other packet steering mechanism/technique. In one example, the Rx frame steering function 422 steers Rx packets/frames to a buffer 411 according to priority information included in a VLAN tag of each packet/frame. Additionally or alternatively, the Rx frame steering function 422 steers Rx packets/frames to an appropriate buffer 411 using steering tags (ST) and/or processing hints (PH) as discussed in [E810] and/or [X710]. It should be noted that the frame/packet steering may be performed during any appropriate stage in the Rx MAC packet processing pipeline.

Before, after, or concurrently with receipt of frames or packets, the host platform 490 allocates chunks, partitions, or other sections of the system memory 470 to be used as respective Rx queues 472, and also allocates chunks, partitions, or other sections of the system memory 470 to be used as respective descriptor rings 471. The host platform 490 then fills or otherwise configures each Rx Desc 471 with the information about its corresponding Rx queue 472 (e.g., address/location 474a of its corresponding frame buffer 472, length 474b of its corresponding frame buffer 472, and/or the like). The length or size of each frame buffer 472 of an Rx Desc 471 may be fixed in size (e.g. through a register on the NIC 468 that is configured by the host platform 490), or has a variable size by setting the length field 474b of the corresponding Rx descriptor 474. Each queue 472 is associated with a cyclic descriptor ring 471, and the cyclic ring 471 comprises a sequence of Rx descriptors 473 in contiguous memory.

The NIC 468 maintains a set of parameters for each Rx descriptor ring 471, usually in its memory-mapped register spaces that contains “Rx descriptor ring context” information (not shown in FIG. 4) about the Rx descriptor rings 471 on the system memory 470. Examples of the Rx descriptor ring context information include a base address (or base (index) pointer), length of the Rx descriptor rings 471, head (index) pointer, and tail (index) pointer. The base address provides the base/start location of the Rx descriptor ring 471 on the system memory 470. The length specifies the number of Rx descriptors 473 that belong to the Rx descriptor ring 471. The size of an Rx descriptor 473 is typically fixed at 8 bytes or 16 bytes. The head and tail (index) pointers are read/written by both the NIC 468 and the host platform 490 to coordinate which Rx descriptor 473 is being processed by the NIC 468. For example, the head (index) pointer points to the current Rx descriptor 473 (relative to the base address) being processed by the NIC 468, and the tail (index) pointer points to the Rx descriptor 473 (relative to the base address) that has been setup by the host platform 490 for future Rx frame receiving (also referred to as a “head chasing the tail pointer design”). When a data frame/packet is written to a slot/memory location indicated by the tail (index) pointer, the tail (index) pointer is incremented to the next slot of the queue 472. Additionally, when a data frame/packet is read out of a slot/memory location indicated by the head (index) pointer, the head (index) pointer is incremented to the next slot of the queue 472. Additional aspects of the descriptor rings 471 are discussed in [X710] and [E810].

When the Rx PE 404 senses a change of a specific RDT, the PE 404 sends a request (e.g., IRQ) via the host interface 467 to fetch the descriptors 473 from the host memory 470 (e.g., the NIC 468 prefetches one or more Rx descriptors 473 ahead of time into its MAC 405). The descriptors 473 content is received in a read operation and is written to the appropriate location in a descriptor queue of the internal descriptor cache.

When a new Rx frame/packet in Rx buffers 411 are ready to be transferred (e.g., DMA operation) to the system memory 470, the destination location of the Rx queues 472 for the transfer (e.g., DMA) operation is obtained from the address field 474a of an Rx descriptor 473. After the transfer (e.g., DMA) operation completes, the fields 474a, status field 474c, and so forth in the Rx descriptors 473 are updated before the head (index) pointer belong to the Rx descriptor ring context is incremented to the next slot by the NIC 468. The host platform software SW 480, 481 processes a ready Rx descriptor 473 pointed by the tail (index) pointer, and when the processing completes, the tail (index) pointer is incremented to the next slot.

The Rx packets/frames are posted to system (host) memory queues 472 indicated to the HW by descriptors 473 and through the set of queues 472. The descriptors 473 include pointers/addresses 474a that point to or otherwise indicate respective slots (or memory locations of such slots) in the data queues 472. For example, the pointer/address 474a in descriptor 473m1 points to a memory location 1 (slot 1) of queue 472-M, the pointer/address 474a in descriptor 473m2 points to a memory location 2 (slot 2) of queue 472-M, the pointer/address 474a in descriptor 473m3 points to a memory location 3 (slot 3) of queue 472-M, and the pointer/address 474a in descriptor 473n1 points to a memory location 1 (slot 1) of queue 472-N. The descriptors 473 also include status indications 474c of the Rx frames/packets. The Rx descriptors 473 are fetched on demand to/from host memory 470 and/or descriptor cache on the NIC 468. The Rx PE 404 fetches the next descriptor 473 from the internal cache of the appropriate queue to be used for the next Rx packet. After the entire packet is placed into the Rx buffer 411, the Rx PE 404 posts the packet data to the location indicated by the descriptor 473 through the host interface 467. If the packet size is greater than the size of the queues 472, more descriptors 473 are fetched and their queues 472 are used for the Rx packet. When the packet is placed into host memory 470, the Rx PE 404 updates some or all the descriptor(s) 473 that were used by packet data. After enough descriptors 473 are gathered for a write back operation, an interrupt moderation timer expires and/or the packet requires immediate forwarding, the Rx PE 404 writes back the descriptor 473 content along with status bits 474c that indicate the packet information including what off loads were done on that packet and/or the like. After the interrupt moderation timer completes or an immediate packet is received, the NIC 468 initiates an interrupt (e.g., IRQ or the like) to the host 490 to indicate that a new received packet is already in host memory 470. The host 490 may read the packet data and send it to the network stack 481 and/or the network driver 480 for further processing, and the host 490 releases the associated queues 472 and descriptors 473 once they are no longer in use.

When a descriptor 473 is fetched, the NIC 468 (or the Rx PE 404) will point to the location 474a in memory 470 indicated by the descriptor 473, and the NIC 468 (or the Rx PE 404) will attempt to store the data there and close the descriptor 473 so that the descriptor 473 will be given back to the to the SW (e.g., network stack 481, network driver 480, and/or the like). For example, in FIG. 4, the Rx PE 404-M will attempt to store data M-1 in memory location 1 in queue 472-M, which is indicated by the descriptor 473m1; will attempt to store data M-2 in memory location 2 in queue 472-M, which is indicated by the descriptor 473m2; and will attempt to store data M-3 in memory location 3 in queue 472-M, which is indicated by the descriptor 473m3. Additionally, the Rx PE 404-N will attempt to store data N-1 in memory location 1 in queue 472-N. At this point, the three descriptors 473m1, 473m2, and 473m3 are owned by the NIC 468, and the NIC 468 has not released these descriptors 473.

Once the data is written to the appropriate location in the queue 472, the NIC 468 (or the Rx PE 404) will toggle the OWN bit 475a of the corresponding descriptor 473 so that ownership of that descriptor 473 is transferred back to the SW (e.g., network stack 481, network driver 480, and/or the like). For example, after the Rx PE 404-M stores data M-1 in memory location 1 in queue 472-M, the Rx PE 404-M will set the OWN bit 475a of descriptor 473m1 to an appropriate value so that the SW (e.g., network stack 481, network driver 480, and/or the like) knows that data M-1 is available to be read out of location 1 of the queue 472-M. For example, the Rx PE 404 will clear the OWN bit 475a (or set the OWN bit 475a to “0”) to indicate that the MAC 405 (HW) does not own the Rx descriptor 473 anymore. This process will be repeated by the NIC 468 (or the Rx PE 404) for each data item to be read out of the buffer 411 and written into the queue 472. After the SW (e.g., network stack 481, network driver 480, and/or the like) reads the data out of location 1 of the queue 472-M, the SW (e.g. network stack 481, network driver 480, and/or the like) will set the OWN bit 475a of descriptor 473m1 to an appropriate value (e.g., set the OWN bit 475a to “1”) so that the NIC 468 (or the Rx PE 404) knows that data can be stored in location 1 of the queue 472-M. Furthermore, the aforementioned processes can take place in a batch-wise fashion where, for example, multiple descriptors 473 are fetched by the NIC 468 (or the Rx PE 404) as a batch, and multiple data items are read from the buffer 411 and written into the queue 472 during each batch (writing) cycle.

The Rx data path will operate in this ping pong fashion until there is no more data to be transferred from the NIC 468 to the host memory 470. In most implementations, there is a limited number of descriptors 473 (e.g., 200 descriptors 473 or the like), which are recycled as data is written to the queues 472. Because there is a limited number of descriptors 473, the descriptors 473 are recycled so that data can continue to be transferred from the NIC 468 to the host memory 470. Furthermore, as some of the descriptors 473 are owned by the NIC 468 and/or as data is being written into the corresponding memory locations in the queue 472, other descriptors 473 are owned by the SW (e.g., network stack 481, network driver 480, and/or the like) and/or the SW (e.g., network stack 481, network driver 480, and/or the like) is copying the data from the corresponding memory locations of the queue 472 into the appropriate app/middleware 491.

As alluded to previously, when the Rx PE 404 releases a batch of descriptors 473, an interrupt (e.g., IRQ) is generated and signaled to the host processor to indicate that those descriptors 473 have been released. When the SW (e.g., network stack 481, network driver 480, and/or the like or the like) goes to process the data of the released descriptors 473, the SW (e.g., network stack 481, network driver 480, and/or the like) may block the interrupt so that the NIC 468 cannot write or signal more interrupts. As an example, a batch of packets to be processed may include data M-1 and M-2 even though all three data items M-1, M-2, and M-3 belong to the same packet. In previous solutions, such as those discussed previously, the SW (e.g., network stack 481, network driver 480, and/or the like) is only aware of the data that can be copied out of the queue 472 based on the released descriptors 473 (e.g., based on the value of the OWN bits 475a), and has no way of knowing that data M-3 belongs to the same packet as data M-1 and M-2 and should be processed within the same batch interval as data M-1 and M-2. Here, processing of data M-3 may have been delayed due to various jitter discussed previously.

Since the NIC 468 (or the ITPD 420) knows that there is one more data item that could be written into the queue 472 within the same batch of interval, the ITPD 420 will write an appropriate value into the NEXT bit 475b of the previous descriptor 473 corresponding to a previously processed data item to indicate that there is a following data item that can be processed within the same batch interval. For example, where the batch includes data M-1 and M-2, the ITPD 420 will write an appropriate value into the NEXT bit 475b of the descriptor 473m1 and 473m2 so that the SW (e.g., network stack 481, network driver 480, and/or the like) will know that there is another data item M-3 that can be processed in the same batch interval.

During operation, when an Rx packet/frame is received by the NIC 468, the Rx packet/frame first goes through an Rx frame steering function 422 (see e.g., [FlowDirector] logic and/or the like) that detects the packet's priority (or TC) based on one or more fields of in the packet (e.g., one or more packet header fields and/or the like). As examples, the packet's priority and/or TC may be indicated by a VLAN field, a priority code point (PCP) field, and/or one or more other packet fields. The Rx frame steering function 422 redirects the Rx packet to a particular HW queue 411. Then, the ITD 420 tags each packet belonging to the same frame with a next bit flag as it is read out of the buffer 411 into the queue 472. Once the packet is tagged with the next bit flag, an indication is sent by the ITD 420 to the corresponding PE 404. The PE 404 writes an appropriate value (e.g., high or “1”) in the next bit field/bit 475b of the corresponding descriptor 473 when (or after) it closes or releases that descriptor 473 by clearing the OWN bit 475a (e.g., by setting the OWN bit 475a to low or “0”). In some examples, the PE 404 sets or writes the appropriate values into the next bit field 475b and/or the OWN bit 475a over the host interface 467 and/or via a dedicated channel (e.g., a DMA channel and/or the like). Setting the next bit 475b (e.g., to high or “1”) in the corresponding descriptor 473 indicates to the SW (e.g., network stack 481, network driver 480, and/or the like) that there are more packet(s) inflight or otherwise still in the buffer 411 after the current packet. In these ways, the next bit indication reduces or eliminates the packet propagation jitter described previously.

In some implementations, the next bit field 475b in each descriptor 473 is set to low (e.g., a value of “0”) by default. In these implementations, when the ITD 420 detects the last packet belonging to a frame, the ITD 420 does not tag the last packet with the next bit flag as it is read out of the buffer 411 and/or written or transferred into the queue 472. Because the last packet is not tagged with the next bit flag, no “next bit” indication is sent to the PE 404 and the next bit field 475b of the corresponding descriptor 473 is not set (e.g., maintains the “0” value) when that descriptor 473 is closed or released. Not setting the next bit 475b (e.g., maintaining low or “0”) in the descriptor 473 corresponding to the last PDU/packet indicates to the SW (e.g., network stack 481, network driver 480, and/or the like) that there are no more packets/PDUs inflight or otherwise still in the buffer 411 after the current packet/PDU, and as such, a task switch can take place without incurring jitter-related delays/latency.

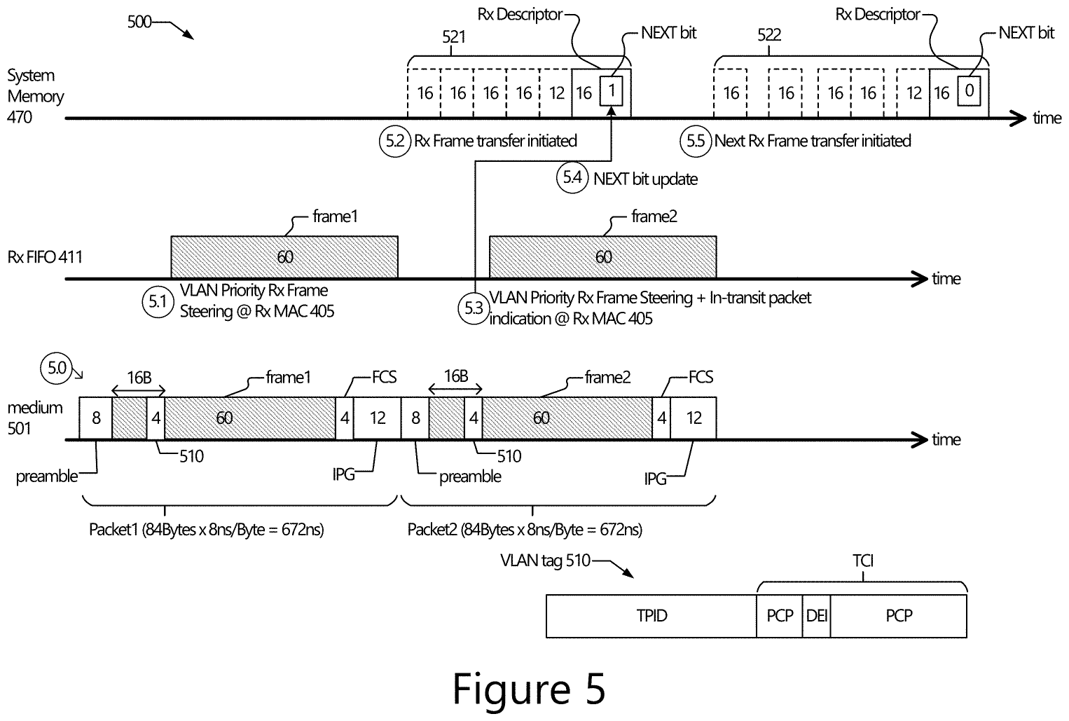

FIG. 5 shows an example timing diagram 500 for a sequence of events for two back-to-back Ethernet packets (e.g., packet1 and packet2) that arrive over a communication medium 501 (e.g., Ethernet cable, wire, air interface, and/or the like) separated by a minimum IPG, and packet2 experiences SySBus congestion. In this example, each packet includes a preamble (or syncword). Each packet includes a frame (e.g., a MAC frame, data frame, or other type of frame) preceded by a preamble and a start frame delimiter (SFD), encoded for a particular PHY 401 type. In some examples, a packet can include one or more extension fields/symbols. The preamble field (e.g., 7 octets) allows the PLS circuitry to reach steady-state synchronization with the received packet's timing (see e.g., [IEEE802.3]§ 4.2.5). The SFD (e.g., 1 octet) marks the end of the packet preamble and indicates the beginning of the frame. In some examples, the SFD field is the sequence 10101011. In this example, each frame is 60 bytes in size/length, however, the frames may have different sizes/lengths in other implementations.

The frame of each packet includes a destination address field (e.g., 6 octets) specifies the station(s) for which the MAC frame is intended, a source address field (e.g., 6 octets) including an address of the station sending the frame, a length/type field (e.g., 2 octets), a (MAC) client data (e.g., 46 to 1500 octets), and a frame check sequence (FCS) field (e.g., 4 octets), and an IPG field (e.g., 12 octets). In some examples, the frame can include one or more padding bytes/octets. The FCS field includes a 32-bit CRC value. The length/type field indicates either the number of MAC client data octets contained in the subsequent MAC client data field of the basic frame (e.g., a “length interpretation”) or the Ethertype of the MAC client protocol (e.g., a “type interpretation”). The MAC client data field contains a sequence of octets depending on the frame type (e.g., basic, Q-tagged, envelop, and/or the like).

Additionally or alternatively, the frame can include a VLAN tag field 510 (e.g., 4 octets) between the source address field and the length/type field. In some implementations, multiple [IEEE802.1Q] tag fields 510 may be included in a frame. The [IEEE802.1Q] tag field 510 includes a VLAN tag (also referred to as a “[IEEE802.1Q] tag 510” or the like). Tagging a frame with a VLAN tag 510 allows a VLAN identifier (VID) to be conveyed, facilitating consistent VLAN classification of the frame throughout the network and enabling segregation of frames assigned to different VIDs. The VLAN tag 510 also allows priority to be conveyed with the frame when using IEEE 802 LAN media access control methods that provide no inherent capability to signal priority (see e.g., IEEE Standard for Local and metropolitan area networks—Media Access Control (MAC) Service Definition, IEEE Std 802.1AC-2016, pp. 1-52 (10 Mar. 2017) § 6.8, the contents of which are hereby incorporated by reference in its entirety). The [IEEE802.1Q] tag field 510 includes a tag protocol identifier (TPID) field (e.g., 16 bits) and a tag control information (TCI) field (e.g., 16 bits). The TCI field is divided into a priority code point (PCP) field (e.g., 3 bits), a drop eligible indicator (DEI) field (e.g., 1 bit), and a VID field (e.g., 12 bits).

The TPID includes an EtherType value that is used to identify the frame as a tagged frame and to select the correct tag decoding functions. Such an EtherType is known as the Tag EtherType. The TPID is EtherType encoded, is two octets in length and contains only the assigned EtherType value. The TPID can indicate that the VLAN tag is one of the following types of tags: B-TAG, C-TAG, CN-TAG, F-TAG, I-TAG, and S-TAG. A distinct EtherType is allocated for use in the TPID field of each tag type so they can be distinguished from each other, and from other protocols.

The TCI field is two octets in length and encodes the VID, DEI, and PCP parameters of a corresponding Enhanced Internal Sublayer Service (EISS) request as unsigned binary numbers. The TCI is dependent on the tag type. The VID is encoded in a 12-bit field, and is used to associate a frame with a particular VLAN and/or a loop-free active topology. The PCP field includes a PCP values, which may be the same or similar as a class of service (CoS) value. The PCP and/or CoS value maps to a frame priority level. Different PCP values can be used to prioritize different classes of traffic. The DEI field includes a DEI value, which may be used separately or in conjunction with the PCP to indicate frames eligible to be dropped in the presence of congestion. Use of the DEI allows the VLAN tag to convey eight distinct priorities, each with a DEI.

During operation, the two packets arrive over the communication medium 501 separated by a minimum IPG (5.0). Then, the Rx steering function 422 steers the Rx frame1 to the desired Rx buffer 411 based on the TC of the Rx frame1 and/or the priority indicated by the VLAN tag 510 (5.1). The PE 404 initiates the Rx frame transfer (e.g., (R)DMA transfer or the like), and frame1 is transferred in data chunks (or PDUs) to system memory 470 with little or negligible SySBus congestion (5.2). Here, the internal SySBus is usually higher speed compared to the speed of the medium 501 (e.g., wire speed), and therefore, the duration for the frame transfer 521 usually takes a shorter amount of time at least when compared to the transfer 522.

As soon as frame2 is steered into the same Rx buffer 411, the corresponding ITD 420 latches the indication about Rx frame2 (5.3). Here, the ITD 420 may tag the next bit field in frame1 to indicate that a next frame should be processed with frame1. Additionally or alternatively, the ITD 420 may signal the PE 404 to indicate that frame1 is not the last frame to be processed in the current batch cycle, and/or that there are still in-transit packets/frames for the current batch cycle. At the end of the frame/data transfer (e.g., (R)DMA transfer) of frame1, the PE 404 reads about or is otherwise notified about in-transit Rx frame(s) (e.g., frame2) and writes or sets the NEXT bit 475b (e.g., NEXT bit=1) during the Rx descriptor 473 update for frame1 (5.4). Then, the frame/data transfer 522 (e.g., (R)DMA transfer) of frame2 is initiated (5.5). Due to SySBus congestion, the transfer 522 of the data chunks (or PDUs) of frame2 may happen over a relatively long duration, at least when compared to the speed of transfer 521. At the end of the frame/data transfer 522 (e.g., (R)DMA transfer), since there is no 3rd Rx frame in the Rx buffer 411, the NEXT bit 475b is updated on the RX descriptor 473 for frame2 (e.g., NEXT bit=0). Additionally or alternatively, the Rx descriptor 473 corresponding to frame2 is not set (e.g., NEXT bit=0).

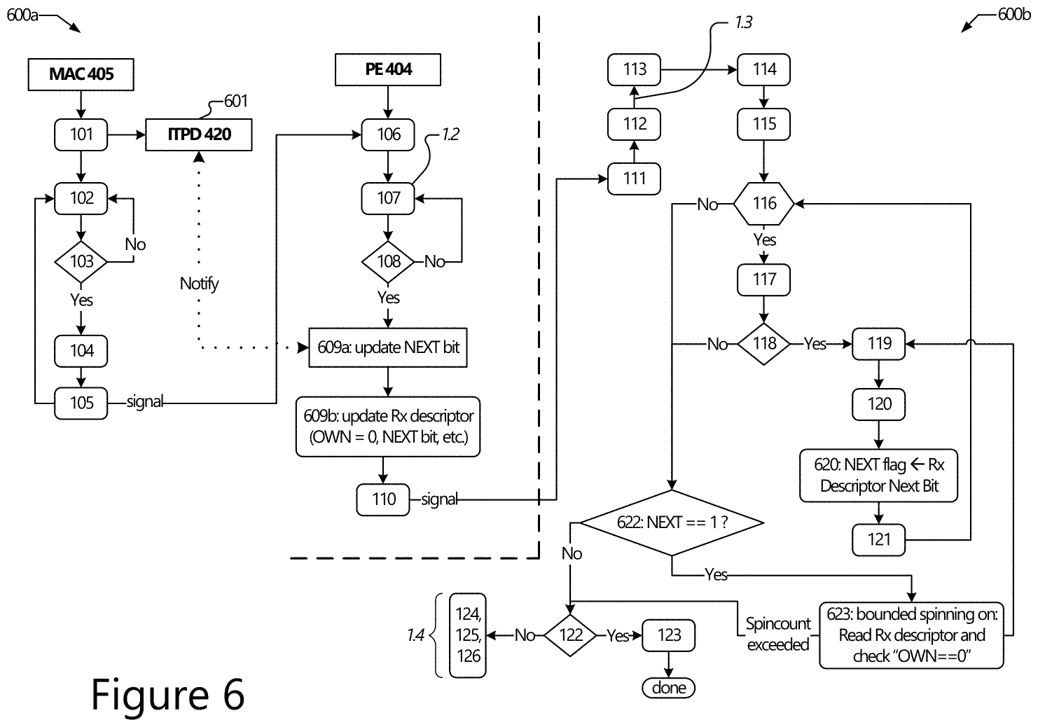

FIG. 6 shows the enhanced process for Rx data path handling, which includes a network controller process 600a that may be performed by NIC 468 and a host platform process 600b that may be performed by host processor circuitry of host platform 490 including interactions with host (system) memory 470. In FIG. 6, like-numbered elements are the same as those discussed previously w.r.t FIG. 1. The updated network controller process 600a includes the Rx frame/packet being sent to the ITD 420 corresponding to the buffer 411 in which the frame/packet is stored (601) after Rx frame steering (101). Then, the ITD 420 sends a notification to the Rx PE 404 to update the NEXT bit 475b in the corresponding Rx descriptor 473 (609a) after the Rx frame has been transferred to the Rx buffer (108), and then the Rx PE 404 updates the corresponding Rx descriptor 473 accordingly (609b).

The host platform process 600b includes, when the OWN bit 475a is set to zero (118), the host processor checks the NEXT bit flag of the frame/packet and/or the NEXT bit field 475b in the Rx descriptor 473 (620) to determine if there is a next in-transit frame/packet to be processed, and sets the NEXT indicator. The NEXT indicator/indication can be done either by setting the NEXT bit 475b in the Rx descriptor 473 or by setting a NEXT metadata field in the metadata in the Rx queue buffer 472. Additionally, the host platform process 600b includes determining if the NEXT bit 475b in the corresponding Rx descriptor 473 is set to one (622) when the count size/amount is not less than the batch size/amount (116) and/or when the OWN bit 475a is not set to zero (118). If the NEXT bit 475b is not set to one (622), then the host processor proceeds to determine whether the count is set to zero (122). If the NEXT bit 475b is set to one (622), then the host processor (with bounded spinning on) reads the Rx descriptor 473 and checks if the OWN bit 475a is set to zero (“OWN==0”) (623). The bounded spinning involves the host processor continuously reading the OWN bit 475a of the current Rx descriptor 473 to see if it has been cleared. A spincount may define a duration of the continuous reading of the OWN bit 475a and/or a number of read operations performed on/for the OWN bit 475a. In some implementations, the host processor may potentially employ a spinlock to cause the batch processor to wait in a loop (e.g., a “spin”) while repeatedly checking whether the lock (e.g., the OWN bit 475a) is available. If the spincount of the bounded spinning mechanism is exceeded (623), then the host processor proceeds to determine whether the count is set to zero (122); otherwise, the host processor loops back to continue processing the current batch (116). The bounded spinning mechanism has a different iteration count (e.g., the spincount of 623) than the of batch processing loop (e.g., the batch count of 116), which may reduce the likelihood of a dead-lock from occurring.

When the Rx packet batch processing function identifies an Rx descriptor 473 with OWN bit 475a set to 0 (e.g., OWN=0) and NEXT bit 475b set to 1 (e.g., NEXT bit=1) (623), which was updated from previous Rx descriptor 473, the Rx packet batch processing function (e.g., network driver/API 480, network stack 481, and/or the like) knows about the existence of an in-transit Rx frame/packet. If the NEXT bit 475b=1 is true, the Rx packet batch processing function (e.g., network driver/API 480, network stack 481, and/or the like) enters a tightly controlled loop of reading Rx descriptor 473 repeatedly (e.g., busy polling) (622, 623) instead of bailing out directly (as is the case in the process depicted by FIG. 1). To ensure that the polling of Rx descriptor 473 is on the latest update (from Rx PE 404), the cache ((R)DMA) memory of the Rx descriptor 473 is invalidated before each read until the OWN bit 475a is zero (e.g., OWN=0) (623) or until the busy-polling loop has exhausted its retry limit (623). In these ways, such a technique ensures that the Rx packet/frame batch processing function does not exit too early (e.g., before the arrival of a slightly late Rx packet/frame). Additionally, this approach avoids the expensive penalty that a slightly late Rx packet/frame may cause due to, for example, high context switching costs (e.g., when Rx IRQ is re-enabled or the like) or task switching costs (e.g., other kernel task is scheduled to run before returning to the Rx packet/frame batch processing function).

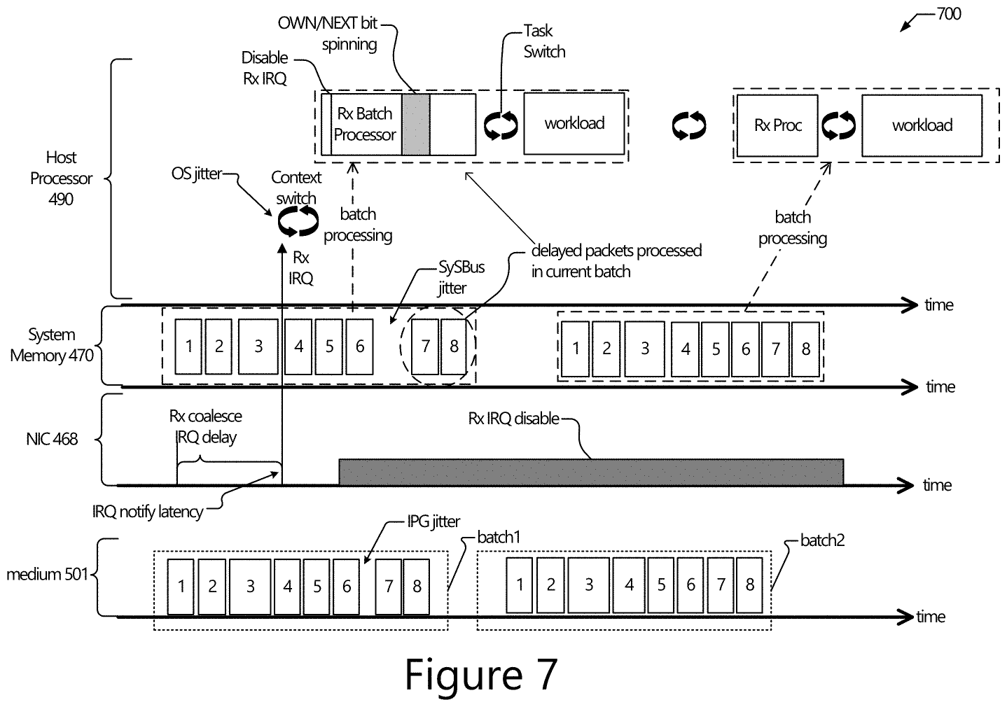

FIG. 7 shows an example timing diagram 700 demonstrating the combined effect of in-transit packet detection. Here, the data chunks/PDUs 7 and 8 in packet1 are delayed due to inter-packet jitter 1.1, DMA transfer jitter 1.2, and/or the like. In this example, the active next bit 475b (e.g., NEXT bit=1) causes the Rx batch processor to continue spinning until the own bit 475a is inactive (e.g., OWN bit=0). This may correspond to the bounded spinning mechanism discussed previously (e.g., 623 of FIG. 6). Because of the busy polling (spinning) on the own bit 475a, even though the packets 7 and 8 are slightly delayed, the data chunks/PDUs 7 and 8 to be able to be processed in the first Rx packet batch processing cycle rather than waiting for the next Rx packet processing cycle to be processed. This is because the spinning OWN bit delays or otherwise prevents the task switch from taking place until the OWN bit 475a is inactive (e.g., OWN bit=0). In these ways, the overall latency/delay of processing the packets is reduced allowing the system to be used for time-sensitive applications as well as providing resource consumption efficiencies for the system.

### 2. Time-Aware Networks and Time-Sensitive Application

The Precision Time Protocol (PTP) (see e.g., IEEE Standard for a Precision Clock Synchronization Protocol for Networked Measurement and Control Systems, IEEE Std 1588-2019 (16 Jun. 2020) (“[IEEE1588]”), the contents of which are hereby incorporated by reference in its entirety) provides precise synchronization of clocks in packet-based networked systems. Synchronization of clocks can be achieved in heterogeneous systems that include clocks of different inherent precision, resolution, and stability. PTP supports synchronization accuracy and precision in the sub-microsecond range with minimal network and local computing resources. Customization is supported by means of profiles. The protocol includes default profiles that permit simple systems to be installed and operated without the need for user management. Sub-nanosecond time transfer accuracy can be achieved in a properly designed network.

The IEEE time-sensitive networking (TSN) standards (e.g., IEEE Standard for Local and Metropolitan Area Networks Timing and Synchronization for Time-Sensitive Applications, IEEE Std 802.1AS™-2020 (19 Jun. 2020) (“[IEEE802.1AS]”), the contents of which is hereby incorporated by reference in its entirety) IEEE time-sensitive networking (TSN) standards specifies protocols, procedures, and managed objects used to ensure that the synchronization requirements are met for time-sensitive applications (TSAs), such as audio, video, and time-sensitive control, across networks (see e.g., IEEE Standard for Local and Metropolitan Area Networks: Overview and Architecture, IEEE Std 802-2014, pp. 1-74 (30 Jun. 2014) (“[IEEE802] ”) and similar media). This includes the maintenance of synchronized time during normal operation and following addition, removal, or failure of network components and network reconfiguration. It specifies the use of [IEEE1588] where applicable in the context of IEEE Standard for Local and Metropolitan Area Network—Bridges and Bridged Networks, IEEE Std 802.1Q-2018, pp. 1-1993 (6 Jul. 2018) (“[IEEE802.1Q]”), the contents of which are hereby incorporated by reference in its entirety. Synchronization to an externally provided timing signal (e.g., a recognized timing standard such as Coordinated Universal Time (UTC) or International Atomic Time (TAI) timescales). [IEEE802.1AS] enables systems to meet respective jitter, wander, and time-synchronization requirements for TSAs, including those that involve multiple streams delivered to multiple end stations. To facilitate the widespread use of packet networks for these applications, synchronization information is one of the components needed at each network element where TSA data are mapped or de-mapped or a time-sensitive function is performed. Some features provided by TSN are oriented to resource management, reliability, access control, and time synchronization (sync). In particular, TSN access control includes utilizing a traffic shaper (or credit-based shaper) that guarantees the worst-case latency for critical data. TSN time sync uses PTP/gPTP to provide accurate time synchronization across the network.

FIG. 8 illustrates an example time-aware network (TAN) 800, which includes a single gPTP domain. The TAN 800 includes a number of interconnected time-aware systems (TASs) that support one or more timing standards such as generalized PTP (gPTP), International Atomic Time (TAI), coordinated universal time (UTC), and/or the like. These TASs can be any networking device, including, for example, bridges, routers, and end stations. A set of TASs that are interconnected by gPTP capable network elements is referred to as a gPTP network.

Each instance of gPTP that a TAS supports is in at least one gPTP domain, and the instances of gPTP are said to be part of that gPTP domain. A gPTP domain (also referred to as a “TSN domain” or simply “domain”) includes one or more PTP instances and links that meet the requirements of this standard and communicate with each other as defined by the [IEEE802.1AS]. A gPTP domain defines the scope of gPTP message communication, state, operations, data sets, and timescale. Other aspects of gPTP domains are discussed in clause 8 of [IEEE802.1AS]. A TAS can support, and be part of, more than one gPTP domain. The entity of a single TAS that executes gPTP in one gPTP domain is referred to as a PTP instance. A TAS can contain multiple PTP instances, which are each associated with a different gPTP domain. A TSN domain is defined as a quantity of commonly managed industrial automation devices. Here, a TSN domain comprises a set of devices, their ports, and the attached individual LANs that transmit time-sensitive streams using TSN standards, which include, for example, transmission selection algorithms, preemption, time synchronization and enhancements for scheduled traffic and that share a common management mechanism. The grouping of devices into a TSN domain may be based on administrative decision, implementation, and/or use cases involved.

There are two types of PTP instances including PTP end instances (or simply “end instances” or “end nodes”) and PTP relay instances (or simply “relay instances” or “relay nodes”). An end instance, if not a PTP grandmaster (GM) instance (or simply “GM instance”), is a recipient of time information. A relay instance, if not a GM instance, receives time information from the GM instance, applies corrections to compensate for delays in the local area network (LAN) and the relay instance itself, and retransmits the corrected information. The relay instances can receive the time information directly from a GM instance, or indirectly through one or more other relay instances. Delay can be measured using standard-based procedures and/or mechanisms such as, for example, Ethernet using full-duplex point-to-point links, Ethernet Passive Optical Network (EPON) links (see e.g., [IEEE802.3]), the contents of which are hereby incorporated by reference in its entirety), [IEEE80211] wireless, generic coordinated shared networks (CSNs), for example, MoCA, G.hn, delay measurement mechanisms (see e.g., [IEEE1588] and/or [IEEE802.1AS], IEEE Standard for Local and metropolitan area networks Audio Video Bridging (AVB) Systems, IEEE Std 802.1BA-2011 (30 Sep. 2011), the contents of which are hereby incorporated by reference in its entirety), and the White Rabbit (WR) link delay model (see e.g., Lipinski et al., “White Rabbit: a PTP Application for Robust Sub-nanosecond Synchronization”, IEEE International Symposium on Precision Clock Synchronization for Measurement, Control and Communication (ISPCS), pgs. 25-30 (12 Sep. 2011), the contents of which are hereby incorporated by reference in its entirety), and/or using any other suitable mechanism, such as those discussed herein.

In some examples, the TAN 800 may be part of, or used in various use cases such as any of the example use cases discussed herein and/or those discussed in Belliardi et al., “Use Cases IEC/IEEE 60802” version (V) 1.3 (13 Sep. 2018), the contents of which is hereby incorporated by reference in its entirety. The TAN 800 uses some or all of the aforementioned above network technologies, where end stations on several local networks are connected to a GM instance on a backbone network via an EPON access network. In the TAN 800, the bridges and routers are examples of TASs that each contain a relay instance, and the end stations are time-aware systems that contain at least one PTP end instance.

Any PTP instance with clock sourcing capabilities can be a potential GM instance, and a selection method (e.g., the best master clock algorithm (BMCA)) ensures that all of the PTP instances in a gPTP domain use the same GM instance. Additionally or alternatively, a steady state GM selection strategy may be used where GM-capable stations advertise their GM-capabilities via announce messages. When a subject GM-capable station obtains an announce message from another GM-capable station with a “better” clock entity, the subject GM-capable station does not send it's an announce message. There may be a settable priority field in the announce message that can override clock quality, and GM-capable station determine the “better” clock entity using a bitwise compare or some other suitable mechanism. Additionally, a suitable tie breaking method can be used where two GM-capable stations have the same priority (e.g., a MAC address-based tie breaker algorithm and/or the like). Bridges (and/or routers) drop all inferior announce messages, and forward only the best (e.g., highest priority) announce messages to other PTP instances. A remaining GM-capable station (i.e., a GM-capable station whose announce message is not dropped) is considered to be the GM instance for the TAN 800. The GM instance is the root of the [IEEE802.1AS] timing tree, and sends a current time (e.g., in time sync messages) for synchronizing the various nodes/instances in the TAN 800. The GM instance may send the current time on a periodic basis and/or in response to some detected event (or trigger condition). Bridges (and/or routers) in the timing tree propagate timing messages toward the leaves of the timing tree (e.g., other PTP instances/nodes in the TAN 800) taking queuing delay into account (referred to as “residence time”). Additional aspects of GM selection, synchronization, and/or other like timing aspects are discussed in [IEEE802.1AS], [IEEE1588], and Stanton, Tutorial: The Time-Synchronization Standard from the AVB/TSN suite IEEE Std 802.11AS™-2011 (and following), IEEE PLENARY, San Diego Calif., July 2014 (July 2014), the contents of which is hereby incorporated by reference in its entirety.

In some implementations, there can be short periods during network reconfiguration when more than one GM instance might be active while the BMCA process is taking place. BMCA may be the same or similar to that used in [IEEE1588], but can be somewhat simplified in some implementations. In FIG. 8, the BMCA process has resulted in the GM instance being on the network backbone. If, however, the access network fails, the systems on a local network automatically switch over to one of the potential GM instances on the local network that is as least as “good” as any other. For example, when an access network link fails, and a potential GM instance that has a GNSS reference source has become the active GM instance, then two gPTP domains may exist where there used to be one.

When the TAN 800 includes multiple gPTP domains that could be used, some of the gPTP domains may use the PTP timescale and one or more other domains may use another timescale such as the arbitrary (ARB) timescale. Additionally or alternatively, some or all PTP instances belonging to the same domain may have direct connections among them in their physical topology (e.g., time cannot be transported from one PTP instance in a first domain to another PTP instance that same domain via a TAS that does not have that domain active). As in the single-domain case, any of the network technologies discussed herein can be used. The GM instance of each domain is selected by BMCA where a separate, independent BMCA instance is invoked in each domain.

The timescale for a gPTP domain is established by the GM clock. There are two types of timescales supported by gPTP including a timescale PTP and a timescale arbitrary (ARB). For timescale PTP, the epoch is the PTP epoch (see e.g., 8.2.2 in [IEEE802.1AS]), and the timescale is continuous. The unit of measure of time is the second defined by International Atomic Time (TAI). For timescale ARB, the epoch is the domain startup time and can be set by an administrative procedure. Between invocations of the administrative procedure, the timescale is continuous. Additional invocations of the administrative procedure can introduce discontinuities in the overall timescale. The unit of measure of time is determined by the GM Clock. The second used in the operation of the protocol can differ from the SI second. The “epoch” at least in some examples refers to the origin of the timescale of a gPTP domain. The PTP epoch (epoch of the timescale PTP) is 1 Jan. 1970 00:00:00 TAI. See Annex C of [IEEE802.1AS]) for information on converting between common timescales.

The communications in the TAN 800 occur via PTP messages and/or media-specific messages. The PTP messages may be any suitable datagram or protocol data unit (PDU). These messages may have the following attributes: message class and message type. The message type attribute indicates a type or name of a particular message such as “sync”, “announce”, “time measurement frame”, and/or the like (see e.g., section 3.18 of [IEEE802.1AS]).

There are two message classes, the event message class and the general message class. General messages are not timestamped whereas event messages are timestamped on egress from a PTP instance and ingress to a PTP instance. The timestamp is the time, relative to the LocalClock entity (see e.g., LocalClock entity 915 of FIG. 9 and section 10.1 in [IEEE802.1AS]) at which the message timestamp point passes the reference plane marking the boundary between the PTP instance and the network media. The definition of the timestamp measurement plane (see e.g., section 3.33 of [IEEE802.1AS]), along with the corrections defined as follows, allows transmission delays to be measured in such a way (at such a low layer) that they appear fixed and symmetrical to gPTP even though the MAC client might otherwise observe substantial asymmetry and transmission variation. For example, the timestamp measurement plane is located below any retransmission and queuing performed by the MAC.

Additionally, the PTP instances in a gPTP domain interface with the network media via physical ports. gPTP defines a logical port (e.g., a PTP port) in such a way that communication between PTP instances is point-to-point even over physical ports that are attached to shared media. One logical port, consisting of one PortSync entity and one media-dependent (MD) entity, is instantiated for each PTP instance with which the PTP instance communicates. For shared media, multiple logical ports can be associated with a single physical port. Additional aspects of the PTP ports are discussed in section 8.5 of [IEEE802.1AS].

Although the TAN 800 is described as being implemented according to gPTP, the embodiments discussed herein are also applicable to PTP implementations. In gPTP there are only two types of PTP instances: PTP end instances and relay instances, while [IEEE1588] has ordinary clocks, boundary clocks, end-to-end transparent clocks, and P2P transparent clocks. A PTP end instance corresponds to an Ordinary Clock in [IEEE1588], and a relay instance is a type of [IEEE1588] Boundary Clock where its operation is very tightly defined, so much so that a relay instance with Ethernet ports can be shown to be mathematically equivalent to a P2P Transparent Clock in terms of how synchronization is performed (see e.g., [IEEE802.1AS] § 11.1.3). In addition, a relay instance can operate in a mode (e.g., the mode where the variable syncLocked is TRUE; see e.g., [IEEE802.1AS] § 10.2.5.15) where the relay instance is equivalent to a P2P Transparent Clock in terms of when time-synchronization messages are sent. A TAS measures link delay and residence time and communicates these in a correction field. In summary, a relay instance conforms to the specifications for a Boundary Clock in [IEEE1588]-based systems, but a relay instance does not conform to the complete specifications for a P2P Transparent Clock in [IEEE1588] because when syncLocked is FALSE, the relay instance sends Sync according to the specifications for a Boundary Clock, and the relay instance invokes the BMCA and has PTP port states. Furthermore, gPTP communications between PTP instances is done using IEEE 802 MAC PDUs and addressing, while [IEEE1588] supports various layer 2 and layer 3-4 communication methods.

FIG. 9 depicts an example PTP instance model 900. The PTP instance model 900 includes a time-aware higher-layer application 905, a media independent layer 901 and one or more media dependent entities 922 within a media dependent layer 902. The time-aware higher-layer application (app) 905 is a TSA and/or any application that utilizes the time-aware aspects of a TAN 800 and/or the like. Examples of such apps 905 include audio, video, time-sensitive control apps, network apps, network functions, and/or other like apps.

If the PTP instance includes app(s) 905 that either use or source time information, then they interface with the gPTP information using the application interfaces specified in clause 9 of [IEEE802.1AS]. These interfaces include a ClockSourceTime interface, which provides external timing to the PTP instance, a ClockTargetEventCapture interface, which returns the synchronized time of an event signaled by a ClockTarget entity, a ClockTargetTriggerGenerate interface, which causes an event to be signaled at a synchronized time specified by a ClockTarget entity, a ClockTargetClockGenerator interface, which causes a periodic sequence of results to be generated, with a phase and rate specified by a ClockTarget entity, and a ClockTargetPhaseDiscontinuity interface, which supplies information that an application can use to determine if a discontinuity in GM Clock phase or frequency has occurred.

The single media-independent part 901 includes a main clock (ClockM) 911 (sometimes referred to as a “ClockMaster”), a secondary clock (Clocks) 911 (sometimes referred to as a “ClockSlave”), and SiteSync logical entities 913, one or more PortSync entities 914, and a LocalClock entity 915. The BMCA and forwarding of time information between logical ports and the and ClockM 911 is done by the SiteSync entity 913, while the computation of PTP port-specific delays needed for time-synchronization correction is done by the PortSync entities 914.

The PTP Instance has a LocalClock entity (e.g., ClockM and/or Clocks), which can be a free-running clock circuitry (e.g., a quartz crystal) that meets the requirements of [IEEE802.3], but could also be better than those requirements. There can be a ClockSource entity (e.g., timing taken from positioning circuitry 1275 of FIG. 12), available in the local system that provides timing to the ClockSource entity. The time provided by the PTP instance, if it is the GM PTP instance, is reflected by the combination of these two entities, and the clockClass reflects this combination as specified [IEEE1588] § 7.6.2.5. The clockClass attribute denotes the traceability of the synchronized time distributed by a ClockMaster when it is the GM PTP instance. For example, when the LocalClock entity uses a quartz oscillator that meets the requirements of [IEEE802.3] and [IEEE802.1AS] § B.1, clockClass is set to 248. But, if a GNSS receiver is present and synchronizes the PTP Instance, then the clockClass is set to the value 6, indicating traceability to a primary reference time source (see e.g., [IEEE1588] § 7.6.2.5).

The media dependent layer 902 includes a protocol stack including media-dependent (MD) ports 920 disposed on a logical link control (LLC) layer, which is separated from the one or more media dependent entities 922 by a MAC Service (MS). The media dependent entities 922 is connected to a media access control (MAC) layer by an Internal Sublayer Service (ISS), and the MAC layer is disposed on a physical (PNY) layer. MD ports 920, which translate the abstract “MDSyncSend” and “MDSyncReceive” structures/signals received from or sent to the media-independent layer and corresponding methods used for the particular LAN attached to the port.

For full-duplex Ethernet ports, [IEEE1588] Sync and Follow_Up (or just Sync if the optional one-step processing is enabled) messages are used, with an additional TLV in the Follow_Up (or the Sync if the optional one-step processing is enabled) used for communication of the RR and information on phase and frequency change when there is a change in GM instance. The path delay (pDelay) is measured using the two-step [IEEE1588] P2P delay mechanism. This is defined in clause 11 of [IEEE802.1AS].

For [IEEE80211] ports, timing information is communicated using the MAC Layer Management Entity to request a “Timing Measurement” or “Fine Timing Measurement” (as defined in [IEEE80211]), which also sends everything that would be included in the Follow_up message for full-duplex Ethernet. The Timing Measurement or Fine Timing Measurement result includes all the information to determine the path delay. This is defined in clause 12 of [IEEE802.1AS]. For EPON, timing information is communicated using a “slow protocol” as defined in clause 13 of [IEEE802.1AS]. CSNs use the same communication system used by full-duplex Ethernet, as defined in clause 16 of [IEEE802.1AS].

### 3. Computing System Configurations and Arrangements

Edge computing refers to the implementation, coordination, and use of computing and resources at locations closer to the “edge” or collection of “edges” of a network. Deploying computing resources at the network's edge may reduce application and network latency, reduce network backhaul traffic and associated energy consumption, improve service capabilities, improve compliance with security or data privacy requirements (especially as compared to conventional cloud computing), and improve total cost of ownership.

Individual compute platforms or other components that can perform edge computing operations (referred to as “edge compute nodes,” “edge nodes,” or the like) can reside in whatever location needed by the system architecture or ad hoc service. In many edge computing architectures, edge nodes are deployed at NANs, gateways, network routers, and/or other devices that are closer to endpoint devices (e.g., UEs, IoT devices, and/or the like) producing and consuming data. As examples, edge nodes may be implemented in a high performance compute data center or cloud installation; a designated edge node server, an enterprise server, a roadside server, a telecom central office; or a local or peer at-the-edge device being served consuming edge services.

Edge compute nodes may partition resources (e.g., memory, CPU, GPU, interrupt controller, I/O controller, memory controller, bus controller, network connections or sessions, and/or the like) where respective partitionings may contain security and/or integrity protection capabilities. Edge nodes may also provide orchestration of multiple applications through isolated user-space instances such as containers, partitions, virtual environments (VEs), virtual machines (VMs), Function-as-a-Service (FaaS) engines, Servlets, servers, and/or other like computation abstractions. Containers are contained, deployable units of SW that provide code and needed dependencies. Various edge system arrangements/architecture treats VMs, containers, and functions equally in terms of application composition. The edge nodes are coordinated based on edge provisioning functions, while the operation of the various applications are coordinated with orchestration functions (e.g., VM or container engine, and/or the like). The orchestration functions may be used to deploy the isolated user-space instances, identifying and scheduling use of specific HW, security related functions (e.g., key management, trust anchor management, and/or the like), and other tasks related to the provisioning and lifecycle of isolated user spaces.

Applications that have been adapted for edge computing include but are not limited to virtualization of traditional network functions including include, for example, SW-Defined Networking (SDN), Network Function Virtualization (NFV), distributed RAN units and/or RAN clouds, and the like. Additional example use cases for edge computing include computational offloading, Content Data Network (CDN) services (e.g., video on demand, content streaming, security surveillance, alarm system monitoring, building access, data/content caching, and/or the like), gaming services (e.g., AR/VR, and/or the like), accelerated browsing, IoT and industry applications (e.g., factory automation), media analytics, live streaming/transcoding, and V2X applications (e.g., driving assistance and/or autonomous driving applications).

The present disclosure provides various examples relevant to various edge computing technologies (ECTs) and edge network configurations provided within and various access/network implementations. Any suitable standards and network implementations are applicable to the edge computing concepts discussed herein. For example, many ECTs and networking technologies may be applicable to the present disclosure in various combinations and layouts of devices located at the edge of a network. Examples of such ECTs include [MEC]; [O-RAN]; [ISEO]; [SA6Edge]; [MAMS]; Content Delivery Networks (CDNs) (also referred to as “Content Distribution Networks” or the like); Mobility Service Provider (MSP) edge computing and/or Mobility as a Service (MAs) provider systems (e.g., used in AECC architectures); Nebula edge-cloud systems; Fog computing systems; Cloudlet edge-cloud systems; Mobile Cloud Computing (MCC) systems; Central Office Re-architected as a Datacenter (CORD), mobile CORD (M-CORD) and/or to Converged Multi-Access and Core (COMAC) systems; and/or the like. Further, the techniques disclosed herein may relate to other IoT edge network systems and configurations, and other intermediate processing entities and architectures may also be used for purposes of the present disclosure. The edge computing systems and arrangements discussed herein may be applicable in various solutions, services, and/or use cases involving mobility. Examples of such scenarios are shown and described w.r.t FIGS. 10-12.

FIG. 10 illustrates an example edge computing environment 1000 including different layers of communication, starting from an endpoint layer 1010a (also referred to as “sensor layer 1010a”, “things layer 1010a”, or the like) including one or more IoT devices 1011 (also referred to as “endpoints 1010a” or the like) (e.g., in an Internet of Things (IoT) network, wireless sensor network (WSN), fog, and/or mesh network topology); increasing in sophistication to intermediate layer 1010b (also referred to as “client layer 1010b”, “gateway layer 1010b”, or the like) including various user equipment (UEs) 1012a, 1012b, and 1012c (also referred to as “intermediate nodes 1010b” or the like), which may facilitate the collection and processing of data from endpoints 1010a; increasing in processing and connectivity sophistication to access layer 1030 including a set of network access nodes (NANs) 1031, 1032, and 1033 (collectively referred to as “NANs 1030” or the like); increasing in processing and connectivity sophistication to edge layer 1037 including a set of edge compute nodes 1036a-c (collectively referred to as “edge compute nodes 1036” or the like) within an edge computing framework 1035 (also referred to as “ECT 1035” or the like); and increasing in connectivity and processing sophistication to a backend layer 1040 including core network (CN) 1042, cloud 1044, and server(s) 1050. The processing at the backend layer 1040 may be enhanced by network services as performed by one or more remote servers 1050, which may be, or include, one or more CN functions, cloud compute nodes or clusters, application (app) servers, and/or other like systems and/or devices. Some or all of these elements may be equipped with or otherwise implement some or all features and/or functionality discussed herein.

The environment 1000 is shown to include end-user devices such as intermediate nodes 1010b and endpoint nodes 1010a, which are configured to connect to (or communicatively couple with) one or more communication networks (also referred to as “access networks,” “radio access networks,” or the like) based on different access technologies (or “radio access technologies”) for accessing application, edge, and/or cloud services. For the following discussion, the terms “node 1010”, “UE 1010”, and/or the like refer to any of the endpoint nodes 1010a, any of the intermediate nodes 1010b, and/or both endpoint nodes 1010a and intermediate nodes 1010b unless the context dictates otherwise. These access networks may include one or more NANs 1030, which are to arranged to provide network connectivity to the UEs 1010 via respective links 1003a and/or 1003b (collectively referred to as “channels 1003”, “links 1003”, “connections 1003”, and/or the like) between individual NANs 1030 and respective UEs 1010.

As examples, the communication networks and/or access technologies may include cellular technology such as LTE, MuLTEfire, and/or NR/5G (e.g., as provided by Radio Access Network (RAN) node 1031 and/or RAN nodes 1032), WiFi or wireless local area network (WLAN) technologies (e.g., as provided by access point (AP) 1033 and/or RAN nodes 1032), and/or the like. Different technologies exhibit benefits and limitations in different scenarios, and application performance in different scenarios becomes dependent on the choice of the access networks (e.g., WiFi, LTE, and/or the like) and the used network and transport protocols (e.g., Transfer Control Protocol (TCP), Virtual Private Network (VPN), Multi-Path TCP (MPTCP), Generic Routing Encapsulation (GRE), and/or the like).

The intermediate nodes 1010b include UE 1012a, UE 1012b, and UE 1012c (collectively referred to as “UE 1012” or “UEs 1012”). In this example, the UE 1012a is illustrated as a vehicle system (also referred to as a vehicle UE or vehicle station), UE 1012b is illustrated as a smartphone (e.g., handheld touchscreen mobile computing device connectable to one or more cellular networks), and UE 1012c is illustrated as a flying drone or unmanned aerial vehicle (UAV). However, the UEs 1012 may be any mobile or non-mobile computing device, such as desktop computers, workstations, laptop computers, tablets, wearable devices, PDAs, pagers, wireless handsets smart appliances, single-board computers (SBCs) (e.g., Raspberry Pi, Arduino, Intel Edison, and/or the like), plug computers, and/or any type of computing device such as any of those discussed herein.

The endpoints 1010 include UEs 1011, which may be IoT devices (also referred to as “IoT devices 1011”), which are uniquely identifiable embedded computing devices (e.g., within the Internet infrastructure) that comprise a network access layer designed for low-power IoT applications utilizing short-lived UE connections. The IoT devices 1011 are any physical or virtualized, devices, sensors, or “things” that are embedded with HW and/or SW components that enable the objects, devices, sensors, or “things” capable of capturing and/or recording data associated with an event, and capable of communicating such data with one or more other devices over a network with little or no user intervention. As examples, IoT devices 1011 may be abiotic devices such as autonomous sensors, gauges, meters, image capture devices, microphones, light emitting devices, audio emitting devices, audio and/or video playback devices, electro-mechanical devices (e.g., switch, actuator, and/or the like), EEMS, ECUs, ECMs, embedded systems, microcontrollers, control modules, networked or “smart” appliances, MTC devices, M2M devices, and/or the like. The IoT devices 1011 can utilize technologies such as M2M or MTC for exchanging data with one or more MTC servers (e.g., app servers 1050, cloud servers in cloud 1044, NFs in CN 1042 and/or the like), edge server(s) 1036 and/or ECT 1035, or device via a PLMN, ProSe or D2D communication, sensor networks, or IoT networks. The M2M or MTC exchange of data may be a machine-initiated exchange of data.

The IoT devices 1011 may execute background applications (e.g., keep-alive messages, status updates, and/or the like) to facilitate the connections of the IoT network. Where the IoT devices 1011 are, or are embedded in, sensor devices, the IoT network may be a WSN. An IoT network describes an interconnecting IoT UEs, such as the IoT devices 1011 being connected to one another over respective direct links 1005. The IoT devices may include any number of different types of devices, grouped in various combinations (referred to as an “IoT group”) that may include IoT devices that provide one or more services for a particular user, customer, organizations, and/or the like. A service provider (e.g., an owner/operator of server(s) 1050, CN 1042, and/or cloud 1044) may deploy the IoT devices in the IoT group to a particular area (e.g., a geolocation, building, and/or the like) in order to provide the one or more services. In some implementations, the IoT network may be a mesh network of IoT devices 1011, which may be termed a fog device, fog system, or fog, operating at the edge of the cloud 1044.

As mentioned previously, the access networks provide network connectivity to the end-user devices 1020, 1010 via respective NANs 1030. The access networks may be Radio Access Networks (RANs) such as an NG RAN or a 5G RAN for a RAN that operates in a 5G/NR cellular network, an E-UTRAN for a RAN that operates in an LTE or 4G cellular network, or a legacy RAN such as a UTRAN or GERAN for GSM or CDMA cellular networks. The access network or RAN may be referred to as an Access Service Network for Worldwide Interoperability for Microwave Access (WiMAX) implementations (see e.g., IEEE Standard for Air Interface for Broadband Wireless Access Systems, IEEE Std 802.16-2017, pp. 1-2726 (2 Mar. 2018) (“[WiMAX]”)). Additionally or alternatively, all or parts of the RAN may be implemented as one or more SW entities running on server computers as part of a virtual network, which may be referred to as a cloud RAN (CRAN), Cognitive Radio (CR), a virtual baseband unit pool (vBBUP), and/or the like. Additionally or alternatively, the CRAN, CR, or vBBUP may implement a RAN function split, wherein one or more communication protocol layers are operated by the CRAN/CR/vBBUP and other communication protocol entities are operated by individual RAN nodes 1031, 1032. This virtualized framework allows the freed-up processor cores of the NANs 1031, 1032 to perform other virtualized applications, such as virtualized applications for various elements discussed herein. The Radio Access Technologies (RATs) employed by the NANs 1030, the UEs 1010, and the other elements in FIG. 10 may include, for example, any of the communication protocols and/or RATs discussed herein.

The UEs 1010 may utilize respective connections (or channels) 1003a, each of which comprises a physical communications interface or layer. The connections 1003a are illustrated as an air interface to enable communicative coupling consistent with cellular communications protocols, such as 3GPP LTE, 5G/NR, Push-to-Talk (PTT) and/or PTT over cellular (POC), UMTS, GSM, CDMA, and/or any of the other communications protocols discussed herein. Additionally or alternatively, the UEs 1010 and the NANs 1030 communicate data (e.g., transmit and receive) data over a licensed medium (also referred to as the “licensed spectrum” and/or the “licensed band”) and an unlicensed shared medium (also referred to as the “unlicensed spectrum” and/or the “unlicensed band”). To operate in the unlicensed spectrum, the UEs 1010 and NANs 1030 may operate using LAA, enhanced LAA (eLAA), and/or further eLAA (feLAA) mechanisms. The UEs 1010 may further directly exchange communication data via respective direct links 1005, which may be LTE/NR Proximity Services (ProSe) link or PC5 interfaces/links, or WiFi based links or a personal area network (PAN) based links (e.g., [IEEE802154] based protocols including ZigBee, IPv6 over Low power Wireless Personal Area Networks (6LoWPAN), WirelessHART, MiWi, Thread, and/or the like; WiFi-direct; Bluetooth/Bluetooth Low Energy (BLE) protocols).

Additionally or alternatively, individual UEs 1010 provide radio information to one or more NANs 1030 and/or one or more edge compute nodes 1036 (e.g., edge servers/hosts, and/or the like). The radio information may be in the form of one or more measurement reports, and/or may include, for example, signal strength measurements, signal quality measurements, and/or the like. Each measurement report is tagged with a timestamp and the location of the measurement (e.g., the UEs 1010 current location). As examples, the measurements collected by the UEs 1010 and/or included in the measurement reports may include one or more measurements discussed in 3GPP TS 36.214 v16.2.0 (2021 Mar. 31) (“[TS36214]”), 3GPP TS 38.215 v16.4.0 (2021 Jan. 8) (“[TS38215]”), 3GPP TS 38.314 v16.4.0 (2021 Sep. 30) (“[TS38314]”), IEEE Standard for Information Technology—Telecommunications and Information Exchange between Systems—Local and Metropolitan Area Networks—Specific Requirements—Part 11: Wireless LAN Medium Access Control (MAC) and Physical Layer (PHY) Specifications, IEEE Std 802.11-2020, pp. 1-4379 (26 Feb. 2021) (“[IEEE80211]”), and/or the like. In any of the examples discussed herein, any suitable data collection and/or measurement mechanism(s) may be used to collect the observation data. For example, data marking (e.g., sequence numbering, and/or the like), packet tracing, signal measurement, data sampling, and/or timestamping techniques may be used to determine any of the aforementioned metrics/observations. The collection of data may be based on occurrence of events that trigger collection of the data. Additionally or alternatively, data collection may take place at the initiation or termination of an event. The data collection can be continuous, discontinuous, and/or have start and stop times. The data collection techniques/mechanisms may be specific to a HW configuration/implementation or non-HW-specific, or may be based on various SW parameters (e.g., OS type and version, and/or the like). Various configurations may be used to define any of the aforementioned data collection parameters. Such configurations may be defined by suitable specifications/standards, such as 3GPP (e.g., [SA6Edge]), ETSI (e.g., [MEC]), O-RAN (e.g., [O-RAN]), Intel® Smart Edge Open (formerly OpenNESS) (e.g., [ISEO]), IETF (e.g., [MAMS]), IEEE/WiFi (e.g., [IEEE80211], [WiMAX], IEEE Guide for Wireless Access in Vehicular Environments (WAVE) Architecture, IEEE Std 1609.0-2019 (10 Apr. 2019) (“[IEEE16090]”), and/or the like), and/or any other like standards such as those discussed herein.

The UE 1012b is shown as being capable of accessing access point (AP) 1033 via a connection 1003b. In this example, the AP 1033 is shown to be connected to the Internet without connecting to the CN 1042 of the wireless system. The connection 1003b can comprise a local wireless connection, such as a connection consistent with any [IEEE802] protocol (e.g., [IEEE80211] and variants thereof), wherein the AP 1033 comprise a WiFi station (e.g., router, bridge, and/or the like). Additionally or alternatively, the UEs 1010 can be configured to communicate using suitable communication signals with each other or with any of the AP 1033 over a single or multicarrier communication channel in accordance with various communication techniques, such as, but not limited to, an OFDM communication technique, a single-carrier frequency division multiple access (SC-FDMA) communication technique, and/or the like, although the scope of the present disclosure is not limited in this respect. The communication technique may include a suitable modulation scheme such as Complementary Code Keying (CCK); Phase-Shift Keying (PSK) such as Binary PSK (BPSK), Quadrature PSK (QPSK), Differential PSK (DPSK), and/or the like; or Quadrature Amplitude Modulation (QAM) such as M-QAM; and/or the like.

The one or more NANs 1031 and 1032 that enable the connections 1003a may be referred to as “RAN nodes” or the like. The RAN nodes 1031, 1032 may comprise ground stations (e.g., terrestrial access points) or satellite stations providing coverage within a geographic area (e.g., a cell). The RAN nodes 1031, 1032 may be implemented as one or more of a dedicated physical device such as a macrocell base station, and/or a low power base station for providing femtocells, picocells or other like cells having smaller coverage areas, smaller user capacity, or higher to bandwidth compared to macrocells. In this example, the RAN node 1031 is embodied as a NodeB, evolved NodeB (eNB), or a next generation NodeB (gNB), and the RAN nodes 1032 are embodied as relay nodes, distributed units, or Road Side Unites (RSUs). Any other type of NANs can be used.

The NANs 1031, 1032 may be configured to communicate with one another via respective interfaces or links (not shown), such as an X2 interface for LTE implementations (e.g., when CN 1042 is an Evolved Packet Core (EPC)), an Xn interface for 5G or NR implementations (e.g., when CN 1042 is an Fifth Generation Core (5GC)), or the like. The NANs 1031 and 1032 are also communicatively coupled to CN 1042. Additionally or alternatively, the CN 1042 may be an evolved packet core (EPC), a NextGen Packet Core (NPC), a 5G core (5GC), and/or some other type of CN. The CN 1042 is a network of network elements and/or network functions (NFs) relating to a part of a communications network that is independent of the connection technology used by a terminal or user device. The CN 1042 comprises a plurality of network elements/NFs configured to offer various data and telecommunications services to customers/subscribers (e.g., users of UEs 1012 and IoT devices 1011) who are connected to the CN 1042 via a RAN. The components of the CN 1042 may be implemented in one physical node or separate physical nodes including components to read and execute instructions from a machine-readable or computer-readable medium (e.g., a non-transitory machine-readable storage medium). Additionally or alternatively, Network Functions Virtualization (NFV) may be utilized to virtualize any or all of the above-described network node functions via executable instructions stored in one or more computer-readable storage mediums (described in further detail infra). A logical instantiation of the CN 1042 may be referred to as a network slice, and a logical instantiation of a portion of the CN 1042 may be referred to as a network sub-slice. NFV architectures and infrastructures may be used to virtualize one or more network functions, alternatively performed by proprietary HW, onto physical resources comprising a combination of industry-standard server HW, storage HW, or switches. In other words, NFV systems can be used to execute virtual or reconfigurable implementations of one or more CN 1042 components/functions.

The CN 1042 is shown to be communicatively coupled to an application server 1050 and a network 1050 via an IP communications interface 1055. the one or more server(s) 1050 comprise one or more physical and/or virtualized systems for providing functionality (or services) to one or more clients (e.g., UEs 1012 and IoT devices 1011) over a network. The server(s) 1050 may include various computer devices with rack computing architecture component(s), tower computing architecture component(s), blade computing architecture component(s), and/or the like. The server(s) 1050 may represent individual servers, a cluster of servers, a server farm, a cloud computing service, a data center, and/or other grouping or pool of servers. Generally, the server(s) 1050 offer applications or services that use IP/network resources. As examples, the server(s) 1050 may provide traffic management services, cloud analytics, content streaming services, immersive gaming experiences, social networking and/or microblogging services, communication services (e.g., Voice-over-Internet Protocol (VoIP) sessions, PTT sessions, group communication sessions, social networking services, and/or the like), initiating and controlling SW and/or firmware (FW) updates for applications or individual components implemented by the UEs 1010, and/or other like services.

The cloud 1044 may represent a cloud computing architecture/platform that provides one or more cloud computing services. Cloud computing refers to a paradigm for enabling network access to a scalable and elastic pool of shareable computing resources with self-service provisioning and administration on-demand and without active management by users. Computing resources (or simply “resources”) are any physical or virtual component, or usage of such components, of limited availability within a computer system or network. Examples of resources include usage/access to, for a period of time, servers, processor(s), storage equipment, memory devices, memory areas, networks, electrical power, input/output (peripheral) devices, mechanical devices, network connections (e.g., channels/links, ports, network sockets, and/or the like), operating systems, virtual machines (VMs), SW/applications, computer files, and/or the like. Cloud computing provides cloud computing services (or cloud services), which are one or more capabilities offered via cloud computing that are invoked using a defined interface (e.g., an API or the like). Some capabilities of cloud 1044 include application capabilities type, infrastructure capabilities type, and platform capabilities type. A cloud capabilities type is a classification of the functionality provided by a cloud service to a cloud service customer (e.g., a user of cloud 1044), based on the resources used. The application capabilities type is a cloud capabilities type in which the cloud service customer can use the cloud service provider's applications; the infrastructure capabilities type is a cloud capabilities type in which the cloud service customer can provision and use processing, storage or networking resources; and platform capabilities type is a cloud capabilities type in which the cloud service customer can deploy, manage and run customer-created or customer-acquired applications using one or more programming languages and one or more execution environments supported by the cloud service provider.

Additionally or alternatively, the cloud 1044 may represent one or more cloud servers, application servers, web servers, and/or some other remote infrastructure. The remote/cloud servers may include any one of a number of services and capabilities such as, for example, any of those discussed herein. Additionally or alternatively, the cloud 1044 may represent a network such as the Internet, a local area network (LAN), a wide area network (WAN), a wireless local area network (WLAN), or a wireless wide area network (WWAN) including proprietary and/or enterprise networks for a company or organization, or combinations thereof. The cloud 1044 may be a network that comprises computers, network connections among the computers, and SW routines to enable communication between the computers over network connections. In this regard, the cloud 1044 comprises one or more network elements that may include one or more processors, communications systems (e.g., including network interface controllers, one or more transmitters/receivers connected to one or more antennas, and/or the like), and computer readable media. Examples of such network elements may include wireless access points (WAPs), home/business servers (with or without RF communications circuitry), routers, switches, hubs, radio beacons, base stations, picocell or small cell base stations, backbone gateways, and/or any other like network device. Connection to the cloud 1044 may be via a wired or a wireless connection using the various communication protocols discussed infra. More than one network may be involved in a communication session between the illustrated devices. Connection to the cloud 1044 may require that the computers execute SW routines which enable, for example, the seven layers of the OSI model of computer networking or equivalent in a wireless (cellular) phone network. Cloud 1044 may be used to enable relatively long-range communication such as, for example, between the one or more server(s) 1050 and one or more UEs 1010. Additionally or alternatively, the cloud 1044 may represent the Internet, one or more cellular networks, local area networks, or wide area networks including proprietary and/or enterprise networks, TCP/Internet Protocol (IP)-based network, or combinations thereof. In these implementations, the cloud 1044 may be associated with network operator who owns or controls equipment and other elements necessary to provide network-related services, such as one or more base stations or access points, one or more servers for routing digital data or telephone calls (e.g., a core network or backbone network), and/or the like. The backbone links 1055 may include any number of wired or wireless technologies, and may be part of a LAN, a WAN, or the Internet. In one example, the backbone links 1055 are fiber backbone links that couple lower levels of service providers to the Internet, such as the CN 1012 and cloud 1044.

As shown by FIG. 10, each of the NANs 1031, 1032, and 1033 are co-located with edge compute nodes (or “edge servers”) 1036a, 1036b, and 1036c, respectively. In any of the examples discussed herein, the edge servers 1036 provide a distributed computing environment for application and service hosting, and also provide storage and processing resources so that data and/or content can be processed in close proximity to subscribers (e.g., users of UEs 1010) for faster response times The edge servers 1036 also support multitenancy run-time and hosting environment(s) for applications, including virtual appliance applications that may be delivered as packaged virtual machine (VM) images, middleware application and infrastructure services, content delivery services including content caching, mobile big data analytics, and computational offloading, among others. Computational offloading involves offloading computational tasks, workloads, applications, and/or services to the edge servers 1036 from the UEs 1010, CN 1042, cloud 1044, and/or server(s) 1050, or vice versa. For example, a device application or client application operating in a UE 1010 may offload application tasks or workloads to one or more edge servers 1036. In another example, an edge server 1036 may offload application tasks or workloads to one or more UE 1010 (e.g., for distributed ML computation or the like).

The edge compute nodes 1036 may include or be part of an edge system 1035 that employs one or more ECTs 1035. The edge compute nodes 1036 may also be referred to as “edge hosts 1036” or “edge servers 1036.” The edge system 1035 includes a collection of edge servers 1036 and edge management systems (not shown by FIG. 10) necessary to run edge computing applications within an operator network or a subset of an operator network. The edge servers 1036 are physical computer systems that may include an edge platform and/or virtualization infrastructure, and provide compute, storage, and network resources to edge computing applications. Each of the edge servers 1036 are disposed at an edge of a corresponding access network, and are arranged to provide computing resources and/or various services (e.g., computational task and/or workload offloading, cloud-computing capabilities, IT services, and other like resources and/or services as discussed herein) in relatively close proximity to UEs 1010. The VI of the edge servers 1036 provide virtualized environments and virtualized resources for the edge hosts, and the edge computing applications may run as VMs and/or application containers on top of the VI.

In one example implementation, the ECT 1035 is and/or operates according to the MEC framework, as discussed in ETSI GR MEC 001 v3.1.1 (2022 January), ETSI GS MEC 003 v3.1.1 (2022 March), ETSI GS MEC 009 v3.1.1 (2021 June), ETSI GS MEC 010-1 v1.1.1 (2017 October), ETSI GS MEC 010-2 v2.2.1 (2022 February), ETSI GS MEC 011 v2.2.1 (2020 December), ETSI GS MEC 012 V2.2.1 (2022 February), ETSI GS MEC 013 V2.2.1 (2022 January), ETSI GS MEC 014 v2.1.1 (2021 March), ETSI GS MEC 015 v2.1.1 (2020 June), ETSI GS MEC 016 v2.2.1 (2020 April), ETSI GS MEC 021 v2.2.1 (2022 February), ETSI GR MEC 024 v2.1.1 (2019 November), ETSI GS MEC 028 V2.2.1 (2021 July), ETSI GS MEC 029 v2.2.1 (2022 January), ETSI MEC GS 030 v2.1.1 (2020 April), ETSI GR MEC 031 v2.1.1 (2020 October), U.S. Provisional App. No. 63/003,834 filed Apr. 1, 2020 (“[US'834]”), and Int'l App. No. PCT/US2020/066969 filed on Dec. 23, 2020 (“[PCT'696]”) (collectively referred to herein as “[MEC]”), the contents of each of which are hereby incorporated by reference in their entireties. In another example implementation, the ECT 1035 is and/or operates according to the Open RAN alliance (“0-RAN”) framework, as described in O-RAN Architecture Description v07.00, O-RAN ALLIANCE WG1 (October 2022); O-RAN Working Group 2 AI/ML workflow description and requirements v01.03 O-RAN ALLIANCE WG2 (October 2021); O-RAN Working Group 2 Non RT RIC: Functional Architecture v01.01, O-RAN ALLIANCE WG2 (June 2021); O- RAN Working Group 3 Near-Real-time RAN Intelligent Controller Architecture & E2 General Aspects and Principles v02.02 (July 2022); O-RAN Working Group 3 Near-Real-time Intelligent Controller E2 Service Model (E2SM) v02.01 (March 2022); and/or any other 0-RAN standard/specification (collectively referred to as “[O-RAN]”); the contents of each of which are hereby incorporated by reference in their entireties. In another example implementation, the ECT 1035 operates according to the 3rd Generation Partnership Project (3GPP) System Aspects Working Group 6 (SA6) Architecture for enabling Edge Applications (referred to as “3GPP edge computing”) as discussed in 3GPP TS 23.558 v17.3.0 (2022-03-23) (“[T523558]”), 3GPP TS 23.501 v17.4.0 (2022-03-23) (“[T523501]”), and U.S. application Ser. No. 17/484,719 filed on 24 Sep. 2021 (“[US'719]”) (collectively referred to as “[SA6Edge]”), the contents of each of which is hereby incorporated by reference in their entireties. In another example implementation, the ECT 1035 is and/or operates according to the Intel® Smart Edge Open framework (formerly known as OpenNESS) as discussed in Intel® Smart Edge Open Developer Guide, version 21.09 (30 Sep. 2021), available at: https://smart-edge-open.githubio/(“[ISEO]”), the contents of which is hereby incorporated by reference in its entirety. In another example implementation, the ECT 1035 operates according to the Multi-Access Management Services (MAMS) framework as discussed in Kanugovi et al., Multi-Access Management Services (MAMS), INTERNET ENGINEERING TASK FORCE (IETF), Request for Comments (RFC) 8743 (March 2020), Ford et al., TCP Extensions for Multipath Operation with Multiple Addresses, IETF RFC 8684, (March 2020), De Coninck et al., Multipath Extensions for QUIC (MP-QUIC) IETF DRAFT-DECONINCK-QUIC-MULTIPATH-07, IETA, QUIC Working Group (3 May 2021), Zhu et al., User-Plane Protocols for Multiple Access Management Service, IETF DRAFT-ZHU-INTAREA-MAMS-USER-PROTOCOL-09, IETA, INTAREA (4 Mar. 2020), and Zhu et al., Generic Multi-Access (GMA) Convergence Encapsulation Protocols, IETF RFC 9188 (February 2022) (collectively referred to as “[MAMS]”), the contents of each of which are hereby incorporated by reference in their entireties.

Any of the aforementioned example implementations, and/or in any other example implementation discussed herein, may also include one or more virtualization technologies, such as those discussed in ETSI GR NFV 001 V1.3.1 (2021-03); ETSI GS NFV 002 V1.2.1 (2014-12); ETSI GR NFV 003 V1.6.1 (2021-03); ETSI GS NFV 006 V2.1.1 (2021-01); ETSI GS NFV-INF 001 V1.1.1 (2015-01); ETSI GS NFV-INF 003 V1.1.1 (2014-12); ETSI GS NFV-INF 004 V1.1.1 (2015-01); ETSI GS NFV-MAN 001 v1.1.1 (2014-12); Israel et al., OSM Release FIVE Technical Overview, ETSI OPEN SOURCE MANO, OSM White Paper, 1st ed. (January 2019); E2E Network Slicing Architecture, GSMA, Official Doc. NG.127, v1.0 (3 Jun. 2021); Open Network Automation Platform (ONAP) documentation, Release Istanbul, v9.0.1 (17 Feb. 2022); 3GPP Service Based Management Architecture (SBMA) as discussed in 3GPP TS 28.533 v17.1.0 (2021-12-23) (“[TS28533]”); the contents of each of which are hereby incorporated by reference in their entireties. It should be understood that the aforementioned edge computing frameworks/ECTs and services deployment examples are only illustrative examples of ECTs, and that the present disclosure may be applicable to many other or additional edge computing/networking technologies in various combinations and layouts of devices located at the edge of a network including the various edge computing networks/systems described herein. Further, the techniques disclosed herein may relate to other IoT edge network systems and configurations, and other intermediate processing entities and architectures may also be applicable to the present disclosure.

FIG. 11 illustrates an example SW distribution platform 1105 to distribute SW 1160, such as the example computer readable instructions 1260 of FIG. 12, to one or more devices, such as example processor platform(s) 1100 and/or example connected edge devices 1262 (see e.g., FIG. 12) and/or any of the other computing systems/devices discussed herein. The example SW distribution platform 1105 may be implemented by any computer server, data facility, cloud service, and/or the like, capable of storing and transmitting SW to other computing devices (e.g., third parties, the example connected edge devices 1262 of FIG. 12). Example connected edge devices may be customers, clients, managing devices (e.g., servers), third parties (e.g., customers of an entity owning and/or operating the SW distribution platform 1105). Example connected edge devices may operate in commercial and/or home automation environments. In some examples, a third party is a developer, a seller, and/or a licensor of SW such as the example computer readable instructions 1260 of FIG. 12. The third parties may be consumers, users, retailers, OEMs, and/or the like that purchase and/or license the SW for use and/or re-sale and/or sub-licensing. In some examples, distributed SW causes display of one or more user interfaces (Uls) and/or graphical user interfaces (GUIs) to identify the one or more devices (e.g., connected edge devices) geographically and/or logically separated from each other (e.g., physically separated IoT devices chartered with the responsibility of water distribution control (e.g., pumps), electricity distribution control (e.g., relays), and/or the like).

In the example of FIG. 11, the SW distribution platform 1105 includes one or more servers and one or more storage devices. The storage devices store the computer readable instructions 1160, which may correspond to the example computer readable instructions 1260 of FIG. 12, as described above. The one or more servers of the example SW distribution platform 1105 are in communication with a network 1110, which may correspond to any one or more of the Internet and/or any of the example networks as described herein. In some examples, the one or more servers are responsive to requests to transmit the SW to a requesting party as part of a commercial transaction. Payment for the delivery, sale and/or license of the SW may be handled by the one or more servers of the SW distribution platform and/or via a third-party payment entity. The servers enable purchasers and/or licensors to download the computer readable instructions 1160 from the SW distribution platform 1105. For example, the SW 1160, which may correspond to the example computer readable instructions 1260 of FIG. 12, may be downloaded to the example processor platform(s) 1100, which is/are to execute the computer readable instructions 1160 to implement the various implementations discussed herein. In some examples, one or more servers of the SW distribution platform 1105 are communicatively connected to one or more security domains and/or security devices through which requests and transmissions of the example computer readable instructions 1160 must pass. In some examples, one or more servers of the SW distribution platform 1105 periodically offer, transmit, and/or force updates to the SW (e.g., the example computer readable instructions 1260 of FIG. 12) to ensure improvements, patches, updates, and/or the like are distributed and applied to the SW at the end user devices.

The computer readable instructions 1160 are stored on storage devices of the SW distribution platform 1105 in a particular format. A format of computer readable instructions includes, but is not limited to a particular code language (e.g., Java, JavaScript, Python, C, C#, SQL, HTML, and/or the like), and/or a particular code state (e.g., uncompiled code (e.g., ASCII), interpreted code, linked code, executable code (e.g., a binary), and/or the like). In some examples, the computer readable instructions 1281, 1282, 1283 stored in the SW distribution platform 1105 are in a first format when transmitted to the example processor platform(s) 1100. In some examples, the first format is an executable binary in which particular types of the processor platform(s) 1100 can execute. However, in some examples, the first format is uncompiled code that requires one or more preparation tasks to transform the first format to a second format to enable execution on the example processor platform(s) 1100. For instance, the receiving processor platform(s) 1100 may need to compile the computer readable instructions 1160 in the first format to generate executable code in a second format that is capable of being executed on the processor platform(s) 1100. In still other examples, the first format is interpreted code that, upon reaching the processor platform(s) 1100, is interpreted by an interpreter to facilitate execution of instructions.

FIG. 12 illustrates an example of components that may be present in an compute node 1200 for implementing the techniques (e.g., operations, processes, methods, and methodologies) described herein. This compute node 1200 provides a closer view of the respective components of node 1200 when implemented as or as part of a computing device or system. The compute node 1200 can include any combination of the hardware or logical components referenced herein, and may include or couple with any device usable with a communication network or a combination of such networks. In particular, any combination of the components depicted by FIG. 12 can be implemented as individual ICs, discrete electronic devices, or other modules, instruction sets, programmable logic or algorithms, hardware, hardware accelerators, software, firmware, or a combination thereof adapted in the compute node 1200, or as components otherwise incorporated within a chassis of a larger system. Additionally or alternatively, any combination of the components depicted by FIG. 12 can be implemented as a system-on-chip (SoC), a single-board computer (SBC), a system-in-package (SiP), a multi-chip package (MCP), and/or the like, in which a combination of the hardware elements are formed into a single IC or a single package. Furthermore, the compute node 1200 may be or include, server, appliance, network infrastructure, machine, robot, drone, and/or any other type of computing devices such as any of those discussed herein. For example, compute node 1200 may be embodied as a client device and/or mobile compute device, a smart appliance, an in-vehicle compute system (e.g., a navigation system), an edge compute node, a NAN, switch, router, bridge, hub, a server, network infrastructure, machine, robot, drone, and/or any other type of computing device such as any of those discussed herein. Additionally or alternatively, the compute node 1200 may be embodied as any of the computing devices discussed herein, such as, for example, the compute node implementation 400, any of the TASs in TAN 800, PTP instance 900, the UEs 1010, NANs 1030, edge compute node(s) 1036, cloud compute nodes (e.g., in cloud 1044), NF(s) (e.g., in CN 1042), and/or app servers 1050 of FIG. 10; processor platform(s) 1100 and/or SW distribution platform 1105 of FIG. 11; IPU 1300 of FIG. 13; any of the servers 1410a, 1410b, 1411a, 1411b, 1412a, 1412b, 1420, 1421, 1422 of FIG. 14; and/or any other type of computing device such as any of those discussed herein.

The compute node 1200 includes one or more processors 1202 (also referred to as “processor circuitry 1202”). The processor circuitry 1202 includes circuitry capable of sequentially and/or automatically carrying out a sequence of arithmetic or logical operations, and recording, storing, and/or transferring digital data. Additionally or alternatively, the processor circuitry 1202 includes any device capable of executing or otherwise operating computer-executable instructions, such as program code, software modules, and/or functional processes. The processor circuitry 1202 includes various hardware elements or components such as, for example, a set of processor cores and one or more of on-chip or on-die memory or registers, cache and/or scratchpad memory, low drop-out voltage regulators (LDOs), interrupt controllers, serial interfaces such as SPI, I2C or universal programmable serial interface circuit, real time clock (RTC), timer-counters including interval and watchdog timers, general purpose I/O, memory card controllers such as secure digital/multi-media card (SD/MMC) or similar, interfaces, mobile industry processor interface (MIPI) interfaces and Joint Test Access Group (JTAG) test access ports. Some of these components, such as the on-chip or on-die memory or registers, cache and/or scratchpad memory, may be implemented using the same or similar devices as the memory circuitry 1210 discussed infra. The processor circuitry 1202 is also coupled with memory circuitry 1210 and storage circuitry 1220, and is configured to execute instructions stored in the memory/storage to enable various apps, OSs, or other software elements to run on the platform 1200. In particular, the processor circuitry 1202 is configured to operate app software (e.g., instructions 1201, 1211, 1221) to provide one or more services to a user of the compute node 1200 and/or user(s) of remote systems/devices.

As examples, the processor circuitry 1202 can be embodied as, or otherwise include one or multiple central processing units (CPUs), application processors, graphics processing units (GPUs), RISC processors, Acorn RISC Machine (ARM) processors, complex instruction set computer (CISC) processors, DSPs, FPGAs, programmable logic devices (PLDs), ASICs, baseband processors, radio-frequency integrated circuits (RFICs), microprocessors or controllers, multi-core processors, multithreaded processors, ultra-low voltage processors, embedded processors, a specialized x-processing units (xPUs) or a data processing unit (DPUs) (e.g., Infrastructure Processing Unit (IPU), network processing unit (NPU), and the like), and/or any other processing devices or elements, or any combination thereof. In some implementations, the processor circuitry 1202 is embodied as one or more special-purpose processor(s)/controller(s) configured (or configurable) to operate according to the various implementations and other aspects discussed herein. Additionally or alternatively, the processor circuitry 1202 includes one or more hardware accelerators (e.g., same or similar to acceleration circuitry 1250), which can include microprocessors, programmable processing devices (e.g., FPGAs, ASICs, PLDs, DSPs. and/or the like), and/or the like. In some examples, the processor circuitry 1202 corresponds to the host processor of the host platform 490 discussed previously.

The system memory 1210 (also referred to as “memory circuitry 1210”) includes one or more hardware elements/devices for storing data and/or instructions 1211 (and/or instructions 1201, 1221). Any number of memory devices may be used to provide for a given amount of system memory 1210. As examples, the memory 1210 can be embodied as processor cache or scratchpad memory, volatile memory, non-volatile memory (NVM), and/or any other machine readable media for storing data. Examples of volatile memory include random access memory (RAM), static RAM (SRAM), dynamic RAM (DRAM), synchronous DRAM (SDRAM), thyristor RAM (T-RAM), content-addressable memory (CAM), and/or the like. Examples of NVM can include read-only memory (ROM) (e.g., including programmable ROM (PROM), erasable PROM (EPROM), electrically EPROM (EEPROM), flash memory (e.g., NAND flash memory, NOR flash memory, and the like), solid-state storage (SSS) or solid-state ROM, programmable metallization cell (PMC), and/or the like), non-volatile RAM (NVRAM), phase change memory (PCM) or phase change RAM (PRAM) (e.g., Intel® 3D XPoint™ memory, chalcogenide RAM (CRAM), Interfacial Phase-Change Memory (IPCM), and the like), memistor devices, resistive memory or resistive RAM (ReRAM) (e.g., memristor devices, metal oxide-based ReRAM, quantum dot resistive memory devices, and the like), conductive bridging RAM (or PMC), magnetoresistive RAM (MRAM), electrochemical RAM (ECRAM), ferroelectric RAM (FeRAM), anti-ferroelectric RAM (AFeRAM), ferroelectric field-effect transistor (FeFET) memory, and/or the like. Additionally or alternatively, the memory circuitry 1210 can include spintronic memory devices (e.g., domain wall memory (DWM), spin transfer torque (STT) memory (e.g., STT-RAM or STT-MRAM), magnetic tunneling junction memory devices, spin—orbit transfer memory devices, Spin—Hall memory devices, nanowire memory cells, and/or the like). In some implementations, the individual memory devices 1210 may be formed into any number of different package types, such as single die package (SDP), dual die package (DDP), quad die package (Q17P), memory modules (e.g., dual inline memory modules (DIMMs), microDIMMs, and/or MiniDIMMs), and/or the like. Additionally or alternatively, the memory circuitry 1210 is or includes block addressable memory device(s), such as those based on NAND or NOR flash memory technologies (e.g., single-level cell (“SLC”), multi-level cell (“MLC”), quad-level cell (“QLC”), tri-level cell (“TLC”), or some other NAND or NOR device). Additionally or alternatively, the memory circuitry 1210 can include resistor-based and/or transistor-less memory architectures. In some examples, the memory circuitry 1210 can refer to a die, chip, and/or a packaged memory product. In some implementations, the memory 1210 can be or include the on-die memory or registers associated with the processor circuitry 1202. Additionally or alternatively, the memory 1210 can include any of the devices/components discussed infra w.r.t the storage circuitry 1220. In some examples, the memory circuitry 1210 corresponds to the host (system) memory 470 discussed previously.

The storage 1220 (also referred to as “storage circuitry 1220”) provides persistent storage to of information, such as data, OSs, apps, instructions 1221, and/or other software elements. As examples, the storage 1220 may be embodied as a magnetic disk storage device, hard disk drive (HDD), microHDD, solid-state drive (SSD), optical storage device, flash memory devices, memory card (e.g., secure digital (SD) card, eXtreme Digital (XD) picture card, USB flash drives, SIM cards, and/or the like), and/or any combination thereof. The storage circuitry 1220 can also include specific storage units, such as storage devices and/or storage disks that include optical disks (e.g., DVDs, CDs/CD-ROM, Blu-ray disks, and the like), flash drives, floppy disks, hard drives, and/or any number of other hardware devices in which information is stored for any duration (e.g., for extended time periods, permanently, for brief instances, for temporarily buffering, and/or caching). Additionally or alternatively, the storage circuitry 1220 can include resistor-based and/or transistor-less memory architectures. Further, any number of technologies may be used for the storage 1220 in addition to, or instead of, the previously described technologies, such as, for example, resistance change memories, phase change memories, holographic memories, chemical memories, among many others. Additionally or alternatively, the storage circuitry 1220 can include any of the devices or components discussed previously w.r.t the memory 1210.

Computer program code for carrying out operations of the present disclosure (e.g., computational logic and/or instructions 1201, 1211, 1221) may be written in any combination of one or more programming languages, including object oriented programming languages, procedural programming languages, scripting languages, markup languages, and/or some other suitable programming languages including proprietary programming languages and/or development tools, or any other languages tools. The computer program/code 1201, 1211, 1221 for carrying out operations of the present disclosure may also be written in any combination of programming languages and/or machine language, such as any of those discussed herein. The program code may execute entirely on the system 1200, partly on the system 1200, as a stand-alone software package, partly on the system 1200 and partly on a remote computer or entirely on the remote computer or server. In the latter scenario, the remote computer may be connected to the system 1200 through any type of network, including a LAN or WAN, or the connection may be made to an external computer (e.g., through the Internet, enterprise network, and/or some other network). Additionally or alternatively, the computer program/code 1201, 1211, 1221 can include one or more operating systems (OS) and/or other software to control various aspects of the compute node 1200. The OS can include drivers to control particular devices that are embedded in the compute node 1200, attached to the compute node 1200, and/or otherwise communicatively coupled with the compute node 1200. Example OSs include consumer-based OS, real-time OS (RTOS), hypervisors, and/or the like.

The storage 1220 may include instructions 1221 in the form of software, firmware, or hardware commands to implement the techniques described herein. Although such instructions 1221 are shown as code blocks included in the memory 1210 and/or storage 1220, any of the code blocks may be replaced with hardwired circuits, for example, built into an ASIC, FPGA memory blocks/cells, and/or the like. In an example, the instructions 1201, 1211, 1221 stored and/or provided via the memory 1210, the storage 1220, and/or the processor 1202 are embodied as a non-transitory or transitory machine-readable medium 1204 (also referred to as “computer readable medium 1204” or “CRM 1204”) including code (e.g., instructions 1201, 1211, 1221, accessible over the IX 1206, to direct the processor 1202 to perform various operations and/or tasks, such as a specific sequence or flow of actions as described herein and/or depicted in any of the accompanying drawings. The CRM 1204 may be embodied as any of the devices/technologies described for the memory 1210 and/or storage 1220.

The various components of the computing node 1200 communicate with one another over an interconnect (IX) 1206. The IX 1206 may include any number of IX (or similar) technologies including, for example, instruction set architecture (ISA), extended ISA (eISA), Inter-Integrated Circuit (I²C), serial peripheral interface (SPI), point-to-point interfaces, power management bus (PMBus), peripheral component interconnect (PCI), PCI express (PCIe), PCI extended (PCIx), Intel® Ultra Path Interconnect (UPI), Intel® Accelerator Link, Intel® QuickPath Interconnect (QPI), Intel® Omni-Path Architecture (OPA), Compute Express Link™ (CXL™) IX, RapidIO™ IX, Coherent Accelerator Processor Interface (CAPI), OpenCAPI, Advanced Microcontroller Bus Architecture (AMBA) IX, cache coherent interconnect for accelerators (CCIX), Gen-Z Consortium IXs, a HyperTransport IX, NVLink provided by NVIDIA®, ARM Advanced eXtensible Interface (AXI), a Time-Trigger Protocol (TTP) system, a FlexRay system, PROFIBUS, Ethernet, USB, On-Chip System Fabric (IOSF), Infinity Fabric (IF), and/or any number of other IX technologies. The IX 1206 may be a proprietary bus, for example, used in a SoC based system. Additionally or alternatively, the IX 1206 may be a suitable compute fabric such as the compute fabric circuitry 1350 discussed infra with respect to FIG. 13.

The communication circuitry 1260 comprises a set of hardware elements that enables the compute node 1200 to communicate over one or more networks (e.g., cloud 1265) and/or with other devices 1290. Communication circuitry 1260 includes various hardware elements, such as, for example, switches, filters, amplifiers, antenna elements, and the like to facilitate over-the-air (OTA) communications. Communication circuitry 1260 includes modem circuitry 1261 that interfaces with processor circuitry 1202 for generation and processing of baseband signals and for controlling operations of transceivers (TRx) 1262, 1263. The modem circuitry 1261 handles various radio control functions according to one or more communication protocols and/or RATs, such as any of those discussed herein. The modem circuitry 1261 includes baseband processors or control logic to process baseband signals received from a receive signal path of the TRxs 1262, 1263, and to generate baseband signals to be provided to the TRxs 1262, 1263 via a transmit signal path.

The TRxs 1262, 1263 include hardware elements for transmitting and receiving radio waves according to any number of frequencies and/or communication protocols, such as any of those discussed herein. The TRxs 1262, 1263 can include transmitters (Tx) and receivers (Rx) as separate or discrete electronic devices, or single electronic devices with Tx and Rx functionally. In either implementation, the TRxs 1262, 1263 may be configured to communicate over different networks or otherwise be used for different purposes. In one example, the TRx 1262 is configured to communicate using a first RAT (e.g., [IEEE802] RATs, such as [IEEE80211], [IEEE802154], [WiMAX], IEEE 802.11bd, ETSI ITS-G5, and/or the like) and TRx 1263 is configured to communicate using a second RAT (e.g., 3GPP RATs such as 3GPP LTE or NR/5G). In another example, the TRxs 1262, 1263 may be configured to communicate over different frequencies or ranges, such as the TRx 1262 being configured to communicate over a relatively short distance (e.g., devices 1290 within about 10 meters using a local Bluetooth®, devices 1290 within about 50 meters using ZigBee®, and/or the like), and TRx 1262 being configured to communicate over a relatively long distance (e.g., using [IEEE802], [WiMAX], and/or 3GPP RATs). The same or different communications techniques may take place over a single TRx at different power levels or may take place over separate TRxs.

A network interface circuitry 1230 (also referred to as “network interface controller 1230” or “NIC 1230”) provides wired communication to nodes of the cloud 1265 and/or to connected devices 1290. The wired communications may be provided according to Ethernet (e.g.,) or may be based on other types of networks, such as Controller Area Network (CAN), Local Interconnect Network (LIN), DeviceNet, ControlNet, Data Highway+, or PROFINET, among many others. As examples, the NIC 1230 may be embodied as a SmartNIC and/or one or more intelligent fabric processors (IFPs). One or more additional NICs 1230 may be included to enable connecting to additional networks. For example, a first NIC 1230 can provide communications to the cloud 1265 over an Ethernet network (e.g., [IEEE802.3]), a second NIC 1230 can provide communications to connected devices 1290 over an optical network (e.g., optical transport network (OTN), Synchronous optical networking (SONET), and synchronous digital hierarchy (SDH)), and so forth. In some examples, the network interface circuitry 1230 corresponds to the host processor of the NIC 468 discussed previously.

Given the variety of types of applicable communications from the compute node 1200 to another component, device 1290, and/or network 1265, applicable communications circuitry used by the compute node 1200 may include or be embodied by any combination of components 1230, 1240, 1250, or 1260. Accordingly, applicable means for communicating (e.g., receiving, transmitting, broadcasting, and so forth) may be embodied by such circuitry.

The acceleration circuitry 1250 (also referred to as “accelerator circuitry 1250”) includes any suitable hardware device or collection of hardware elements that are designed to perform one or more specific functions more efficiently in comparison to general-purpose processing elements. The acceleration circuitry 1250 can include various hardware elements such as, for example, one or more GPUs, FPGAs, DSPs, SoCs (including programmable SoCs and multi-processor SoCs), ASICs (including programmable ASICs), PLDs (including complex PLDs (CPLDs) and high capacity PLDs (HCPLDs), xPUs (e.g., DPUs, IPUs, and NPUs) and/or other forms of specialized circuitry designed to accomplish specialized tasks. Additionally or alternatively, the acceleration circuitry 1250 may be embodied as, or include, one or more of artificial intelligence (AI) accelerators (e.g., vision processing unit (VPU), neural compute sticks, neuromorphic hardware, deep learning processors (DLPs) or deep learning accelerators, tensor processing units (TPUs), physical neural network hardware, and/or the like), cryptographic accelerators (or secure cryptoprocessors), network processors, I/O accelerator (e.g., DMA engines and the like), and/or any other specialized hardware device/component. The offloaded tasks performed by the acceleration circuitry 1250 can include, for example, AI/ML tasks (e.g., training, feature extraction, model execution for inference/prediction, classification, and so forth), visual data processing, graphics processing, digital and/or analog signal processing, network data processing, infrastructure function management, object detection, rule analysis, and/or the like.

The TEE 1270 operates as a protected area accessible to the processor circuitry 1202 and/or other components to enable secure access to data and secure execution of instructions. In some implementations, the TEE 1270 may be a physical hardware device that is separate from other components of the system 1200 such as a secure-embedded controller, a dedicated SoC, a trusted platform module (TPM), a tamper-resistant chipset or microcontroller with embedded processing devices and memory devices, and/or the like. Additionally or alternatively, the TEE 1270 is implemented as secure enclaves (or “enclaves”), which are isolated regions of code and/or data within the processor and/or memory/storage circuitry of the compute node 1200, where only code executed within a secure enclave may access data within the same secure enclave, and the secure enclave may only be accessible using the secure app (which may be implemented by an app processor or a tamper-resistant microcontroller). In some implementations, the memory circuitry 1204 and/or storage circuitry 1208 may be divided into one or more trusted memory regions for storing apps or software modules of the TEE 1270. Additionally or alternatively, the processor circuitry 1202, acceleration circuitry 1250, memory circuitry 1210, and/or storage circuitry 1220 may be divided into, or otherwise separated into virtualized environments using a suitable virtualization technology, such as, for example, virtual machines (VMs), virtualization containers, and/or the like. These virtualization technologies may be managed and/or controlled by a virtual machine monitor (VMM), hypervisor container engines, orchestrators, and the like. Such virtualization technologies provide execution environments in which one or more apps and/or other software, code, or scripts may execute while being isolated from one or more other apps, software, code, or scripts.

The input/output (I/O) interface circuitry 1240 (also referred to as “interface circuitry 1240”) is used to connect additional devices or subsystems. The interface circuitry 1240, is part of, or includes circuitry that enables the exchange of information between two or more components or devices such as, for example, between the compute node 1200 and various additional/external devices (e.g., sensor circuitry 1242, actuator circuitry 1244, and/or positioning circuitry 1243). Access to various such devices/components may be implementation specific, and may vary from implementation to implementation. At least in some examples, the interface circuitry 1240 includes one or more hardware interfaces such as, for example, buses, input/output (I/O) interfaces, peripheral component interfaces, network interface cards, and/or the like. Additionally or alternatively, the interface circuitry 1240 includes a sensor hub or other like elements to obtain and process collected sensor data and/or actuator data before being passed to other components of the compute node 1200.

The sensor circuitry 1242 includes devices, modules, or subsystems whose purpose is to detect events or changes in its environment and send the information (sensor data) about the detected events to some other a device, module, subsystem, and the like. Individual sensors 1242 may be exteroceptive sensors (e.g., sensors that capture and/or measure environmental phenomena and/external states), proprioceptive sensors (e.g., sensors that capture and/or measure internal states of the compute node 1200 and/or individual components of the compute node 1200), and/or exproprioceptive sensors (e.g., sensors that capture, measure, or correlate internal states and external states). Examples of such sensors 1242 include inertia measurement units (IMU), microelectromechanical systems (MEMS) or nanoelectromechanical systems (NEMS), level sensors, flow sensors, temperature sensors (e.g., thermistors, including sensors for measuring the temperature of internal components and sensors for measuring temperature external to the compute node 1200), pressure sensors, barometric pressure sensors, gravimeters, altimeters, image capture devices (e.g., visible light cameras, thermographic camera and/or thermal imaging camera (TIC) systems, forward-looking infrared (FLIR) camera systems, radiometric thermal camera systems, active infrared (IR) camera systems, ultraviolet (UV) camera systems, and/or the like), light detection and ranging (LiDAR) sensors, proximity sensors (e.g., IR radiation detector and the like), depth sensors, ambient light sensors, optical light sensors, ultrasonic transceivers, microphones, inductive loops, and/or the like. The IMUs, MEMS, and/or NEMS can include, for example, one or more 3-axis accelerometers, one or more 3-axis gyroscopes, one or more magnetometers, one or more compasses, one or more barometers, and/or the like.

The actuators 1244 allow compute node 1200 to change its state, position, and/or orientation, or move or control a mechanism or system. The actuators 1244 comprise electrical and/or mechanical devices for moving or controlling a mechanism or system, and converts energy (e.g., electric current or moving air and/or liquid) into some kind of motion. Additionally or alternatively, the actuators 1244 can include electronic controllers linked or otherwise connected to one or more mechanical devices and/or other actuation devices. As examples, the actuators 1244 can be or include any number and combination of the following: soft actuators (e.g., actuators that changes its shape in response to a stimuli such as, for example, mechanical, thermal, magnetic, and/or electrical stimuli), hydraulic actuators, pneumatic actuators, mechanical actuators, electromechanical actuators (EMAs), microelectromechanical actuators, electrohydraulic actuators, linear actuators, linear motors, rotary motors, DC motors, stepper motors, servomechanisms, electromechanical switches, electromechanical relays (EMRs), power switches, valve actuators, piezoelectric actuators and/or biomorphs, thermal biomorphs, solid state actuators, solid state relays (SSRs), shape-memory alloy-based actuators, electroactive polymer-based actuators, relay driver integrated circuits (ICs), solenoids, impactive actuators/mechanisms (e.g., jaws, claws, tweezers, clamps, hooks, mechanical fingers, humaniform dexterous robotic hands, and/or other gripper mechanisms that physically grasp by direct impact upon an object), propulsion actuators/mechanisms (e.g., wheels, axles, thrusters, propellers, engines, motors, servos, clutches, rotors, and the like), projectile actuators/mechanisms (e.g., mechanisms that shoot or propel objects or elements), payload actuators, audible sound generators (e.g., speakers and the like), LEDs and/or visual warning devices, and/or other like electromechanical components. Additionally or alternatively, the actuators 1244 can include virtual instrumentation and/or virtualized actuator devices.

Additionally or alternatively, the interface circuitry 1240 and/or the actuators 1244 can include various individual controllers and/or controllers belonging to one or more components of the compute node 1200 such as, for example, host controllers, cooling element controllers, baseboard management controller (BMC), platform controller hub (PCH), uncore components (e.g., shared last level cache (LLC) cache, caching agent (Cbo), integrated memory controller (IMC), home agent (HA), power control unit (PCU), configuration agent (Ubox), integrated I/O controller (IIO), and interconnect (IX) link interfaces and/or controllers), and/or any other components such as any of those discussed herein. The compute node 1200 may be configured to operate one or more actuators 1244 based on one or more captured events, instructions, control signals, and/or configurations received from a service provider, client device, and/or other components of the compute node 1200. Additionally or alternatively, the actuators 1244 can include mechanisms that are used to change the operational state (e.g., on/off, zoom or focus, and/or the like), position, and/or orientation of one or more sensors 1242.

The positioning circuitry (pos) 1243 includes circuitry to receive and decode signals transmitted/broadcasted by a positioning network of a global navigation satellite system (GNSS). Examples of navigation satellite constellations (or GNSS) include United States' Global Positioning System (GPS), Russia's Global Navigation System (GLONASS), the European Union's Galileo system, China's BeiDou Navigation Satellite System, a regional navigation system or GNSS augmentation system (e.g., Navigation with Indian Constellation (NAVIC), Japan's Quasi-Zenith Satellite System (QZSS), France's Doppler Orbitography and Radio-positioning Integrated by Satellite (DORIS), and the like), or the like. The positioning circuitry 1245 comprises various hardware elements (e.g., including hardware devices such as switches, filters, amplifiers, antenna elements, and the like to facilitate OTA communications) to communicate with components of a positioning network, such as navigation satellite constellation nodes. Additionally or alternatively, the positioning circuitry 1245 may include a Micro-Technology for Positioning, Navigation, and Timing (Micro-PNT) IC that uses a master timing clock to perform position tracking/estimation without GNSS assistance. The positioning circuitry 1245 may also be part of, or interact with, the communication circuitry 1260 to communicate with the nodes and components of the positioning network. The positioning circuitry 1245 may also provide position data and/or time data to the application circuitry (e.g., processor circuitry 1202), which may use the data to synchronize operations with various infrastructure (e.g., radio base stations), for turn-by-turn navigation, or the like. In some implementations, the positioning circuitry 1245 is, or includes an INS, which is a system or device that uses sensor circuitry 1242 (e.g., motion sensors such as accelerometers, rotation sensors such as gyroscopes, and altimeters, magnetic sensors, and/or the like to continuously calculate (e.g., using dead by dead reckoning, triangulation, or the like) a position, orientation, and/or velocity (including direction and speed of movement) of the platform 1200 without the need for external references.

In some examples, various I/O devices may be present within or connected to, the compute node 1200, which are referred to as input circuitry 1246 and output circuitry 1245. The input circuitry 1246 and output circuitry 1245 include one or more user interfaces designed to enable user interaction with the platform 1200 and/or peripheral component interfaces designed to enable peripheral component interaction with the platform 1200. The input circuitry 1246 and/or output circuitry 1245 may be, or may be part of a Human Machine Interface (HMI). Input circuitry 1246 includes any physical or virtual means for accepting an input including buttons, switches, dials, sliders, keyboard, keypad, mouse, touchpad, touchscreen, microphone, scanner, headset, and/or the like. The output circuitry 1245 may be included to show information or otherwise convey information, such as sensor readings, actuator position(s), or other like information. Data and/or graphics may be displayed on one or more user interface components of the output circuitry 1245. Output circuitry 1245 may include any number and/or combinations of audio or visual display, including, inter alia, one or more simple visual outputs/indicators (e.g., binary status indicators (e.g., light emitting diodes (LEDs)) and multi-character visual outputs, or more complex outputs such as display devices or touchscreens (e.g., Liquid Chrystal Displays (LCD), LED displays, quantum dot displays, projectors, and the like), with the output of characters, graphics, multimedia objects, and the like being generated or produced from the operation of the compute node 1200. The output circuitry 1245 may also include speakers or other audio emitting devices, printer(s), and/or the like. Additionally or alternatively, the sensor circuitry 1242 may be used as the input circuitry 1245 (e.g., an image capture device, motion capture device, or the like) and one or more actuators 1244 may be used as the output device circuitry 1245 (e.g., an actuator to provide haptic feedback or the like). In another example, near-field communication (NFC) circuitry comprising an NFC controller coupled with an antenna element and a processing device may be included to read electronic tags and/or connect with another NFC-enabled device. Peripheral component interfaces may include, but are not limited to, a non-volatile memory port, a USB port, an audio jack, a power supply interface, and the like. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 1280 can be used to power the compute node 1200, although, in examples in which the compute node 1200 is mounted in a fixed location, it may have a power supply coupled to an electrical grid, or the battery 1280 may be used as a backup power source. As examples, the battery 1280 can be a lithium ion battery or a metal-air battery (e.g., zinc-air battery, aluminum-air battery, lithium-air battery, and the like). Other battery technologies may be used in other implementations.

A battery monitor/charger 1282 may be included in the compute node 1200 to track the state of charge (SoCh) of the battery 1280, if included. The battery monitor/charger 1282 may be used to monitor other parameters of the battery 1280 to provide failure predictions, such as the state of health (SoH) and the state of function (SoF) of the battery 1280. The battery monitor/charger 1282 may include a battery monitoring IC. The battery monitor/charger 1282 may communicate the information on the battery 1280 to the processor 1202 over the IX 1206. The battery monitor/charger 1282 may also include an analog-to-digital (ADC) converter that enables the processor 1202 to directly monitor the voltage of the battery 1280 or the current flow from the battery 1280. The battery parameters may be used to determine actions that the compute node 1200 may perform, such as transmission frequency, mesh network operation, sensing frequency, and the like. A power block 1285, or other power supply coupled to a grid, may be coupled with the battery monitor/charger 1282 to charge the battery 1280. In some examples, the power block 1285 may be replaced with a wireless power receiver to obtain the power wirelessly, for example, through a loop antenna in the compute node 1200. A wireless battery charging circuit may be included in the battery monitor/charger 1282. The specific charging circuits may be selected based on the size of the battery 1280, and thus, the current required. The charging may be performed according to Airfuel Alliance standards, the Qi wireless charging standard, the Rezence charging standard, among others.

The compute node 1200 also includes clock circuitry 1252, which is a device (or collection of devices) that tracks the passage of time. In some implementations, the clock circuitry 1252 may be an atomic clock and/or a clock generator (electronic oscillator and/or timing-signal generator). In clock generator implementations, the clock circuitry 1252 may include resonant circuitry (e.g., crystal oscillator or the like) and amplifier circuitry to invert the signal from the resonant circuitry and feed a portion back into the resonant circuitry to maintain oscillation.

The crystal oscillator includes a piezoelectric resonator such as quartz, polycrystalline ceramics, thin-film resonators, and/or the like. Where crystal units are used, the clock circuitry 1252 may also include an oscillation circuit separate from the crystal clock. Where crystal oscillators are used, the crystal unit and oscillation circuit may be integrated into a single package or integrated circuit. Examples of such clock circuitry 1252 include crystal clocks (Y), crystal oscillators (XOs), calibrated dual XO (CDXO), microcomputer-compensated crystal oscillator (MCXO), oven controlled XOs (OCXOs), double OCXOs (DOCXOs), temperature-compensated crystal oscillator crystal oscillators (TCXOs), tactical miniature crystal oscillator (TMXO), temperature-sensing crystal oscillator (TSXO), voltage controlled XOs (VCXOs), and/or other suitable clocks and/or variants and/or combinations thereof. Any of the aforementioned crystal clocks and/or XOs may be formed from a suitable material such as quartz, rubidium (e.g., rubidium crystal oscillators (RbXO)), cesium (e.g., cesium beam atomic clocks), and/or other suitable materials and/or variants and/or combinations thereof.

The clock circuitry 1252 is configured to create a signal with a relatively precise frequency, which may be used by other components such as for example, keeping track of time, providing a clock signal for digital circuits, stabilizing frequencies for transmitters and receivers, and/or the like. In some implementations, the clock circuitry 1252 may be a stand-alone component (e.g., separate from the other components of compute node 1200), or may be part of another component (e.g., processor circuitry 1202 positioning circuitry 1243, and/or the like). Additionally or alternatively, the clock circuitry 1252 can be synchronized with a synchronization source. In one example, a timing indicated by GNSS signals (e.g., as provided by positioning circuitry 1275) can be used as a synchronization source in deployment scenarios where global synchronization is desired. Additionally or alternatively, a network time (or timing) can be used as a synchronization source in deployment scenarios where network-based synchronization is desired. Additionally or alternatively, a longwave radio clock or radio-controlled clock may be used as a synchronization source, where a dedicated terrestrial longwave radio transmitter connected to a time standard (e.g., an atomic clock) transmits a time code that is demodulated and decoded to determine the current time. Additionally or alternatively, a GM instance may be used as a synchronization source as described previously. Any combination of the previous synchronization sources may be used. Additionally or alternatively, any of the aforementioned synchronization sources as a primary synchronization source, and another one or more of the aforementioned synchronization sources can be used as secondary or fallback synchronization sources that is/are used when the primary synchronization source is unavailable. Additionally or alternatively, the clock circuitry 1252 may be configured with priority information for different synchronization sources, where each a highest priority synchronization source is used when available. The synchronization configuration may be signaled to, and provisioned in, the clock circuitry 1252 (via the communication circuitry).

The example of FIG. 12 is intended to depict a high-level view of components of a varying device, subsystem, or arrangement of an edge computing node. However, in other implementations, some of the components shown may be omitted, additional components may be present, and a different arrangement of the components shown may occur in other implementations. Further, these arrangements are usable in a variety of use cases and environments, including those discussed below (e.g., a mobile device in industrial compute for smart city or smart factory, among many other examples).

FIG. 13 depicts an example of an infrastructure processing unit (IPU) 1300. Different examples of IPUs 1300 discussed herein are capable of supporting one or more processors (such as any of those discussed herein) connected to the IPUs 1300, and enable improved performance, management, security and coordination functions between entities (e.g., cloud service providers), and enable infrastructure offload and/or communications coordination functions. As discussed infra, IPUs 1300 may be integrated with smart NICs and/or storage or memory (e.g., on a same die, system on chip (SoC), or connected dies) that are located at on-premises systems, NANs (e.g., base stations, access points, gateways, network appliances, and/or the like), neighborhood central offices, and so forth. In various implementations, the IPU 1300, or individual components of the IPU 1300, may be or include the compute node 1200 of FIG. 12 and/or any other computing device discussed herein. Different examples of one or more IPUs 1300 discussed herein can perform application and/or functionality including any number of microservices, where each microservice runs in its own process and communicates using protocols (e.g., an HTTP resource API, message service, gRPC, and/or the like). Microservices can be independently deployed using centralized management of these services. A management system may be written in different programming languages and use different data storage technologies.

Furthermore, one or more IPUs 1300 can execute platform management, networking stack processing operations, security (crypto) operations, storage software, identity and key management, telemetry, logging, monitoring and service mesh (e.g., control how different microservices communicate with one another). The IPU 1300 can access an XPU to offload performance of various tasks. For instance, an IPU 1300 exposes XPU, storage, memory, and processor resources and capabilities as a service that can be accessed by other microservices for function composition. This can improve performance and reduce data movement and latency. An IPU 1300 can perform capabilities such as those of a router, load balancer, firewall, TCP/reliable transport, a service mesh (e.g., proxy or API gateway), security, data transformation, authentication, quality of service (QoS), security, telemetry measurement, event logging, initiating and managing data flows, data placement, or job scheduling of resources on an XPU, storage, memory, and/or processor circuitry.

In the example of FIG. 13, the IPU 1300 includes or otherwise accesses secure resource management (SRM) circuitry 1302, network interface controller (NIC) circuitry 1304, security and root of trust (SRT) circuitry 1306, resource composition circuitry 1308, timestamp management (TSM) circuitry 1310, memory and storage circuitry 1312, processing circuitry 1314, accelerator circuitry 1316, and/or translator circuitry 1318. Any number and/or combination of other structure(s) can be used such as, but not limited to, compression and encryption (C&E) circuitry 1320; memory management and translation unit (MMTU) circuitry 1322; compute fabric data switching (CFDS) circuitry 1324; security policy enforcement (SPE) circuitry 1326, device virtualization (DV) circuitry 1328; telemetry, tracing, logging, and monitoring (TTLM) circuitry 1330, quality of service (QoS) circuitry 1332, searching circuitry 1334, network function (NF) circuitry 1336 (e.g., operating as a router, switch (e.g., software-defined networking (SDN) switch), firewall, load balancer, network address translator (NAT), and/or any other suitable NF such as any of those discussed herein); reliable transporting, ordering, retransmission, congestion control (RTORCC) circuitry 1338; and high availability, fault handling and migration (HAFHM) circuitry 1340 as shown by FIG. 13. Different examples can use one or more structures (components) of the example IPU 1300 together or separately. For example, C&E circuitry 1320 can be used as a separate service or chained as part of a data flow with vSwitch and packet encryption.

In some examples, IPU 1300 includes programmable circuitry 1370 structured to receive commands from processor circuitry 1314 (e.g., CPU, GPU, XPUs, DPUs, NPUs, and/or the like) and/or an application or service via an API and perform commands/tasks on behalf of the processor circuitry 1314 or other requesting element, including workload management and offload or accelerator operations. The programmable circuitry 1370 can include any number of field programmable gate arrays (FPGAs), programmable ASICs, programmable SoCs, CLDs, DSPs, and/or other programmable devices configured and/or otherwise structures to perform any operations of any IPU 1300 described herein.

Example compute fabric circuitry 1350 provides connectivity to a local host or device (e.g., server or device such as compute resources, memory resources, storage resources, and/or the like). Connectivity with a local host or device or smartNIC or another IPU is, in some examples, provided using one or more of PCI (or variants thereof such as PCIe and/or the like), ARM AXI, Intel® QPI, Intel® UPI, Intel® On-Chip System Fabric (IOSF), Omnipath, Ethernet, Compute Express Link (CXL), HyperTransport, NVLink, Advanced Microcontroller Bus Architecture (AMBA) interconnect, OpenCAPI, Gen-Z, CCIX, Infinity Fabric (IF), and so forth. In some examples, the compute fabric circuitry 1350 may implement any of the IX technologies discussed previously with respect to IX 1256. Different examples of the host connectivity provide symmetric memory and caching to enable equal peering between CPU, XPU, DPU, and IPU (e.g., via CXL.cache and CXL.mem).

Example media interfacing circuitry 1360 provides connectivity to a remote smartNIC, another IPU (e.g., another IPU 1300 or the like), and/or service via a network medium or fabric. This can be provided over any type of network media (e.g., wired or wireless) and/or using any suitable protocol (e.g., Ethernet, InfiniBand, Fiber channel, ATM, and/or the like).

In some examples, instead of the server/CPU being the primary component managing IPU 1300, IPU 1300 is a root of a system (e.g., rack of servers or data center) and manages compute resources (e.g., CPU, XPU, storage, memory, other IPUs, and so forth) in the IPU 1300 and outside of the IPU 1300. Different operations of an IPU are described below.

In some examples, the IPU 1300 performs orchestration to decide which hardware or software is to execute a workload based on available resources (e.g., services and devices) and considers service level agreements and latencies, to determine whether resources (e.g., CPU, XPU, storage, memory, and/or the like) are to be allocated from the local host or from a remote host or pooled resource. In examples when the IPU 1300 is selected to perform a workload, secure resource managing circuitry 1302 offloads work to a CPU, XPU, or other device or platform, and the IPU 1300 accelerates connectivity of distributed runtimes, reduce latency, and increases reliability.

In some examples, SRM circuitry 1302 runs a service mesh to decide what resource is to execute workload, and provide for L7 (application layer) and remote procedure call (RPC) traffic to bypass kernel altogether so that a user space application can communicate directly with the example IPU 1300 (e.g., IPU 1300 and application can share a memory space). In some examples, a service mesh is a configurable, low-latency infrastructure layer designed to handle communication among application microservices using application programming interfaces (APIs) (e.g., over RPCs and/or the like). The example service mesh provides fast, reliable, and secure communication among containerized or virtualized application infrastructure services. The service mesh can provide critical capabilities including, but not limited to service discovery, load balancing, encryption, observability, traceability, authentication and authorization, and support for the circuit breaker pattern. In some examples, infrastructure services include a composite node created by an IPU at or after a workload from an application is received. In some cases, the composite node includes access to hardware devices, software using APIs, RPCs, gRPCs, or communications protocols with instructions such as, but not limited, to iSCSI, NVMe-oF, or CXL. In some cases, the example IPU 1300 dynamically selects itself to run a given workload (e.g., microservice) within a composable infrastructure including an IPU, XPU, CPU, storage, memory, and other devices in a node.

In some examples, communications transit through media interfacing circuitry 1360 of the to example IPU 1300 through a NIC/smartNIC (for cross node communications) or loopback back to a local service on the same host. Communications through the example media interfacing circuitry 1360 of the example IPU 1300 to another IPU can then use shared memory support transport between XPUs switched through the local IPUs. Use of IPU-to-IPU communication can reduce latency and jitter through ingress scheduling of messages and work processing based on service level objective (SLO).

For example, for a request to a database application that requires a response, the example IPU 1300 prioritizes its processing to minimize the stalling of the requesting application. In some examples, the IPU 1300 schedules the prioritized message request issuing the event to execute a SQL query database and the example IPU constructs microservices that issue SQL queries and the queries are sent to the appropriate devices or services.

FIG. 14 depicts an example systems 1400a and 1400b. System 1400a includes a compute server 1410a, storage server 1411a, and machine learning (ML) server 1412a. The compute server 1410a includes one or more CPUs 1450 (which may be the same or similar as the processor circuitry 1252 of FIG. 12) and a network interface controller (NIC) 1468 (which may be the same or similar as the network interface circuitry 1268 of FIG. 12). The storage server 1411a includes a CPU 1450, a NIC 1468, and one or more solid state drives (SSDs) 1460 (which may be the same or similar as the NTCRM 1260 of FIG. 12). The ML server 1412a includes a CPU 1450, a NIC 1468, and one or more GPUs 1452. In system 1400a, workload execution 1403 is/are provided on or by CPUs 1450 and GPUs 1452 of the servers 1410a, 1411a, 1412a. System 1400a includes security control point (SCP) 1401, which delivers security and trust within individual CPUs 1450.

System 1400b includes a compute server 1410b, storage server 1411b, ML server 1412b, an inference server 1420, flexible server 1421, and multi-acceleration server 1422. The compute server 1410b includes one or more CPUs 1450 and an IPU 1424 (which may be the same or similar as the IPU 1300 of FIG. 13). The storage server 1411b includes an ASIC 1451, an IPU 1424, and one or more SSDs 1460. The ML server 1412b includes one or more GPUs 1452 and an IPU 1424. The inference server 1420 includes an IPU 1424 and one or more inference accelerators 1464 (which may be the same or similar as the acceleration circuitry 1264 of FIG. 12). The flexible server 1421 includes an IPU 1424 and a one or more FPGAs 1465 (which may be the same or similar as FPGAs discussed previously). The multi-acceleration server 1422 includes an IPU 1424, one or more FPGAs 1465, and one or more inference accelerators 1464. System 1400b involves rebalancing the SCPs 1401 as cloud service providers (CSPs) absorb infrastructure workloads 1403. The system 1400b rebalances the SCPs 1401 to IPUs 1424 from CPUs 1450 to handle workload execution 1403 by CSPs. Additionally, infrastructure security and SCPs 1401 move into the IPUs 1424, and the SCPs 1401 provide end-to-end security. Various elements of the IPU 1300 of FIG. 13 can be used to provide SCPs 1401 such as, for example, the SRM circuitry 1302 and/or the SRT circuitry 1306.

### 4. Example Implementations

Additional examples of the presently described methods, devices, systems, and networks discussed herein include the following, non-limiting implementations. Each of the following non-limiting examples may stand on its own or may be combined in any permutation or combination with any one or more of the other examples provided below or throughout the present disclosure.

Example [0147] includes a method of operating a network controller, the method comprising: steering a received data unit belonging to batch and assigned to a traffic class (TC) to a buffer that is assigned to the TC; storing the received data unit in the buffer; and during or after transfer of the data unit from the buffer to a memory location in a receiver (Rx) queue indicated by a corresponding descriptor: determining whether at least one other data unit belonging to the batch has not been transferred to the Rx queue; and setting a next bit field in the corresponding descriptor when the at least one other data unit is not in the Rx queue and/or is still stored in the buffer.

Example [0148] includes a method of operating a network controller, the method comprising: steering received data units belonging to a batch of data units to a buffer for storage in the buffer; determining, during or after transfer of a data unit in the batch from the buffer to a receiver (Rx) queue, whether at least one other data unit in the batch should be transferred to the Rx queue with other data units in the batch; and setting, after the data unit is transferred to a slot in the Rx queue indicated by a corresponding descriptor, a next bit field in the corresponding descriptor.

Example [0149] includes the method of example [0147]-[0148] and/or some other example(s) herein, wherein the method includes: transferring or causing to transfer the data unit from the buffer to the memory location indicated by the corresponding descriptor.

Example [0150] includes a method of operating a network controller, the method comprising: steering a received data unit belonging to batch to a buffer; storing the received data unit in the buffer along with zero or more other data units belonging to the batch; transferring individual data units from the buffer to respective memory locations indicated by corresponding descriptors; and after the individual data units are transferred to the memory location, setting respective next bits in the corresponding descriptors when at least one other data unit in the batch is still in the buffer.

Example [0151] includes the method of example [0150] and/or some other example(s) herein, wherein the method includes: after the data unit is transferred to the memory location, not setting the next bit field in the corresponding descriptor when no other data units in the batch are still stored in the buffer.

Example [0152] includes the method of examples [0147]-[0151] and/or some other example(s) herein, wherein the buffer is implemented using a memory device of the network controller, and the memory location is an area of a system memory of a host platform.

Example [0153] includes the method of example [0152] and/or some other example(s) herein, wherein the memory location is a slot in a queue implemented by the system memory, and the queue is assigned to the TC.

Example [0154] includes the method of examples [0147]-[0153] and/or some other example(s) herein, wherein the TC is a high priority TC among a plurality of TCs, and the plurality of TCs includes at least one other TC with a lower priority than the high priority TC.

Example [0155] includes the method of example [0154] and/or some other example(s) herein, wherein the high priority TC is associated with cyclic traffic or time-sensitive networking traffic.

Example [0156] includes the method of examples [0154]-[0155] and/or some other example(s) herein, wherein the buffer is a first buffer, the network controller includes a plurality of buffers including the first buffer, and each buffer of the plurality of buffers is assigned a corresponding TC of the plurality of TCs.

Example [0157] includes the method of examples [0152]-[0156] and/or some other example(s) herein, wherein the setting a next bit field in the corresponding descriptor includes: signalling a packet engine to set the next bit in the corresponding descriptor.

Example [0158] includes the method of example [0157] and/or some other example(s) herein, wherein the packet engine corresponds to the buffer or the TC.

Example [0159] includes the method of examples [0157]-[0158] and/or some other example(s) herein, wherein the packet engine is a local area network (LAN) engine, a protocol engine, or a direct memory access (DMA) engine.

Example [0160] includes the method of examples [0157]-[0159] and/or some other example(s) herein, wherein the packet engine is to release the corresponding descriptor after the data unit is transferred to the memory location and after the next bit field in the corresponding descriptor is set.

Example [0161] includes the method of example [0160] and/or some other example(s) herein, wherein the releasing the corresponding descriptor includes the PE setting an own bit in to the corresponding descriptor to zero.

Example [0162] includes the method of examples [0160]-[0161] and/or some other example(s) herein, wherein the PE is to signal an operating system kernel in the host platform after the corresponding descriptor is released.

Example [0163] includes the method of example [0162] and/or some other example(s) herein, wherein the PE is to send an interrupt request (IRQ) to the operating system kernel in the host platform after the corresponding descriptor is released.

Example [0164] includes the method of examples [0156]-[0163] and/or some other example(s) herein, wherein the network controller includes a set of in-transit data unit detectors (ITDs), wherein individual ITDs of the set of ITDs are assigned to corresponding buffers of the plurality of buffers.

Example [0165] includes the method of example [0164] and/or some other example(s) herein, wherein a number of ITDs in the set of ITDs is equal to a number of buffers in the plurality of buffers.

Example [0166] includes the method of example [0164] and/or some other example(s) herein, wherein a number of ITDs in the set of ITDs is less than a number of buffers in the plurality of buffers.

Example [0167] includes the method of examples [0164]-[0166] and/or some other example(s) herein, wherein the network controller includes an ITD controller, and the method includes: operating the ITD controller to activate or deactivate the individual ITDs based on the corresponding TC of the corresponding buffers.

Example [0168] includes the method of examples [0164]-[0167] and/or some other example(s) herein, wherein the method includes: operating a first ITD corresponding to the first buffer to tag the received data unit with a next bit tag.

Example [0169] includes the method of example [0168] and/or some other example(s) herein, wherein the PE is to extract the next bit tag from the received data unit and insert the extracted next bit tag into the corresponding descriptor.

Example [0170] includes the method of examples [0147]-[0169] and/or some other example(s) herein, wherein the steering is performed by a receiver steering function.

Example [0171] includes the method of example [0170] and/or some other example(s) herein, wherein the receiver steering function is to steer the received data unit to the buffer based on a priority of the received data unit included in the received data unit.

Example [0172] includes the method of example [0171] and/or some other example(s) herein, wherein the priority of the received data unit is included in a virtual local area network tag included in the received data unit.

Example [0173] includes the method of examples [0147]-[0172] and/or some other example(s) herein, wherein the method includes: checking a data unit status of the received data unit based on error-detecting code of the received data unit.

Example [0174] includes the method of example [0173] and/or some other example(s) herein, wherein the data unit is a frame, and the error-detecting code is a frame check sequence (FCS).

Example [0175] includes the method of examples [0147]-[0174] and/or some other example(s) herein, wherein the method is performed by a medium access control (MAC) entity in the network controller.

Example [0176] includes a method of operating a network driver of a host platform, the method comprising: reading, during a batch processing cycle, descriptors associated with respective slots of a receiver (Rx) queue in a system memory of the host platform, wherein the Rx queue stores a batch of data units in the respective slots; processing, during the batch processing cycle, the batch of data units in the Rx queue; and continuing the batch processing cycle while a next bit field in the descriptors is active or until a next bit field in one of the descriptors is inactive.

Example [0177] includes a method of operating a network driver of a host platform, the method comprising: for an individual data unit belonging to a batch during a batch processing cycle: read a descriptor to determine a slot in which the individual data unit is stored, wherein data unit belonging to the batch are stored in respective slots of an Rx queue maintained in a system memory of the host platform; read the individual data unit out of the determined slot; and continue the batch processing cycle when a next bit field in the descriptor is active, wherein the next bit field being active indicates that at least one additional data unit belonging to the batch is stored in another slot of the Rx queue or will be transferred into the another slot.

Example [0178] includes the method of examples [0176]-[0177] and/or some other example(s) herein, wherein the method includes: causing or permitting a task switch to take place when the next bit field in the descriptor is inactive.

Example [0179] includes the method of example [0178] and/or some other example(s) herein, wherein the method includes: causing or permitting the task switch to take place when all data units belonging to the batch have been transferred to the Rx queue.

Example [0180] includes the method of examples [0176]-[0179] and/or some other example(s) herein, wherein the continuing the batch processing cycle includes: executing a bounded spinning process or a spinlock to prevent a task switch from taking place.

Example [0181] includes the method of examples [0176]-[0180] and/or some other example(s) herein, wherein the method includes: disabling an Rx interrupt request (IRQ) before processing the batch of data units.

Example [0182] includes the method of example [0181] and/or some other example(s) herein, wherein the method includes: enabling the Rx IRQ when all data units belonging to the batch are processed during the batch processing cycle.

Example [0183] includes the method of examples [0176]-[0182] and/or some other example(s) herein, wherein the data units belonging to the batch are transferred into the Rx queue from a buffer implemented by a network controller.

Example [0184] includes the method of examples [0176]-[0183] and/or some other example(s) herein, wherein the method includes the method of any one or more of examples [0147]-[0175] and/or some other example(s) herein.

Example [0184] includes the method of examples [0147]-[0176], [0183]-[0184], and/or some other example(s) herein, wherein the network controller is disposed in one or more of a time-aware system in a time-aware network, a precision time protocol computing instance, a router, a bridge, a hub, a network appliance, a gateway device, a user equipment or end station, a network access node, an edge compute node, a cloud compute node, a network function in a core network, and an application server.

Example [0186] includes the method of examples [0147]-[0185] and/or some other example(s) herein, wherein each data unit in the batch is a packet, frame, datagram, protocol data unit (PDU), service data unit (SDU), segment, data block, data chunk, cell, data field, data element, information element, type length value, a set of bytes, a set of bits, or a set of symbols.

Example [0187] includes one or more computer readable media comprising instructions, wherein execution of the instructions by processor circuitry is to cause the processor circuitry to perform the method of examples [0147]-[0186] and/or some other example(s) herein.

Example [0188] includes a computer program comprising the instructions of example [187] and/or some other example(s) herein.

Example [0189] includes an Application Programming Interface defining functions, methods, variables, data structures, and/or protocols for the computer program of example [0188] and/or some other example(s) herein.

Example [0190] includes an apparatus comprising circuitry loaded with the instructions of example [0187] and/or some other example(s) herein.

Example [0191] includes an apparatus comprising circuitry operable to run the instructions of example [0187] and/or some other example(s) herein.

Example [0192] includes an integrated circuit comprising one or more of the processor circuitry and the one or more computer readable media of example [0187] and/or some other example(s) herein.

Example [0193] includes a computing system comprising the one or more computer readable media and the processor circuitry of example [0187] and/or some other example(s) herein.

Example [0194] includes an apparatus comprising means for executing the instructions of example 1.a.i.39 and/or some other example(s) herein.

Example [0195] includes a signal generated as a result of executing the instructions of example [0187] and/or some other example(s) herein.

Example [0196] includes a data unit generated as a result of executing the instructions of example [0187] and/or some other example(s) herein.

Example [0197] includes the data unit of example [0196] and/or some other example(s) herein, wherein the data unit is a datagram, packet, frame, subframe, segment, Protocol Data Unit (PDU), Service Data Unit (SDU), message, data block, data chunk, partition, fragment, and/or database object.

Example [0198] includes a signal encoded with the data unit of examples [0196]-[0197] and/or some other example(s) herein.

Example [0199] includes an electromagnetic signal carrying the instructions of example [187] and/or some other example(s) herein.

Example [0200] includes an apparatus comprising means for performing the method of examples [0147]-[0186] and/or some other example(s) herein.

### 5. Terminology

As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof. The phrase “A and/or B” means (A), (B), or (A and B). For the purposes of the present disclosure, the phrase “A, B, and/or C” means (A), (B), (C), (A and B), (A and C), (B and C), or (A, B and C). The description may use the phrases “in an embodiment,” or “In some embodiments,” each of which may refer to one or more of the same or different embodiments.

Furthermore, the terms “comprising,” “including,” “having,” and the like, as used with respect to the present disclosure, are synonymous.

The terms “master” and “slave” at least in some examples refers to a model of asymmetric communication or control where one device, process, element, or entity (the “master”) controls one or more other device, process, element, or entity (the “slaves”). The terms “master” and “slave” are used in this disclosure only for their technical meaning. The term “master” or “grandmaster” may be substituted with any of the following terms “main”, “source”, “primary”, “initiator”, “requestor”, “transmitter”, “host”, “maestro”, “controller”, “provider”, “producer”, “client”, “source”, “mix”, “parent”, “chief”, “manager”, “reference” (e.g., as in “reference clock” or the like), and/or the like. Additionally, the term “slave” may be substituted with any of the following terms “receiver”, “secondary”, “subordinate”, “replica”, target”, “responder”, “device”, “performer”, “agent”, “standby”, “consumer”, “peripheral”, “follower”, “server”, “child”, “helper”, “worker”, “node”, and/or the like.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or ink, and/or the like.

The term “establish” or “establishment” at least in some examples refers to (partial or in full) acts, tasks, operations, and the like, related to bringing or the readying the bringing of something into existence either actively or passively (e.g., exposing a device identity or entity identity). Additionally or alternatively, the term “establish” or “establishment” at least in some examples refers to (partial or in full) acts, tasks, operations, and the like, related to initiating, starting, or warming communication or initiating, starting, or warming a relationship between two entities or elements (e.g., establish a session, establish a session, and the like). Additionally or alternatively, the term “establish” or “establishment” at least in some examples refers to initiating something to a state of working readiness. The term “established” at least in some examples refers to a state of being operational or ready for use (e.g., full establishment). Furthermore, any definition for the term “establish” or “establishment” defined in any specification or standard can be used for purposes of the present disclosure and such definitions are not disavowed by any of the aforementioned definitions.

The term “obtain” at least in some examples refers to (partial or in full) acts, tasks, operations, and the like, of intercepting, movement, copying, retrieval, or acquisition (e.g., from a memory, an interface, or a buffer), on the original packet stream or on a copy (e.g., a new instance) to of the packet stream. Other aspects of obtaining or receiving may involving instantiating, enabling, or controlling the ability to obtain or receive a stream of packets (or the following parameters and templates or template values).

The term “receipt” at least in some examples refers to any action (or set of actions) involved with receiving or obtaining an object, data, data unit, and the like, and/or the fact of the object, data, data unit, and the like being received. The term “receipt” at least in some examples refers to an object, data, data unit, and the like, being pushed to a device, system, element, and the like (e.g., often referred to as a push model), pulled by a device, system, element, and the like (e.g., often referred to as a pull model), and/or the like.

The term “element” at least in some examples refers to a unit that is indivisible at a given level of abstraction and has a clearly defined boundary, wherein an element may be any type of entity including, for example, one or more devices, systems, controllers, network elements, modules, and so forth, or combinations thereof. The term “entity” at least in some examples refers to a distinct circuit, component, platform, architecture, device, system, and/or any other element.

The term “measurement” at least in some examples refers to the observation and/or quantification of attributes of an object, event, or phenomenon. Additionally or alternatively, the term “measurement” at least in some examples refers to a set of operations having the object of determining a measured value or measurement result, and/or the actual instance or execution of operations leading to a measured value. Additionally or alternatively, the term “measurement” at least in some examples refers to data recorded during testing.

The term “metric” at least in some examples refers to a quantity produced in an assessment of a measured value. Additionally or alternatively, the term “metric” at least in some examples refers to data derived from a set of measurements. Additionally or alternatively, the term “metric” at least in some examples refers to set of events combined or otherwise grouped into one or more values. Additionally or alternatively, the term “metric” at least in some examples refers to a combination of measures or set of collected data points. Additionally or alternatively, the term “metric” at least in some examples refers to a standard definition of a quantity, produced in an assessment of performance and/or reliability of the network, which has an intended utility and is carefully specified to convey the exact meaning of a measured value.

The term “signal” at least in some examples refers to an observable change in a quality and/or quantity. Additionally or alternatively, the term “signal” at least in some examples refers to a function that conveys information about of an object, event, or phenomenon. Additionally or alternatively, the term “signal” at least in some examples refers to any time varying voltage, current, or electromagnetic wave that may or may not carry information. The term “digital signal” at least in some examples refers to a signal that is constructed from a discrete set of waveforms of a physical quantity so as to represent a sequence of discrete values.

The term “identifier” at least in some examples refers to a value, or a set of values, that uniquely identify an identity in a certain scope. Additionally or alternatively, the term “identifier” at least in some examples refers to a sequence of characters that identifies or otherwise indicates the identity of a unique object, element, or entity, or a unique class of objects, elements, or entities.

Additionally or alternatively, the term “identifier” at least in some examples refers to a sequence of characters used to identify or refer to an application, program, session, object, element, entity, variable, set of data, and/or the like. The “sequence of characters” mentioned previously at least in some examples refers to one or more names, labels, words, numbers, letters, symbols, and/or any combination thereof. Additionally or alternatively, the term “identifier” at least in some examples refers to a name, address, label, descriptor, distinguishing index, and/or attribute. Additionally or alternatively, the term “identifier” at least in some examples refers to an instance of identification. The term “persistent identifier” at least in some examples refers to an identifier that is reused by a device or by another device associated with the same person or group of persons for an indefinite period. The term “identification” at least in some examples refers to a process of recognizing an identity as distinct from other identities in a particular scope or context, which may involve processing identifiers to reference an identity in an identity database. The term “application identifier”, “application ID”, or “app ID” at least in some examples refers to an identifier that can be mapped to a specific application, application instance, or application instance. In the context of 3GPP 5G/NR, an “application identifier” at least in some examples refers to an identifier that can be mapped to a specific application traffic detection rule.

The term “circuitry” at least in some examples refers to a circuit or system of multiple circuits configured to perform a particular function in an electronic device. The circuit or system of circuits may be part of, or include one or more hardware components, such as a logic circuit, a processor (shared, dedicated, or group) and/or memory (shared, dedicated, or group), an application-specific integrated circuit (ASIC), field-programmable gate array (FPGA), programmable logic controller (PLC), system on chip (SoC), system in package (SiP), multi-chip package (MCP), digital signal processor (DSP), and the like, that are configured to provide the described functionality. In addition, the term “circuitry” may also refer to a combination of one or more hardware elements with the program code used to carry out the functionality of that program code. Some types of circuitry may execute one or more software or firmware programs to provide at least some of the described functionality. Such a combination of hardware elements and program code may be referred to as a particular type of circuitry.

The terms “machine-readable medium” and “computer-readable medium” refers to tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., HTTP). A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, and/or the like), interpreting, loading, organizing (e.g., dynamically or statically linking), encoding, decoding, encrypting, unencrypting, packaging, unpackaging, or otherwise manipulating the information into the instructions. In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, and/or the like) on one or several remote servers. The source code packages may be encrypted when in transit over a network and decrypted, uncompressed, assembled (e.g., linked) if necessary, and compiled or interpreted (e.g., into a library, stand-alone executable, and/or the like) at a local machine, and to executed by the local machine. The terms “machine-readable medium” and “computer-readable medium” may be interchangeable for purposes of the present disclosure. The term “non-transitory computer-readable medium at least in some examples refers to any type of memory, computer readable storage device, and/or storage disk and may exclude propagating signals and transmission media.

The term “interface circuitry” at least in some examples refers to, is part of, or includes circuitry that enables the exchange of information between two or more components or devices. The term “interface circuitry” at least in some examples refers to one or more hardware interfaces, for example, buses, I/O interfaces, peripheral component interfaces, network interface cards, and/or the like.

The term “SmartNIC” at least in some examples refers to a network interface controller (NIC), network adapter, or a programmable network adapter card with programmable hardware accelerators and network connectivity (e.g., Ethernet or the like) that can offload various tasks or workloads from other compute nodes or compute platforms such as servers, application processors, and/or the like and accelerate those tasks or workloads. A SmartNIC has similar networking and offload capabilities as an IPU, but remains under the control of the host as a peripheral device.

The term “infrastructure processing unit” or “IPU” at least in some examples refers to an advanced networking device with hardened accelerators and network connectivity (e.g., Ethernet or the like) that accelerates and manages infrastructure functions using tightly coupled, dedicated, programmable cores. In some implementations, an IPU offers full infrastructure offload and provides an extra layer of security by serving as a control point of a host for running infrastructure applications. An IPU is capable of offloading the entire infrastructure stack from the host and can control how the host attaches to this infrastructure. This gives service providers an extra layer of security and control, enforced in hardware by the IPU.

The term “device” at least in some examples refers to a physical entity embedded inside, or attached to, another physical entity in its vicinity, with capabilities to convey digital information from or to that physical entity. The term “controller” at least in some examples refers to an element or entity that has the capability to affect a physical entity, such as by changing its state or causing the physical entity to move. The term “scheduler” at least in some examples refers to an entity or element that assigns resources (e.g., processor time, network links, memory space, and/or the like) to perform tasks. The term “network scheduler” at least in some examples refers to a node, element, or entity that manages network packets in transmit and/or receive queues of one or more protocol stacks of network access circuitry (e.g., a network interface controller (NIC), baseband processor, and the like). The term “network scheduler” at least in some examples can be used interchangeably to with the terms “packet scheduler”, “queueing discipline” or “qdisc”, and/or “queueing algorithm”.

The term “compute node” or “compute device” at least in some examples refers to an identifiable entity implementing an aspect of computing operations, whether part of a larger system, distributed collection of systems, or a standalone apparatus. In some examples, a compute node may be referred to as a “computing device”, “computing system”, or the like, whether in operation as a client, server, or intermediate entity. Specific implementations of a compute node may be incorporated into a server, base station, gateway, road side unit, on-premise unit, user equipment, end consuming device, appliance, or the like.

The term “computer system” at least in some examples refers to any type interconnected electronic devices, computer devices, or components thereof. Additionally, the terms “computer system” and/or “system” at least in some examples refer to various components of a computer that are communicatively coupled with one another. Furthermore, the term “computer system” and/or “system” at least in some examples refer to multiple computer devices and/or multiple computing systems that are communicatively coupled with one another and configured to share computing and/or networking resources.

The term “server” at least in some examples refers to a computing device or system, including processing hardware and/or process space(s), an associated storage medium such as a memory device or database, and, in some instances, suitable application(s). Additionally or alternatively, the term “server” at least in some examples refers to one or more computing system(s) that provide access to a pool of physical and/or virtual resources. As examples, the various servers discussed herein can be arranged or configured in a rack architecture, tower architecture, blade architecture, and/or the like. Additionally or alternatively, the various servers discussed herein may represent an individual server, a cluster of servers, a server farm, a cloud computing service, an edge computing network, a data center, and/or other grouping or pool of servers.

The term “platform” at least in some examples refers to an environment in which instructions, program code, software elements, and the like can be executed or otherwise operate, and examples of such an environment include an architecture (e.g., a motherboard, a computing system, and/or the like), one or more hardware elements (e.g., embedded systems, and the like), a cluster of compute nodes, a set of distributed compute nodes or network, an operating system, a virtual machine (VM), a virtualization container, a software framework, a client application (e.g., web browser or the like) and associated application programming interfaces, a cloud computing service (e.g., platform as a service (PaaS)), or other underlying software executed with instructions, program code, software elements, and the like.

The term “architecture” at least in some examples refers to a computer architecture or a network architecture. The term “computer architecture” at least in some examples refers to a physical and logical design or arrangement of software and/or hardware elements in a computing system or platform including technology standards for interacts therebetween. The term “network architecture” at least in some examples refers to a physical and logical design or arrangement of software and/or hardware elements in a network including communication protocols, interfaces, and media transmission.

The term “appliance,” “computer appliance,” and the like, at least in some examples refers to a computer device or computer system with program code (e.g., software or firmware) that is specifically designed to provide a specific computing resource. The term “gateway” at least in some examples refers to a network appliance that allows data to flow from one network to another network, or a computing system or application configured to perform such tasks. Examples of gateways include IP gateways, Internet-to-Orbit (12O) gateways, IoT gateways, cloud storage gateways, and/or the like.

The term “user equipment” or “UE” at least in some examples refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, station, mobile station, mobile user, subscriber, user, remote station, access agent, user agent, receiver, radio equipment, reconfigurable radio equipment, reconfigurable mobile device, and the like. Furthermore, the term “user equipment” or “UE” may include any type of wireless/wired device or any computing device including a wireless communications interface. Examples of UEs, client devices, and the like, include desktop computers, workstations, laptop computers, mobile data terminals, smartphones, tablet computers, wearable devices, machine-to-machine (M2M) devices, machine-type communication (MTC) devices, Internet of Things (IoT) devices, embedded systems, sensors, autonomous vehicles, drones, robots, in-vehicle infotainment systems, instrument clusters, onboard diagnostic devices, dashtop mobile equipment, electronic engine management systems, electronic/engine control units/modules, microcontrollers, control module, server devices, network appliances, head-up display (HUD) devices, helmet-mounted display devices, augmented reality (AR) devices, virtual reality (VR) devices, mixed reality (MR) devices, and/or other like systems or devices. The term “station” or “STA” at least in some examples refers to a logical entity that is a singly addressable instance of a medium access control (MAC) and physical layer (PHY) interface to the wireless medium (WM). The term “wireless medium” or WM″ at least in some examples refers to the medium used to implement the transfer of protocol data units (PDUs) between peer physical layer (PHY) entities of a wireless local area network (LAN). Additionally or alternatively, the term “end station” at least in some examples refers to a device attached to a local area network (LAN) or metropolitan area network (MAN) that acts as a source of, and/or destination for, traffic carried on the LAN or MAN.

The term “network element” at least in some examples refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, network access node (NAN), base station, access point (AP), RAN device, RAN node, gateway, server, network appliance, network function (NF), virtualized NF (VNF), and/or the like.

The term “network access node” or “NAN” at least in some examples refers to a network element in a radio access network (RAN) responsible for the transmission and reception of radio signals in one or more cells or coverage areas to or from a UE or station. A “network access node” or “NAN” can have an integrated antenna or may be connected to an antenna array by feeder cables. Additionally or alternatively, a “network access node” or “NAN” may include specialized digital signal processing, network function hardware, and/or compute hardware to operate as a compute node. In some examples, a “network access node” or “NAN” may be split into multiple functional blocks operating in software for flexibility, cost, and performance. In some examples, a “network access node” or “NAN” may be a base station (e.g., an evolved Node B (eNB) or a next generation Node B (gNB)), an access point and/or wireless network access point, router, switch, hub, radio unit or remote radio head, Transmission Reception Point (TRxP), a gateway device (e.g., Residential Gateway, Wireline 5G Access Network, Wireline 5G Cable Access Network, Wireline BBF Access Network, and the like), network appliance, and/or some other network access hardware. The term “access point” or “AP” at least in some examples refers to an entity that contains one station (STA) and provides access to the distribution services, via the wireless medium (WM) for associated STAs. An AP comprises a STA and a distribution system access function (DSAF).

The term “edge computing” encompasses many implementations of distributed computing that move processing activities and resources (e.g., compute, storage, acceleration, and/or network resources) towards the “edge” of the network. Example edge computing implementations can provide cloud-like services, functions, applications, and subsystems, from one or multiple locations accessible via wireless networks.

The term “colocated” or “co-located” at least in some examples refers to two or more elements being in the same place or location, or relatively close to one another (e.g., within some predetermined distance from one another). Additionally or alternatively, the term “colocated” or “co-located” at least in some examples refers to the placement or deployment of two or more compute elements or compute nodes together in a secure dedicated storage facility, or within a same enclosure or housing.

The term “cloud computing” or “cloud” at least in some examples refers to a paradigm for enabling network access to a scalable and elastic pool of shareable computing resources with self-service provisioning and administration on-demand and without active management by users. Cloud computing provides cloud computing services (or cloud services), which are one or more capabilities offered via cloud computing that are invoked using a defined interface (e.g., an API or the like).

The term “compute resource” or simply “resource” at least in some examples refers to any physical or virtual component, or usage of such components, of limited availability within a computer system or network. Examples of computing resources include usage/access to, for a period of time, servers, processor(s), storage equipment, memory devices, memory areas, networks, electrical power, input/output (peripheral) devices, mechanical devices, network connections (e.g., channels/links, ports, network sockets, and the like), operating systems, virtual machines (VMs), software/applications, computer files, and/or the like. A “hardware resource” at least in some examples refers to compute, storage, and/or network resources provided by physical hardware element(s). A “virtualized resource” at least in some examples refers to compute, storage, and/or network resources provided by virtualization infrastructure to an application, device, system, and the like. The term “network resource” or “communication resource” at least in some examples refers to resources that are accessible by computer devices/systems via a communications network. The term “system resources” at least in some examples refers to any kind of shared entities to provide services, and may include computing and/or network resources. System resources may be considered as a set of coherent functions, network data objects or services, accessible through a server where such system resources reside on a single host or multiple hosts and are clearly identifiable.

The term “network function” or “NF” at least in some examples refers to a functional block within a network infrastructure that has one or more external interfaces and a defined functional behavior. The term “network service” or “NS” at least in some examples refers to a composition of Network Function(s) and/or Network Service(s), defined by its functional and behavioral specification(s). The term “RAN function” or “RANF” at least in some examples refers to a functional block within a RAN architecture that has one or more external interfaces and a defined behavior related to the operation of a RAN or RAN node. Additionally or alternatively, the term “RAN function” or “RANF” at least in some examples refers to a set of functions and/or NFs that are part of a RAN. The term “Application Function” or “AF” at least in some examples refers to an element or entity that interacts with a 3GPP core network in order to provide services. Additionally or alternatively, the term “Application Function” or “AF” at least in some examples refers to an edge compute node or ECT framework from the perspective of a 5G core network. The term “edge compute function” or “ECF” at least in some examples refers to an element or entity that performs an aspect of an edge computing technology (ECT), an aspect of edge networking technology (ENT), or performs an aspect of one or more edge computing services running over the ECT or ENT. The term “management function” at least in some examples refers to a logical entity playing the roles of a service consumer and/or a service producer. The term “management service” at least in some examples refers to a set of offered management capabilities.

The term “service consumer” at least in some examples refers to an entity that consumes one or more services. The term “service producer” at least in some examples refers to an entity that offers, serves, or otherwise provides one or more services. The term “service provider” at least in some examples refers to an organization or entity that provides one or more services to at least one service consumer. For purposes of the present disclosure, the terms “service provider” and “service producer” may be used interchangeably even though these terms may refer to difference concepts. Examples of service providers include cloud service provider (CSP), network service provider (NSP), application service provider (ASP) (e.g., Application software service provider in a service-oriented architecture (ASSP)), internet service provider (ISP), telecommunications service provider (TSP), online service provider (OSP), payment service provider (PSP), managed service provider (MSP), storage service providers (SSPs), SAML service provider, and/or the like. At least in some examples, SLAs may specify, for example, particular aspects of the service to be provided including quality, availability, responsibilities, metrics by which service is measured, as well as remedies or penalties should agreed-on service levels not be achieved. The term “SAML service provider” at least in some examples refers to a system and/or entity that receives and accepts authentication assertions in conjunction with a single sign-on (SSO) profile of the Security Assertion Markup Language (SAML) and/or some other security mechanism(s).

The term “virtualization container”, “execution container”, or “container” at least in some examples refers to a partition of a compute node that provides an isolated virtualized computation environment. The term “OS container” at least in some examples refers to a virtualization container utilizing a shared Operating System (OS) kernel of its host, where the host providing the shared OS kernel can be a physical compute node or another virtualization container. Additionally or alternatively, the term “container” at least in some examples refers to a standard unit of software (or a package) including code and its relevant dependencies, and/or an abstraction at the application layer that packages code and dependencies together. Additionally or alternatively, the term “container” or “container image” at least in some examples refers to a lightweight, standalone, executable software package that includes everything needed to run an application such as, for example, code, runtime environment, system tools, system libraries, and settings.

The term “virtual machine” or “VM” at least in some examples refers to a virtualized computation environment that behaves in a same or similar manner as a physical computer and/or a server. The term “hypervisor” at least in some examples refers to a software element that partitions the underlying physical resources of a compute node, creates VMs, manages resources for VMs, and isolates individual VMs from each other.

The term “edge compute node” or “edge compute device” at least in some examples refers to an identifiable entity implementing an aspect of edge computing operations, whether part of a larger system, distributed collection of systems, or a standalone apparatus. In some examples, a compute node may be referred to as a “edge node”, “edge device”, “edge system”, whether in operation as a client, server, or intermediate entity. Additionally or alternatively, the term “edge compute node” at least in some examples refers to a physical, logical, and/or virtualized implementation of a compute-capable element in the form of a device, gateway, bridge, system or subsystem, component, and/or any other computing element whether operating in a server, client, endpoint, or peer mode, and whether located at an “edge” of an network or at a connected location further within the network.

The term “Internet of Things” or “IoT” at least in some examples refers to a system of interrelated computing devices, mechanical and digital machines capable of transferring data with little or no human interaction, and may involve technologies such as real-time analytics, machine learning and/or AI, embedded systems, wireless sensor networks, control systems, automation (e.g., smart home, smart building and/or smart city technologies), and the like. IoT devices are usually low-power devices without heavy compute or storage capabilities. The term “Edge IoT devices” at least in some examples refers to any kind of IoT devices deployed at a network's edge.

The term “protocol” at least in some examples refers to a predefined procedure or method of performing one or more operations. Additionally or alternatively, the term “protocol” at least in some examples refers to a common means for unrelated objects to communicate with each other (sometimes also called interfaces). The term “communication protocol” at least in some examples refers to a set of standardized rules or instructions implemented by a communication device and/or system to communicate with other devices and/or systems, including instructions for packetizing/depacketizing data, modulating/demodulating signals, implementation of protocols stacks, and/or the like. In various implementations, a “protocol” and/or a “communication protocol” may be represented using a protocol stack, a finite state machine (FSM), and/or any other suitable data structure. The term “standard protocol” at least in some examples refers to a protocol whose specification is published and known to the public and is controlled by a standards body. The term “protocol stack” or “network stack” at least in some examples refers to an implementation of a protocol suite or protocol family. In various implementations, a protocol stack includes a set of protocol layers, where the lowest protocol deals with low-level interaction with hardware and/or communications interfaces and each higher layer adds additional capabilities.

The term “application layer” at least in some examples refers to an abstraction layer that specifies shared communications protocols and interfaces used by hosts in a communications network. Additionally or alternatively, the term “application layer” at least in some examples refers to an abstraction layer that interacts with software applications that implement a communicating component, and may include identifying communication partners, determining resource availability, and synchronizing communication. Examples of application layer protocols include HTTP, HTTPs, File Transfer Protocol (FTP), Dynamic Host Configuration Protocol (DHCP), Internet Message Access Protocol (IMAP), Lightweight Directory Access Protocol (LDAP), MQTT (MQ Telemetry Transport), Remote Authentication Dial-In User Service (RADIUS), Diameter protocol, Extensible Authentication Protocol (EAP), RDMA over Converged Ethernet version 2 (RoCEv2), Real-time Transport Protocol (RTP), RTP Control Protocol (RTCP), Real Time Streaming Protocol (RTSP), SBMV Protocol, Skinny Client Control Protocol (SCCP), Session Initiation Protocol (SIP), Session Description Protocol (SDP), Simple Mail Transfer Protocol (SMTP), Simple Network Management Protocol (SNMP), Simple Service Discovery Protocol (SSDP), Small Computer System Interface (SCSI), Internet SCSI (iSCSI), iSCSI Extensions for RDMA (iSER), Transport Layer Security (TLS), voice over IP (VoIP), Virtual Private Network (VPN), Extensible Messaging and Presence Protocol (XMPP), and/or the like.

The term “session layer” at least in some examples refers to an abstraction layer that controls dialogues and/or connections between entities or elements, and may include establishing, managing and terminating the connections between the entities or elements.

The term “transport layer” at least in some examples refers to a protocol layer that provides end-to-end (e2e) communication services such as, for example, connection-oriented communication, reliability, flow control, and multiplexing. Examples of transport layer protocols include datagram congestion control protocol (DCCP), fibre channel protocol (FBC), Generic Routing Encapsulation (GRE), GPRS Tunneling (GTP), Micro Transport Protocol (μTP), Multipath TCP (MPTCP), MultiPath QUIC (MPQUIC), Multipath UDP (MPUDP), Quick UDP Internet Connections (QUIC), Remote Direct Memory Access (RDMA), Resource Reservation Protocol (RSVP), Stream Control Transmission Protocol (SCTP), transmission control protocol (TCP), user datagram protocol (UDP), and/or the like.

The term “network layer” at least in some examples refers to a protocol layer that includes means for transferring network packets from a source to a destination via one or more networks. Additionally or alternatively, the term “network layer” at least in some examples refers to a protocol layer that is responsible for packet forwarding and/or routing through intermediary nodes. Additionally or alternatively, the term “network layer” or “internet layer” at least in some examples refers to a protocol layer that includes interworking methods, protocols, and specifications that are used to transport network packets across a network. As examples, the network layer protocols include internet protocol (IP), IP security (IPsec), Internet Control Message Protocol (ICMP), Internet Group Management Protocol (IGMP), Open Shortest Path First protocol (OSPF), Routing Information Protocol (RIP), RDMA over Converged Ethernet version 2 (RoCEv2), Subnetwork Access Protocol (SNAP), and/or some other internet or network protocol layer.

The term “link layer” or “data link layer” at least in some examples refers to a protocol layer that transfers data between nodes on a network segment across a physical layer. Examples of link layer protocols include logical link control (LLC), medium access control (MAC), Ethernet, RDMA over Converged Ethernet version 1 (RoCEv1), and/or the like.

The term “medium access control protocol”, “MAC protocol”, or “MAC” at least in some examples refers to a protocol that governs access to the transmission medium in a network, to enable the exchange of data between stations in a network. Additionally or alternatively, the term “medium access control layer”, “MAC layer”, or “MAC” at least in some examples refers to a protocol layer or sublayer that performs functions to provide frame-based, connectionless-mode (e.g., datagram style) data transfer between stations or devices. Additionally or alternatively, the term “medium access control layer”, “MAC layer”, or “MAC” at least in some examples refers to a protocol layer or sublayer that performs mapping between logical channels and transport channels; multiplexing/demultiplexing of MAC SDUs belonging to one or different logical channels into/from transport blocks (TB) delivered to/from the physical layer on transport channels; scheduling information reporting; error correction through HARQ (one HARQ entity per cell in case of CA); priority handling between UEs by means of dynamic scheduling; priority handling between logical channels of one UE by means of logical channel prioritization; priority handling between overlapping resources of one UE; and/or padding (see e.g., [IEEE802], 3GPP TS 38.321 v17.2.0 (2022-10-01) and 3GPP TS 36.321 v17.2.0 (2022-10-03) (collectively referred to as “[TSMAC]”)).

The term “physical layer”, “PHY layer”, or “PHY” at least in some examples refers to a protocol layer or sublayer that includes capabilities to transmit and receive modulated signals for communicating in a communications network (see e.g., [IEEE802], 3GPP TS 38.201 v17.0.0 (2022-01-05) and 3GPP TS 36.201 v17.0.0 (2022-03-31)).

The term “radio technology” at least in some examples refers to technology for wireless transmission and/or reception of electromagnetic radiation for information transfer. The term “radio access technology” or “RAT” at least in some examples refers to the technology used for the underlying physical connection to a radio based communication network. The term “RAT type” at least in some examples may identify a transmission technology and/or communication protocol used in an access network, for example, new radio (NR), Long Term Evolution (LTE), narrowband IoT (NB-IOT), untrusted non-3GPP, trusted non-3GPP, trusted Institute of Electrical and Electronics Engineers (IEEE) 802 (e.g., [IEEE80211]; see also IEEE Standard for Local and Metropolitan Area Networks: Overview and Architecture, IEEE Std 802-2014, pp. 1-74 (30 Jun. 2014) (“[IEEE802] ”), the contents of which is hereby incorporated by reference in its entirety), non-3GPP access, MuLTEfire, WiMAX, wireline, wireline-cable, wireline broadband forum (wireline-BBF), and the like. Examples of RATs and/or wireless communications protocols include Advanced Mobile Phone System (AMPS) technologies such as Digital AMPS (D-AMPS), Total Access Communication System (TACS) (and variants thereof such as Extended TACS (ETACS), and the like); Global System for Mobile Communications (GSM) technologies such as Circuit Switched Data (CSD), High-Speed CSD (HSCSD), General Packet Radio Service (GPRS), and Enhanced Data Rates for GSM Evolution (EDGE); Third Generation Partnership Project (3GPP) technologies including, for example, Universal Mobile Telecommunications System (UMTS) (and variants thereof such as UMTS Terrestrial Radio Access (UTRA), Wideband Code Division Multiple Access (W-CDMA), Freedom of Multimedia Access (FOMA), Time Division-Code Division Multiple Access (TD-CDMA), Time Division-Synchronous Code Division Multiple Access (TD-SCDMA), and the like), Generic Access Network (GAN)/Unlicensed Mobile Access (UMA), High Speed Packet Access (HSPA) (and variants thereof such as HSPA Plus (HSPA+), and the like), Long Term Evolution (LTE) (and variants thereof such as LTE-Advanced (LTE-A), Evolved UTRA (E-UTRA), LTE Extra, LTE-A Pro, LTE LAA, MuLTEfire, and the like), Fifth Generation (5G) or New Radio (NR), and the like; ETSI technologies such as High Performance Radio Metropolitan Area Network (HiperMAN) and the like; IEEE technologies such as [IEEE802] and/or WiFi (e.g., [IEEE80211] and variants thereof), Worldwide Interoperability for Microwave Access (WiMAX) (e.g., [WiMAX] and variants thereof), Mobile Broadband Wireless Access (MBWA)/iBurst (e.g., IEEE 802.20 and variants thereof), and the like; Integrated Digital Enhanced Network (iDEN) (and variants thereof such as Wideband Integrated Digital Enhanced Network (WiDEN); millimeter wave (mmWave) technologies/standards (e.g., wireless systems operating at 10-300 GHz and above such as 3GPP 5G, Wireless Gigabit Alliance (WiGig) standards (e.g., IEEE 802.11ad, IEEE 802.11ay, and the like); short-range and/or wireless personal area network (WPAN) technologies/standards such as Bluetooth (and variants thereof such as Bluetooth 5.3, Bluetooth Low Energy (BLE), and the like), IEEE 802.15 technologies/standards (e.g., IEEE Standard for Low-Rate Wireless Networks, IEEE Standard for Low-Rate Wireless Networks, IEEE Std 802.15.4-2020, pp. 1-800 (23 Jul. 2020) (“[IEEE802154]”), ZigBee, Thread, IPv6 over Low power WPAN (6LoWPAN), WirelessHART, MiWi, ISA100.11a, IEEE Standard for Local and metropolitan area networks—Part 15.6: Wireless Body Area Networks, IEEE Std 802.15.6-2012, pp. 1-271 (29 Feb. 2012), WiFi-direct, ANT/ANT+, Z-Wave, 3GPP Proximity Services (ProSe), Universal Plug and Play (UPnP), low power Wide Area Networks (LPWANs), Long Range Wide Area Network (LoRA or LoRaWAN™), and the like; optical and/or visible light communication (VLC) technologies/standards such as IEEE Standard for Local and metropolitan area networks—Part 15.7: Short-Range Optical Wireless Communications, IEEE Std 802.15.7-2018, pp. 1-407 (23 Apr. 2019), and the like; V2X communication including 3GPP cellular V2X (C-V2X), Wireless Access in Vehicular Environments (WAVE) (IEEE Standard for Information technology—Local and metropolitan area networks—Specific requirements—Part 11: Wireless LAN Medium Access Control (MAC) and Physical Layer (PHY) Specifications Amendment 6: Wireless Access in Vehicular Environments, IEEE Std 802.11p-2010, pp. 1-51 (15 Jul. 2010) (“[IEEE80211p]”), which is now part of [IEEE80211]), IEEE 802.11bd (e.g., for vehicular ad-hoc environments), Dedicated Short Range Communications (DSRC), Intelligent-Transport-Systems (ITS) (including the European ITS-G5, ITS-GSB, ITS-GSC, and the like); Sigfox; Mobitex; 3GPP2 technologies such as cdmaOne (2G), Code Division Multiple Access 2000 (CDMA 2000), and Evolution-Data Optimized or Evolution-Data Only (EV-DO); Push-to-talk (PTT), Mobile Telephone System (MTS) (and variants thereof such as Improved MTS (IMTS), Advanced MTS (AMTS), and the like); Personal Digital Cellular (PDC); Personal Handy-phone System (PHS), Cellular Digital Packet Data (CDPD); Cellular Digital Packet Data (CDPD); DataTAC; Digital Enhanced Cordless Telecommunications (DECT) (and variants thereof such as DECT Ultra Low Energy (DECT ULE), DECT-2020, DECT-5G, and the like); Ultra High Frequency (UHF) communication; Very High Frequency (VHF) communication; and/or any other suitable RAT or protocol. In addition to the aforementioned RATs/standards, any number of satellite uplink technologies may be used for purposes of the present disclosure including, for example, radios compliant with standards issued by the International Telecommunication Union (ITU), or the ETSI, among others. The examples provided herein are thus understood as being applicable to various other communication technologies, both existing and not yet formulated.

The term “channel” at least in some examples refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” at least in some examples refers to a connection between two devices through a RAT for the purpose of transmitting and receiving information.

The term “local area network” or “LAN” at least in some examples refers to a network of devices, whether indoors or outdoors, covering a limited area or a relatively small geographic area (e.g., within a building or a campus). The term “wireless local area network”, “wireless LAN”, or “WLAN” at least in some examples refers to a LAN that involves wireless communications. The term “wide area network” or “WAN” at least in some examples refers to a network of devices that extends over a relatively large geographic area (e.g., a telecommunications network). Additionally or alternatively, the term “wide area network” or “WAN” at least in some examples refers to a computer network spanning regions, countries, or even an entire planet. The term “backbone network”, “backbone”, or “core network” at least in some examples refers to a computer network which interconnects networks, providing a path for the exchange of information between different subnetworks such as LANs or WANs. The term “virtual local area network” or “VLAN” at least in some examples refers to a LAN that is partitioned and/or isolated in a computer network. Additionally or alternatively, the term “virtual local area network” or “VLAN” at least in some examples refers to closure of a set of MAC service access points (MSAPs) such that a data request in one MSAP in the set is expected to result in a data indication in another MSAP in the set. The term “interworking” at least in some examples refers to the use of interconnected stations in a network for the exchange of data, by means of protocols operating over one or more underlying data transmission paths.

The term “service” at least in some examples refers to the provision of a discrete function within a system and/or environment. Additionally or alternatively, the term “service” at least in some examples refers to a functionality or a set of functionalities that can be reused. The term “microservice” at least in some examples refers to one or more processes that communicate over a network to fulfill a goal using technology-agnostic protocols (e.g., HTTP or the like).

Additionally or alternatively, the term “microservice” at least in some examples refers to services that are relatively small in size, messaging-enabled, bounded by contexts, autonomously developed, independently deployable, decentralized, and/or built and released with automated processes. Additionally or alternatively, the term “microservice” at least in some examples refers to a self-contained piece of functionality with clear interfaces, and may implement a layered architecture through its own internal components. Additionally or alternatively, the term “microservice architecture” at least in some examples refers to a variant of the service-oriented architecture (SOA) structural style wherein applications are arranged as a collection of loosely-coupled services (e.g., fine-grained services) and may use lightweight protocols. The term “network service” at least in some examples refers to a composition of Network Function(s) and/or Network Service(s), defined by its functional and behavioural specification.

The term “quality” at least in some examples refers to a property, character, attribute, or feature of something as being affirmative or negative, and/or a degree of excellence of something. Additionally or alternatively, the term “quality” at least in some examples, in the context of data processing, refers to a state of qualitative and/or quantitative aspects of data, processes, and/or some other aspects of data processing systems. The term “Quality of Service” or “QoS' at least in some examples refers to a description or measurement of the overall performance of a service. In some cases, the QoS may be described or measured from the perspective of the users of that service, and as such, QoS may be the collective effect of service performance that determine the degree of satisfaction of a user of that service. In other cases, QoS at least in some examples refers to traffic prioritization and resource reservation control mechanisms rather than the achieved perception of service quality. In these cases, QoS is the ability to provide different priorities to different applications, users, or flows, or to guarantee a certain level of performance to a flow. In either case, QoS is characterized by the combined aspects of performance factors applicable to one or more services such as, for example, service operability performance, service accessibility performance; service retain ability performance; service reliability performance, service integrity performance, and other factors specific to each service. Several related aspects of the service may be considered when quantifying the QoS, including packet loss rates, bit rates, throughput, transmission delay, availability, reliability, jitter, signal strength and/or quality measurements, and/or other measurements such as those discussed herein. Additionally or alternatively, the term “Quality of Service” or “QoS' at least in some examples refers to mechanisms that provide traffic-forwarding treatment based on flow-specific traffic classification. In some examples, Additionally or alternatively, the term “Quality of Service” or “QoS' at least in some examples is based on the definitions provided by SERIES E: OVERALL NETWORK OPERATION, TELEPHONE SERVICE, SERVICE OPERATION AND HUMAN FACTORS Quality of telecommunication services: concepts, models, objectives and dependability planning Terms and definitions related to the quality of telecommunication services, Definitions of terms related to quality of service, ITU-T Recommendation E.800 (September 2008) (“[ITUE800]”), the contents of which is hereby incorporated by reference in its entirety. The term “Class of Service” or “CoS” at least in some examples refers to mechanisms that provide traffic-forwarding treatment based on non-flow-specific traffic classification. In some implementations, the term “Quality of Service” or “QoS” can be used interchangeably with the term “Class of Service” or “CoS”.

The term “clock” at least in some examples refers to a physical device that is capable of providing a measurement of the passage of time since a defined epoch. The term “local clock” at least in some examples refers to a free-running clock, embedded in a respective entity (e.g., PTP instance, CSN node, and/or the like), that provides a common time to that entity relative to an arbitrary epoch. The term “recognized timing standard” at least in some examples refers to recognized standard time source that is a source external to [IEEE1588] precision time protocol (PTP) and provides time that is traceable to the international standards laboratories maintaining clocks that form the basis for the International Atomic Time (TAI) and Coordinated Universal Time (UTC) timescales. Examples of these sources are National Institute of Standards and Technology (NIST) timeservers and global navigation satellite systems (GNSSs).

The term “stability” in the context of a clock or clock signal, at least in some examples refers to a measure of the variations over time of the frequency error (of the clock or clock signal). The frequency error typically varies with time due to aging and various environmental effects, e.g., temperature. The term “synchronized time” at least in some examples refers to the time of an event relative to the Grandmaster Clock. If there is a change in the Grandmaster PTP instance or its time base, the synchronized time can experience a phase and/or frequency step. The term “synchronized clocks” at least in some examples refers to, absent relativistic effects, two clocks are synchronized to a specified uncertainty if they have the same epoch and their measurements of the time of a single event at an arbitrary time differ by no more than that uncertainty. The term “syntonized clocks” at least in some examples refers to, absent relativistic effects, two clocks are syntonized to a specified uncertainty if the duration of a second is the same on both, which means the time as measured by each advances at the same rate within the specified uncertainty (in some examples, the two clocks might or might not share the same epoch).

The term “time-aware” at least in some examples describes the use of time that is synchronized with other stations using a protocol (see e.g., [IEEE802.1AS]). The term “time-aware system” at least in some examples refers to a device that contains one or more PTP instances and/or PTP services (e.g., Common Mean Link Delay Service). In some implementations, a time-aware system can contain more than one PTP instance in the same domain and/or different domains. The term “time-sensitive stream” at least in some examples refers to a stream of traffic, transmitted from a single source station, destined for one or more destination stations, where the traffic is sensitive to timely delivery. Additionally or alternatively, the term “time-sensitive stream” at least in some examples refers to a stream of data frames that are required to be delivered within a bounded latency.

The term “Ethernet” at least in some examples refers to a term that is used to refer either to the IEEE 802.3 media access method or to the frame format discussed in IEEE Standard for Ethernet, IEEE Std 802.3-2018 (31 Aug. 2018) (“[IEEE802.3]”), the contents of which are hereby incorporated by reference in its entirety. The term “Ethernet frame” or simply “frame” at least in some examples refers to a format of aggregated bits from a medium access control (MAC) sublayer entity that are transmitted together in time. Additionally or alternatively, the term “frame” at least in some examples refers to a unit of data transmission on an IEEE 802 Local Area Network (LAN) that conveys a MAC Protocol Data Unit (MPDU). The term “basic frame” at least in some examples refers to a MAC frame that carries a Length/Type field with the Length or Type interpretation and has a maximum length of 1518 octets; in some examples, a basic frame is not intended to allow inclusion of additional tags or encapsulations required by higher layer protocols (see e.g., [IEEE802.3], clause 3.2.7). The term “envelope frame” at least in some examples refers to a MAC frame that carries a length/type field with the type interpretation that may indicate additional encapsulation information within the MAC client data and has a maximum length of 2000 octets; at least in some examples, an envelope frame is allows additional prefixes and suffixes to be included as required by higher layer encapsulation protocols, where the encapsulation protocols may use up to 482 octets (see e.g., [IEEE802.3], clause 3.2.7). The term “MAC frame” at least in some examples refers to a frame including a destination address, a source address, a length/type field, MAC client data, and a frame check sequence (FCS); in some examples, a MAC frame also includes padding bits/bytes. The term “MAC frame” at least in some examples can also be referred to as a “data frame” or the like.

The term “tagged frame” at least in some examples refers to a frame that contains a tag header immediately following the source (MAC) address field of a frame. The term “virtual local area network tagged frame” or “VLAN tagged frame” at least in some examples refers to a tagged frame whose tag header carries both VLAN identification (e.g., VLAN ID (VID)) and priority information. The term “backbone VLAN tag”, “B-VLAN tag”, or “B-TAG” at least in some to examples refers to a service VLAN tag (S-TAG) used in conjunction with backbone MAC (B-MAC) addresses. The term “backbone service instance tag” or “I-TAG” at least in some examples refers to a tag with an EtherType value allocated for an “IEEE 802.1Q Backbone Service Instance Tag EtherType.” The term “congestion notification tag” or “CN-TAG” at least in some examples refers to a tag that conveys a flow identifier (ID) that a reaction point (RP) can add to transmitted congestion controlled flow (CCF) frames, and that a congestion point (CP) includes in a congestion notification message (CNM). The term “customer VLAN tag”, “C-VLAN tag”, or “C-TAG” at least in some examples refers to VLAN tag with a tag protocol identification value allocated for an “802.1Q Tag Protocol EtherType.” The term “flow filtering tag” or “F-TAG” at least in some examples refers to a tag with a tag protocol identification value allocated for an “IEEE 802.1Q Flow Filtering Tag EtherType.” The term “service VLAN tag”, “S-VLAN tag”, or “S-TAG” at least in some examples refers to a VLAN tag with a tag protocol identification value allocated for an “802.1Q Service Tag EtherType.” The term “tag header” at least in some examples refers to a header that allows priority information, and optionally, VLAN identification information, to be associated with a frame.

The term “carrier extension” at least in some examples refers to one or more additional non-data symbols added to the end of a frame that is/are less than slotTime bits in length so that the resulting transmission is at least one slotTime in duration.

The term “code-group” or “code group” at least in some examples refers to a set of encoded symbols representing encoded data or control information (see e.g., [IEEE802.3], clauses 23, 24, 32, 36, 40, and 96).

The term “end of packet delimiter”, “End of Packet Delimiter”, or “EPD” at least in some examples refers to a defined sequence of three single code-group 8B/10B ordered sets used to delineate the ending boundary of a data transmission sequence for a single packet (see e.g., [IEEE802.3], clause 36). The term “end of stream delimiter”, “End-of-Stream Delimiter”, or “ESD” at least in some examples refers to a code-group pattern used to terminate a normal data transmission; in some examples, an ESD is generated using unique Start-of-Stream Delimiter (SSD)/ESD coding rules (see e.g., [IEEE802.3], clauses 22, 23, 32, 40, and 96).

The term “Ethertype” at least in some examples refers to a 2 octet value that indicates the nature of the MAC client protocol. The term “inter-packet gap” or “IPG” at least in some examples refers to a delay or time gap between Ethernet packets intended to provide inter-frame recovery time for other Ethernet sublayers and for the Physical Medium (see e.g., [IEEE802.3], clauses 4.2.3.2.1 and 4.2.3.2.2).

The term “traffic class” at least in some examples refers to a classification used to expedite transmission of frames generated by critical or time-sensitive services. At least in some examples, traffic classes are numbered from zero through N-1, where N is the number of outbound queues associated with a given bridge port, and 1≤N≤8, and each traffic class has a one-to-one correspondence with a specific outbound queue for that port, wherein traffic class 0 corresponds to non-expedited traffic and non-zero traffic classes correspond to expedited classes of traffic. At least in some examples, a fixed mapping determines, for a given priority associated with a frame and a given number of traffic classes, what traffic class will be assigned to the frame.

The term “queue” at least in some examples refers to a collection of entities (e.g., data, objects, events, and the like) are stored and held to be processed later. that are maintained in a sequence and can be modified by the addition of entities at one end of the sequence and the removal of entities from the other end of the sequence; the end of the sequence at which elements are added may be referred to as the “back”, “tail”, or “rear” of the queue, and the end at which elements are removed may be referred to as the “head” or “front” of the queue. Additionally, a queue may perform the function of a buffer, and the terms “queue” and “buffer” may be used interchangeably throughout the present disclosure. The term “enqueue” at least in some examples refers to one or more operations of adding an element to the rear of a queue. The term “dequeue” at least in some examples refers to one or more operations of removing an element from the front of a queue.

The term “queue management” at least in some examples refers to a system, mechanism, policy, process, algorithm, or technique used to control one or more queues. The term “Active Queue Management” or “AQM” at least in some examples refers to a system, mechanism, policy, process, algorithm, or technique of dropping packets in a queue or buffer before the queue or buffer becomes full. The term “AQM entity” as used herein may refer to a network scheduler, a convergence layer entity, a network appliance, network function, and/or some other like entity that performs/executes AQM tasks. The term “queue management technique” at least in some examples refers to a particular queue management system, mechanism, policy, process, and/or algorithm, which may include a “drop policy”. The term “active queue management technique” or “AQM technique” at least in some examples refers to a particular AQM system, mechanism, policy, process, and/or algorithm. Examples of queue management and/or AQM algorithms/techniques include random early detection (RED), adaptive RED (ARED), robust RED (RRED), stabilized RED (SRED), explicit congestion notification (ECN), controlled delay (CoDel), Packet First in First Out (PFIFO), Blue, Stochastic Fair Blue (SFB), Resilient SFB (RSFB), Random Exponential Marking (REM), modified REM (M-REM), RED with Preferential Dropping (RED-PD), Common Applications Kept Enhanced (CAKE), smart queue management (SQM) (e.g., combination of AQM, QoS, and/or other techniques), Proportional Rate-based Control (PRC), proportional integral (PI) controller, and/or the like.

The term “drop policy” at least in some examples refers to a set of guidelines or rules used by a queue management/AQM technique to determine when to discard, remove, delete, or otherwise drop data or packets from a queue, buffer, cache, or other like data structure or device, or data or packets arriving for storage in a queue, buffer, cache, and/or other like data structure or device. The term “cache replacement algorithm”, “cache replacement policy”, “cache eviction algorithm”, “cache algorithm”, or “caching algorithm” at least in some examples refers to an optimization instructions or algorithms used by a caching system to manage cached data stored by the caching system. Examples of cache algorithms include Bélády's algorithm, random replacement (RR), first-in first-out (FIFO), last-in first-out (LIFO), first-in last-out (FILO), least recently used (LRU), time-aware LRU (TLRU), pseudo-LRU (PLRU), most recently used (MRU), least frequently used (LFU), LFU with dynamic aging (LFUDA), least frequent recently used (LFRU), re-reference interval prediction (RRIP), low inter-reference recency set (LIRS), adaptive replacement cache (ARC), Markov chain-based cache replacement, multi-queue algorithm (MQ), and/or the like. For purposes of the present disclosure, the aforementioned example cache replacement algorithms, as well as those not listed, can be used as queue management/AQM techniques.

The term “stack” at least in some examples refers to an abstract data type that serves as a collection of elements and may include a push operation or function, a pop operation or function, and sometimes a peek operation or function. The term “push”, in the context of data structures such as stacks, buffers, and queues, at least in some examples refers an operation or function that adds one or more elements to a collection or set of elements. The term “pop”, in the context of data structures such as stacks, buffers, and queues, at least in some examples refers an operation or function that removes or otherwise obtains one or more elements from a collection or set of elements. The term “peek”, in the context of data structures such as stacks, buffers, and queues, at least in some examples refers an operation or function that provides access to one or more elements from a collection or set of elements.

The term “data buffer” or “buffer” at least in some examples refers to a region of a physical or virtual memory used to temporarily store data, for example, when data is being moved from one storage location or memory space to another storage location or memory space, data being moved between processes within a computer, allowing for timing corrections made to a data stream, reordering received data packets, delaying the transmission of data packets, and the like. At least in some examples, a “data buffer” or “buffer” may implement a queue. The term “circular buffer”, “circular queue”, “cyclic buffer”, or “ring buffer” at least in some examples refers to a data structure that uses a single fixed-size buffer or other area of memory as if it were connected end-to-end or as if it has a circular or elliptical shape.

The term “channel coding” at least in some examples refers to processes and/or techniques to add redundancy to messages or packets in order to make those messages or packets more robust against noise, channel interference, limited channel bandwidth, and/or other errors. For purposes of the present disclosure, the term “channel coding” can be used interchangeably with the terms “forward error correction” or “FEC”; “error correction coding”, “error correction code”, or “ECC”; and/or “network coding” or “NC”. The term “network coding” at least in some examples refers to processes and/or techniques in which transmitted data is encoded and decoded to improve network performance. The term “code rate” at least in some examples refers to the proportion of a data stream or flow that is useful or non-redundant (e.g., for a code rate of k/n, for every k bits of useful information, the (en)coder generates a total of n bits of data, of which n−k are redundant). The term “systematic code” at least in some examples refers to any error correction code in which the input data is embedded in the encoded output. The term “non-systematic code” at least in some examples refers to any error correction code in which the input data is not embedded in the encoded output. The term “interleaving” at least in some examples refers to a process to rearrange code symbols so as to spread bursts of errors over multiple codewords that can be corrected by ECCs.

The term “code word” or “codeword” at least in some examples refers to an element of a code or protocol, which is assembled in accordance with specific rules of the code or protocol.

The term “traffic shaping” at least in some examples refers to a bandwidth management technique that manages data transmission to comply with a desired traffic profile or class of service. Traffic shaping ensures sufficient network bandwidth for time-sensitive, critical applications using policy rules, data classification, queuing, QoS, and other techniques. The term “throttling” at least in some examples refers to the regulation of flows into or out of a network, or into or out of a specific device or element. The term “access traffic steering” or “traffic steering” at least in some examples refers to a procedure that selects an access network for a new data flow and transfers the traffic of one or more data flows over the selected access network. Access traffic steering is applicable between one 3GPP access and one non-3GPP access. The term “access traffic switching” or “traffic switching” at least in some examples refers to a procedure that moves some or all traffic of an ongoing data flow from at least one access network to at least one other access network in a way that maintains the continuity of the data flow. The term “access traffic splitting” or “traffic splitting” at least in some examples refers to a procedure that splits the traffic of at least one data flow across multiple access networks. When traffic splitting is applied to a data flow, some traffic of the data flow is transferred via at least one access channel, link, or path, and some other traffic of the same data flow is transferred via another access channel, link, or path.

The term “network address” at least in some examples refers to an identifier for a node or host in a computer network, and may be a unique identifier across a network and/or may be unique to a locally administered portion of the network. Examples of identifiers and/or network addresses include a Closed Access Group Identifier (CAG-ID), Bluetooth hardware device address (BD_ADDR), a cellular network address (e.g., Access Point Name (APN), AMF identifier (ID), AF-Service-Identifier, Edge Application Server (EAS) ID, Data Network Access Identifier (DNAI), Data Network Name (DNN), EPS Bearer Identity (EBI), Equipment Identity Register (EIR) and/or 5G-EIR, Extended Unique Identifier (EUI), Group ID for Network Selection (GIN), Generic Public Subscription Identifier (GPSI), Globally Unique AMF Identifier (GUAMI), Globally Unique Temporary Identifier (GUTI) and/or 5G-GUTI, Radio Network Temporary Identifier (RNTI) (including any RNTI discussed in clause 8.1 of 3GPP TS 38.300 v17.2.0 (2022-09-29) (“[TS38300]”), International Mobile Equipment Identity (IMEI), IMEI Type Allocation Code (IMEA/TAC), International Mobile Subscriber Identity (IMSI), IMSI software version (IMSISV), permanent equipment identifier (PEI), Local Area Data Network (LADN) DNN, Mobile Subscriber Identification Number (MSIN), Mobile Subscriber/Station ISDN Number (MSISDN), Network identifier (NID), Network Slice Instance (NSI) ID, Permanent Equipment Identifier (PEI), Public Land Mobile Network (PLMN) ID, QoS Flow ID (QFI) and/or 5G QoS Identifier (5QI), RAN ID, Routing Indicator, SMS Function (SMSF) ID, Stand-alone Non-Public Network (SNPN) ID, Subscription Concealed Identifier (SUCI), Subscription Permanent Identifier (SUPI), Temporary Mobile Subscriber Identity (TMSI) and variants thereof, UE Access Category and Identity, and/or other cellular network related identifiers), an email address, Enterprise Application Server (EAS) ID, an endpoint address, an Electronic Product Code (EPC) as defined by the EPCglobal Tag Data Standard, a Fully Qualified Domain Name (FQDN), an internet protocol (IP) address in an IP network (e.g., IP version 4 (IPv4), IP version 6 (IPv6), and the like), an internet packet exchange (IPX) address, Local Area Network (LAN) ID, a media access control (MAC) address, personal area network (PAN) ID, a port number (e.g., Transmission Control Protocol (TCP) port number, User Datagram Protocol (UDP) port number), QUIC connection ID, RFID tag, service set identifier (SSID) and variants thereof, telephone numbers in a public switched telephone network (PTSN), a socket address, universally unique identifier (UUID) (e.g., as specified in ISO/IEC 11578:1996), a Universal Resource Locator (URL) and/or Universal Resource Identifier (URI), Virtual LAN (VLAN) ID, an X.21 address, an X.25 address, Zigbee® ID, Zigbee® Device Network ID, and/or any other suitable network address and components thereof. The term “universally unique identifier” or “UUID” at least in some examples refers to a number used to identify information in computer systems. In some examples, a UUID includes 128-bit numbers and/or are represented as 32 hexadecimal digits displayed in five groups separated by hyphens in the following format: “xxxxxxxx-xxxx-Mxxx-Nxxx-xxxxxxxxxxxx” where the four-bit M and the 1 to 3 bit N fields code the format of the UUID itself. Additionally or alternatively, the term “universally unique identifier” or “UUID” at least in some examples refers to a “globally unique identifier” and/or a “GUID”. The term “endpoint address” at least in some examples refers to an address used to determine the host/authority part of a target URI, where the target URI is used to access an NF service (e.g., to invoke service operations) of an NF service producer or for notifications to an NF service consumer. The term “port” in the context of computer networks, at least in some examples refers to a communication endpoint, a virtual data connection between two or more entities, and/or a virtual point where network connections start and end. Additionally or alternatively, a “port” at least in some examples is associated with a specific process or service.

The term “physical rate” or “PHY rate” at least in some examples refers to a speed at which one or more bits are actually sent over a transmission medium. Additionally or alternatively, the term “physical rate” or “PHY rate” at least in some examples refers to a speed at which data can move across a wireless link between a transmitter and a receiver.

The term “delay” at least in some examples refers to a time interval between two events. Additionally or alternatively, the term “delay” at least in some examples refers to a time interval between the propagation of a signal and its reception. The term “packet delay” at least in some examples refers to the time it takes to transfer any packet from one point to another. Additionally or alternatively, the term “packet delay” or “per packet delay” at least in some examples refers to the difference between a packet reception time and packet transmission time. Additionally or alternatively, the “packet delay” or “per packet delay” can be measured by subtracting the packet sending time from the packet receiving time where the transmitter and receiver are at least somewhat synchronized. The term “processing delay” at least in some examples refers to an amount of time taken to process a packet in a network node. The term “transmission delay” at least in some examples refers to an amount of time needed (or necessary) to push a packet (or all bits of a packet) into a transmission medium. The term “propagation delay” at least in some examples refers to amount of time it takes a signal's header to travel from a sender to a receiver. The term “network delay” at least in some examples refers to the delay of an a data unit within a network (e.g., an IP packet within an IP network). The term “queuing delay” at least in some examples refers to an amount of time a job waits in a queue until that job can be executed. Additionally or alternatively, the term “queuing delay” at least in some examples refers to an amount of time a packet waits in a queue until it can be processed and/or transmitted. The term “delay bound” at least in some examples refers to a predetermined or configured amount of acceptable delay. The term “per-packet delay bound” at least in some examples refers to a predetermined or configured amount of acceptable packet delay where packets that are not processed and/or transmitted within the delay bound are considered to be delivery failures and are discarded or dropped.

The term “packet drop rate” at least in some examples refers to a share of packets that were not sent to the target due to high traffic load or traffic management and should be seen as a part of the packet loss rate. The term “packet loss rate” at least in some examples refers to a share of packets that could not be received by the target, including packets dropped, packets lost in transmission and packets received in wrong format.

The term “latency” at least in some examples refers to the amount of time it takes to transfer a first/initial data unit in a data burst from one point to another. Additionally or alternatively, the term “latency” at least in some examples refers to the delay experienced by a data unit (e.g., frame) in the course of its propagation between two points in a network, measured from the time that a known reference point in the frame passes the first point to the time that the reference point in the data unit passes the second point

The term “jitter” at least in some examples refers to a deviation from a predefined (“true”) periodicity of a presumably periodic signal in relation to a reference clock signal. Additionally or alternatively, the term “jitter” at least in some examples refers to variations of signal transitions from their ideal positions in time. In some examples, “jitter may be characterized by its spectral properties and its distribution in time.

The term “throughput” or “network throughput” at least in some examples refers to a rate of production or the rate at which something is processed. Additionally or alternatively, the term “throughput” or “network throughput” at least in some examples refers to a rate of successful message (date) delivery over a communication channel. The term “goodput” at least in some examples refers to a number of useful information bits delivered by the network to a certain destination per unit of time. The term “performance indicator” at least in some examples refers to performance data aggregated over a group of network functions (NFs), which is derived from performance measurements collected at the NFs that belong to the group, according to the aggregation method identified in a Performance Indicator definition.

The term “application” at least in some examples refers to a computer program designed to carry out a specific task other than one relating to the operation of the computer itself. Additionally or alternatively, term “application” at least in some examples refers to a complete and deployable package, environment to achieve a certain function in an operational environment.

The term “process” at least in some examples refers to an instance of a computer program that is being executed by one or more threads. In some implementations, a process may be made up of multiple threads of execution that execute instructions concurrently. The term “thread of execution” or “thread” at least in some examples refers to the smallest sequence of programmed instructions that can be managed independently by a scheduler.

The term “exception” at least in some examples refers to an event that can cause a currently executing program to be suspended. Additionally or alternatively, the term “exception” at least in some examples refers to an exception is an event that typically occurs when an instruction causes an error. Additionally or alternatively, the term “exception” at least in some examples refers to an event or a set of circumstances for which executing code will terminate normal operation. The term “exception” at least in some examples can also be referred to as an “interrupt.” The term “interrupt” at least in some examples refers to a signal or request to interrupt currently executing code (when permitted) so that events can be processed in a timely manner. If the interrupt is accepted, the processor will suspend its current activities, save its state, and execute an interrupt handler (or an interrupt service routine (ISR)) to deal with the event. The term “masking an interrupt” or “masked interrupt” at least in some examples refers to disabling an interrupt, and the term “unmasking an interrupt” or “unmasked interrupt” at least in some examples refers to enabling an interrupt. In some implementations, a processor may have an internal interrupt mask register to enable or disable specified interrupts.

The term “spinlock” or “spin lock” at least in some examples refers to a lock that causes a thread trying to acquire it to wait in a loop (e.g., a “spin”) while repeatedly checking whether the lock is available; in some examples, the use of such a lock can be considered a type of busy waiting since the thread remains active but is not performing a useful task. The term “lock” or “mutex” at least in some examples refers to a synchronization primitive and/or a mechanism that enforces limits on access to a resource when there are many threads of execution.

The term “algorithm” at least in some examples refers to an unambiguous specification of how to solve a problem or a class of problems by performing calculations, input/output operations, data processing, automated reasoning tasks, and/or the like. The term “analytics” at least in some examples refers to the discovery, interpretation, and communication of meaningful patterns in data.

The term “application programming interface” or “API” at least in some examples refers to a set of subroutine definitions, communication protocols, and tools for building software. Additionally or alternatively, the term “application programming interface” or “API” at least in some examples refers to a set of clearly defined methods of communication among various components. In some examples, an API may be defined or otherwise used for a web-based system, to operating system, database system, computer hardware, software library, and/or the like.

The term “data processing” or “processing” at least in some examples refers to any operation or set of operations which is performed on data or on sets of data, whether or not by automated means, such as collection, recording, writing, organization, structuring, storing, adaptation, alteration, retrieval, consultation, use, disclosure by transmission, dissemination or otherwise making available, alignment or combination, restriction, erasure and/or destruction. The term “data pipeline” or “pipeline” at least in some examples refers to a set of data processing elements (or data processors) connected in series and/or in parallel, where the output of one data processing element is the input of one or more other data processing elements in the pipeline; the elements of a pipeline may be executed in parallel or in time-sliced fashion and/or some amount of buffer storage can be inserted between elements.

The terms “instantiate,” “instantiation,” and the like at least in some examples refers to the creation of an instance. An “instance” also at least in some examples refers to a concrete occurrence of an object, which may occur, for example, during execution of program code.

The term “packet processor” at least in some examples refers to software and/or hardware element(s) that transform a stream of input packets into output packets (or transforms a stream of input data into output data); examples of the transformations include adding, removing, and modifying fields in a packet header, trailer, and/or payload.

The term “software agent” at least in some examples refers to a computer program that acts for a user or other program in a relationship of agency.

The term “use case” at least in some examples refers to a description of a system from a user's perspective. Use cases sometimes treat a system as a black box, and the interactions with the system, including system responses, are perceived as from outside the system. Use cases typically avoid technical jargon, preferring instead the language of the end user or domain expert. The term “user” at least in some examples refers to an abstract representation of any entity issuing commands, requests, and/or data to a compute node or system, and/or otherwise consumes or uses services.

The term “memory address” at least in some examples refers to a reference to a specific memory location, which can be represented as a sequence of digits and/or characters. The term “physical address” at least in some examples refers to a memory location, which may be a particular memory cell or block in main memory and/or primary storage device(s), or a particular register in a memory-mapped I/O device. The term “memory location” at least in some examples refers to a unit of storage space in memory that is identified by a memory address (e.g., a starting address) and a size or length. In some examples, a “memory location” has a physical address expressed as a code, which is used by a processor or other computing element to access the memory location. The term “physical address” at least in some examples refers to a memory address that is used to access a particular storage/memory cell of a memory device (e.g., a main memory) and/or a register of a memory device (e.g., a memory-mapped I/O device); in some examples, a “physical address” is represented in the form of a binary number, and a “physical address” may be referred to as a “binary address” or a “real address”. The term “logical address” or “virtual address” at least in some examples refers to an address at which an item (e.g., a memory cell, storage element, network host, and/or the like) appears to reside from the perspective of an access agent or requestor. For purposes of the present disclosure, the term “memory address” refers to a physical address, a logical address, and/or a virtual address unless the context dictates otherwise.

The term “address space” at least in some examples refers to a range of discrete addresses, where each address in the address space corresponds to a network host, peripheral device, disk sector, a memory cell, and/or other logical or physical entity. The term “virtual address space” or “VAS” at least in some examples refers to the set of ranges of virtual addresses that are made available to an application, process, service, operating system, device, system, or other entity.

The term “virtual memory” or “virtual storage” at least in some examples refers to a memory management technique that provides an abstraction of memory/storage resources that are actually available on a given machine, which creates the illusion to users of a very large (main) memory. Additionally or alternatively, the “virtual memory” or “virtual storage” at least in some examples refers to an address mapping between applications and hardware memory.

The term “pointer” at least in some examples refers to an object that stores a memory address. This can be that of another value located in computer memory, or in some cases, that of memory-mapped computer hardware. In some examples, a pointer references a location in memory, and obtaining the value stored at that location is known as dereferencing the pointer.

The term “descriptor” at least in some examples refers to an element, entity, or structure that contains or includes information that describes data. Additionally or alternatively, the term “descriptor” at least in some examples refers to an element, entity, or structure that describes memory blocks representing data or code. Additionally or alternatively, the term “descriptor” at least in some examples refers to an element, entity, or structure that contains some or all information related to an address space or a memory location.

The term “cycles per instruction” or “CPI” at least in some examples refers to the number of clock cycles required to execute an average instruction. In some examples, the “cycles per instruction” or “CPI” is the reciprocal or the multiplicative inverse of the throughput or instructions per cycle (IPC). The term “instructions per cycle” or “IPC” at least in some examples refers to the average number of instructions executed during a clock cycle, such as the clock cycle of a processor or controller. In some examples, the “instructions per cycle” or “IPC” is the reciprocal or the multiplicative inverse of the cycles per instruction (CPI). The term “clock” at least in some examples refers to a physical device that is capable of providing a measurement of the passage of time. The term “duty cycle” at least in some examples refers to the fraction of one period in which a signal or system is active. The term “cycles per transaction” or “CPT” at least in some examples refers to the number of clock cycles required to execute an average transaction. In some examples, the “cycles per transaction” or “CPT” is the reciprocal or the multiplicative inverse of the throughput or transactions per cycle (TPC). The term “transactions per cycle” or “TPC” at least in some examples refers to the average number of transactions executed during a clock cycle or duty cycle. In some examples, the “transactions per cycle” or “TPC” is the reciprocal or the multiplicative inverse of the cycles per transaction (CPT).

The term “data unit” at least in some examples at least in some examples refers to a unit of information that is communicated (e.g., transmitted and/or received) through a network. In some examples, a data unit is structured to have header and payload sections. The term “data unit” at least in some examples may be synonymous with any of the following terms, even though they may refer to different aspects: “datagram”, a “protocol data unit” or “PDU”, a “service data unit” or “SDU”, “frame” and/or “data frame”, “packet”, “network packet”, “segment”, “block” and/or “data block”, “cell”, “chunk” or “data chunk”, “Type Length Value” or “TLV”, “information element”, “data element”, “bits”, “symbols”, and/or the like. Examples of data units include internet protocol (IP) packets, Internet Packet Exchange (IPX) packets, Sequenced Packet Exchange (SPX) packets, Internet Control Message Protocol (ICMP) packet, UDP datagrams, TCP segments, SCTP packet, ICMP packet, Ethernet packet (see e.g., [IEEE802.3]), Ethernet frame (see e.g., [IEEE802.3]), asynchronous transfer mode (ATM) cells, RRC messages, SDAP PDUs, SDAP SDUs, PDCP PDUs, PDCP SDUs, MAC PDUs, MAC SDUs, BAP PDUs. BAP SDUs, RLC PDUs, RLC SDUs, bits, symbols, application PDUs (APDUs), transaction PDUs (TPDUs), WiFi frames (see e.g., [IEEE802], [IEEE80211], and/or the like), Type Length Value (TLV), and/or other like data structures.

The term “translation” at least in some examples refers to the process of converting or otherwise changing data from a first form, shape, configuration, structure, arrangement, embodiment, description, or the like into a second form, shape, configuration, structure, arrangement, embodiment, description, or the like; at least in some examples there may be two different types of translation: transcoding and transformation. The term “transcoding” at least in some examples refers to taking information/data in one format (e.g., a packed binary format) and translating the same information/data into another format in the same sequence. Additionally or alternatively, the term “transcoding” at least in some examples refers to taking the same information, in the same sequence, and packaging the information (e.g., bits or bytes) differently. The term “transformation” at least in some examples refers to changing data from one format and writing it in another format, keeping the same order, sequence, and/or nesting of data items. Additionally or alternatively, the term “transformation” at least in some examples involves the process of converting data from a first format or structure into a second format or structure, and involves reshaping the data into the second format to conform with a schema or other like specification. Transformation may include rearranging data items or data objects, which may involve changing the order, sequence, and/or nesting of the data items/objects. Additionally or alternatively, the term “transformation” at least in some examples refers to changing the schema of a data object to another schema.

Aspects of the inventive subject matter may be referred to herein, individually and/or collectively, merely for convenience and without intending to voluntarily limit the scope of this application to any single aspect or inventive concept if more than one is in fact disclosed. Thus, although specific aspects have been illustrated and described herein, it should be appreciated that any arrangement calculated to achieve the same purpose may be substituted for the specific aspects shown. This disclosure is intended to cover any and all adaptations or variations of various aspects. Combinations of the above aspects and other aspects not specifically described herein will be apparent to those of skill in the art upon reviewing the above description.

1-51. (canceled)

52. A network interface controller (NIC), comprising:
a receiver (Rx) buffer to store Rx packets belonging to a network packet batch;
an Rx steering circuitry to steer the Rx packets belonging to the network packet batch to the Rx buffer for storage in the Rx buffer; and
in-transit packet detector (ITPD) circuitry assigned to the Rx buffer,
wherein, after or during an individual Rx packet in the network packet batch is transferred from the Rx buffer to an Rx queue slot indicated by a descriptor, the ITPD circuitry is to:
cause a next bit field in the descriptor to be set to a first value when at least one other Rx packet belonging to the network packet batch is still stored in the Rx buffer, and
cause the next bit field in the descriptor to be set to a second value when no other Rx packets belonging to the network packet batch are still stored in the Rx buffer.

53. The NIC of claim 52, wherein the Rx buffer is assigned to a traffic class (TC) of a plurality of TCs that is associated with cyclic traffic or time-sensitive networking traffic.

54. The NIC of claim 52, wherein the Rx queue slot is a slot in an Rx queue that includes a plurality of slots, the descriptor is among a plurality of descriptors, each descriptor in the plurality of descriptors corresponds to a respective slot of the plurality of slots, and the descriptor corresponds to the Rx queue slot.

55. The NIC of claim 54, wherein the Rx buffer is implemented using a memory device of the NIC, and the Rx queue is implemented by a system memory of a host platform.

56. The NIC of claim 54, wherein the NIC includes a packet engine to:
control transfer of the individual Rx packet to the Rx queue slot in the Rx queue; and
after the transfer of the individual Rx packet to the Rx queue slot and after the next bit field in the descriptor is set to the first value or the second value, set an own bit in the descriptor to a value to release control of the descriptor.

57. The NIC of claim 56, wherein the ITD is to:
signal the packet engine to set the next bit in the descriptor to the first value or the second value.

58. The NIC of claim 56, wherein:
the ITD is to tag the individual Rx packet with a next bit tag when the descriptor is to be set to the first value; and
the packet engine is to:
extract the next bit tag from the individual Rx packet, and
insert the extracted next bit tag into the descriptor.

59. The NIC of claim 52, wherein the ITD is among a set of ITDs, individual ITDs of the set of ITDs are assigned to corresponding Rx buffers of a plurality of Rx buffers, and wherein a number of ITDs in the set of ITDs is less than or equal to a number of Rx buffers in the plurality of Rx buffers.

60. The NIC of claim 59, wherein the NIC includes:
an ITD controller to assign the individual ITDs to the corresponding Rx buffers based on respective TCs of the corresponding Rx buffers.

61. The NIC of claim 52, wherein the Rx steering circuitry is to:
steer the Rx packets belonging to the network packet batch to the Rx buffer based on a priority of the Rx packets, wherein the priority of the Rx packets is included in a virtual local area network tag included in each of the Rx packets.

62. The NIC of claim 52, wherein the NIC is disposed in a time-aware system in a time-aware network, a precision time protocol computing instance, a router, a bridge, a hub, a network appliance, a gateway device, a user equipment or end station, a network access node, an edge compute node, a cloud compute node, a network server in a core network, or an application server.

63. One or more non-transitory computer-readable media comprising instructions, wherein execution of the instructions by a host processor of a host platform is to cause the host platform to:
for an individual packet belonging to a network packet batch during a batch processing cycle,
read a descriptor to determine a slot in which the individual packet is stored, wherein packets belonging to the network packet batch are stored in respective slots of a receiver (Rx) queue maintained in a system memory of the host platform,
read the individual packet out of the determined slot, and
continue the batch processing cycle when a next bit field in the descriptor is active, wherein the next bit field being active indicates that at least one additional packet belonging to the network packet batch is stored in another slot of the Rx queue or will be transferred into the another slot.

64. The one or more NTCRM of claim 63, wherein execution of the instructions is to cause the host platform to:
cause or permit a task switch to take place when the next bit field in the descriptor is inactive.

65. The one or more NTCRM of claim 63, wherein, to continue the batch processing cycle, execution of the instructions is to cause the host platform to:
execute a bounded spinning process to prevent a task switch from taking place.

66. The one or more NTCRM of claim 65, wherein, to execute the bounded spinning process the batch processing cycle, execution of the instructions is to cause the host platform to:
continuously reading an own bit field of the descriptor.

67. The one or more NTCRM of claim 63, wherein execution of the instructions is to cause the host platform to:
disable an Rx interrupt request (IRQ) before processing the network packet batch; and
enable the Rx IRQ when all Rx packets in the network packet batch have been processed during the batch processing cycle.

68. The one or more NTCRM of claim 63, wherein the host platform is disposed in a time-aware system in a time-aware network, a precision time protocol computing instance, a router, a bridge, a hub, a network appliance, a gateway device, a user equipment or end station, a network access node, an edge compute node, a cloud compute node, a network server in a core network, or an application server.

69. A method of operating a network interface controller (NIC), the method comprising:
steering packets belonging to a network packet batch to a buffer for storage in the buffer;
transferring an individual Rx packet in the network packet batch from the buffer to a slot of a receiver (Rx) queue indicated by a descriptor;
during or after the transferring,
causing a next bit field in the descriptor to be set to a first value when at least one other packet belonging to the network packet batch is still stored in the buffer, and
causing the next bit field in the descriptor to be set to a second value when no other packets belonging to the network packet batch are stored in the buffer; and
after the transferring, releasing control of the descriptor.

70. The method of claim 69, wherein the buffer is assigned to a traffic class (TC) of a plurality of TCs that is associated with cyclic traffic or time-sensitive networking traffic.

71. The method of claim 70, wherein the steering includes:
steering the packets belonging to the network packet batch to the buffer based on a TC of the packets, wherein the TC of the Rx packets is included in a virtual local area network tag included in each of the Rx packets, and the TC of the packets is same as the TC assigned to the buffer.

72. The method of claim 69, wherein the method includes:
tagging the individual packet with a next bit tag before storing the individual packet in the buffer when the descriptor is to be set to the first value; and
during or after the transferring:
extracting the next bit tag from the individual Rx packet, and
inserting the extracted next bit tag into the descriptor.

73. The method of claim 69, wherein the releasing the control of the descriptor includes:
setting an own bit in the descriptor to a value indicating that the descriptor has been released.

74. A compute node, comprising:
a network interface controller (NIC) arranged to:
steer Rx packets belonging to a network packet batch to an Rx buffer for storage in the Rx buffer,
transfer an individual Rx packet in the network packet batch to a slot of an Rx queue indicated by a descriptor corresponding to the slot,
set a next bit field in the descriptor to a first value when at least one other Rx packet belonging to the network packet batch is still stored in the Rx buffer,
set the next bit field in the descriptor to a second value when no other Rx packets belonging to the network packet batch are still stored in the Rx buffer, and
release control of the descriptor after the transfer of the individual Rx packet; and
a host platform connected to the NIC, wherein the host platform includes host memory that maintains the Rx queue, and the host platform is arranged to, during a batch processing cycle:
read the descriptor to determine the slot of the Rx queue in which the individual packet is stored,
read the individual packet out of the determined slot,
continue the batch processing cycle when the next bit field in the descriptor is set to the first value, and
cause or permit a task switch to take place when the next bit field in the descriptor is set to the second value.

75. The compute node of claim 74, wherein the Rx buffer is assigned to a traffic class (TC) of a plurality of TCs that is associated with cyclic traffic or time-sensitive networking traffic.

76. The compute node of claim 74, wherein the NIC is arranged to:
steer the packets belonging to the network packet batch to the buffer based on a TC of the packets, wherein the TC of the Rx packets is included in a virtual local area network tag included in each of the Rx packets, and the TC of the packets is same as the TC assigned to the buffer.

77. The compute node of claim 74, wherein the compute node is a time-aware system in a time-aware network, a precision time protocol computing instance, a router, a bridge, a hub, a network appliance, a gateway device, a user equipment or end station, a network access node, an edge compute node, a cloud compute node, a network server in a core network, or an application server.
